(19) United States
(12) Patent Application Publication
(10) Pub. No.: US 2026/0183589 A1
(43) Pub. Date: Jul. 2, 2026

(54) TILLER MID-MOUNT FIRE APPARATUS

(71) Applicant: Oshkosh Corporation, Oshkosh, WI (US)

(72) Inventors: Eric Betz, Clintonville, WI (US); Jennifer Bloemer, DePere, WI (US); Nathan Daily, Oshkosh, WI (US); Sandesh Gudemane, Oshkosh, WI (US); Jeremy Skjold, Oshkosh, WI (US); Daniel Stadtmueller, Oshkosh, WI (US); Shena Straka, Oshkosh, WI (US)

(73) Assignee: Oshkosh Corporation, Oshkosh, WI (US)

(21) Appl. No.: 19/436,944

(22) Filed: Dec. 30, 2025

Related U.S. Application Data
(60) Provisional application No. 63/740,797, filed on Dec. 31, 2024.
(60) Provisional application No. 63/740,782, filed on Dec. 31, 2024.
(60) Provisional application No. 63/740,819, filed on Dec. 31, 2024.
(60) Provisional application No. 63/740,804, filed on Dec. 31, 2024.

(51) Int. Cl. A62C 27/00; B60S 9/02

(52) U.S. Cl. CPC A62C 27/00; B60S 9/02

(57) ABSTRACT

A tiller fire apparatus includes a tractor and a trailer. The tractor includes a chassis defining a longitudinal axis, a first cab coupled to the chassis, a front axle coupled to the chassis, and a single intermediate axle coupled to the chassis rearward of the front axle. The trailer includes a frame pivotably coupled to the chassis about a vertical axis perpendicular to the longitudinal axis, a single rear axle coupled to the frame, a stabilization assembly coupled to the frame rearward of the vertical axis, a second cab coupled to the frame rearward of the single rear axle, and an aerial assembly supported by the frame. The aerial assembly has a vertical reach of at least 95 feet and a horizontal reach of at least 90 feet. The tractor and the trailer have a longitudinal length along the longitudinal axis that is at most 52 feet.

### CROSS-REFERENCE TO RELATED APPLICATIONS

This application claims the benefit of and priority to U.S. Provisional Application No. 63/740,782 filed Dec. 31, 2024, U.S. Provisional Application No. 63/740,797 filed Dec. 31, 2024, U.S. Provisional Application No. 63/740,804 filed Dec. 31, 2024, and U.S. Provisional Application No. 63/740,819 filed Dec. 31, 2024, the entire contents of which are hereby incorporated by reference herein.

### BACKGROUND

Fire apparatuses may be configured as rear-mount aerial fire apparatuses or mid-mount aerial fire apparatuses. Further, such fire apparatuses may be configured as quint configuration fire apparatuses including an aerial ladder, a water tank, a water pump, ground ladder storage, and hose storage.

### SUMMARY

One embodiment relates to a tiller fire apparatus. The tiller fire apparatus includes a tractor and a trailer. The tractor includes a chassis defining a longitudinal axis, a first cab coupled to the chassis, a front axle coupled to the chassis, and a single intermediate axle coupled to the chassis rearward of the front axle. The trailer includes a frame pivotably coupled to the chassis about a vertical axis perpendicular to the longitudinal axis, a single rear axle coupled to the frame, a stabilization assembly coupled to the frame rearward of the vertical axis, a second cab coupled to the frame rearward of the single rear axle, and an aerial assembly supported by the frame. The aerial assembly has a vertical reach of at least 95 feet and a horizontal reach of at least 90 feet. The tractor and the trailer have a longitudinal length along the longitudinal axis that is at most 52 feet.

Another embodiment relates to a fire apparatus. The fire apparatus includes a tractor and a trailer. The tractor includes a chassis defining a longitudinal axis, a first cab coupled to the chassis, a front axle coupled to the chassis, and a single intermediate axle coupled to the chassis rearward of the front axle. The trailer includes a frame pivotably coupled to the chassis about a vertical axis perpendicular to the longitudinal axis, a single rear axle coupled to the frame, a stabilization assembly coupled to the frame rearward of the vertical axis, a second cab coupled to the frame rearward of the rear axle, and an aerial assembly supported by the frame. The aerial assembly includes a multi-section ladder that is extensible to provide a vertical reach of at least 95 feet and a horizontal reach of at least 90 feet. The fire apparatus has an overall height of at most 139 inches when the aerial assembly is in a stowed position. Yet another embodiment relates to a fire apparatus. The fire apparatus includes a tractor

and a trailer. The tractor includes a chassis defining a longitudinal axis, a first cab coupled to the chassis, a front axle coupled to the chassis, and a single intermediate axle coupled to the chassis rearward of the front axle. The trailer includes a frame pivotably coupled to the chassis about a vertical axis perpendicular to the longitudinal axis, a single rear axle coupled to the frame, a stabilization assembly coupled to the frame rearward of the vertical axis, a second cab coupled to the frame rearward of the rear axle, and an aerial assembly supported by the frame. The aerial assembly includes a multi-section ladder that is extensible to provide a vertical reach of at least 95 feet and a horizontal reach of at least 90 feet. The aerial assembly is capable of accommodating at least a 500 pound load applied to a distal end of the multi-section ladder while the multi-section ladder is fully extended. A distal end of the aerial assembly is positioned forward of the second cab when the aerial assembly is in a stowed position.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a right side view of a mid-mount fire apparatus, according to an exemplary embodiment.

FIG. 2 is a left side view of the mid-mount fire apparatus of FIG. 1, according to an exemplary embodiment.

FIG. 3 is a top view of the mid-mount fire apparatus of FIG. 1, according to an exemplary embodiment.

FIG. 4 is a front view of the mid-mount fire apparatus of FIG. 1, according to an exemplary embodiment.

FIG. 5 is a rear view of the mid-mount fire apparatus of FIG. 1 having ground ladders in a horizontal configuration, according to an exemplary embodiment.

FIG. 6 is a rear view of the mid-mount fire apparatus of FIG. 1 having ground ladders in a vertical configuration, according to an exemplary embodiment.

FIG. 7 is a perspective view of a portion of the mid-mount fire apparatus of FIG. 1, according to an exemplary embodiment.

FIG. 8 is a side view of an aerial ladder assembly of the mid-mount fire apparatus of FIG. 1, according to an exemplary embodiment.

FIG. 9 is a detailed perspective view of the aerial ladder assembly of FIG. 8, according to an exemplary embodiment.

FIG. 10 is a side view of a ladder platform of the aerial ladder assembly of FIG. 8, according to an exemplary embodiment.

FIG. 11 is detailed perspective view of the ladder platform of FIG. 10, according to an exemplary embodiment.

FIG. 12 is a bottom detailed perspective view of the aerial ladder assembly of FIG. 8, according to an exemplary embodiment.

FIG. 13 is a rear view of the aerial ladder assembly of FIG. 8, according to an exemplary embodiment.

FIG. 14 is a perspective view of an aerial ladder of the aerial ladder assembly of FIG. 8 in a retracted configuration, according to an exemplary embodiment.

FIG. 15 is a side view of the aerial ladder of FIG. 14 in the retracted configuration, according to an exemplary embodiment.

FIG. 16 is a front view of the aerial ladder of FIG. 14 in the retracted configuration, according to an exemplary embodiment.

FIG. 17 is a bottom perspective view of the aerial ladder of FIG. 14 in the retracted configuration, according to an exemplary embodiment.

FIG. 18 is a perspective view of the aerial ladder of FIG. 14 in an extended configuration, according to an exemplary embodiment.

FIG. 19 is a perspective view of a first end of the aerial ladder of FIG. 14 in the retracted configuration, according to an exemplary embodiment.

FIG. 20 is a perspective view of a second end of the aerial ladder of FIG. 14 in the retracted configuration, according to an exemplary embodiment.

FIG. 21 is a detailed perspective view of a portion of the aerial ladder of FIG. 14 in the retracted configuration, according to an exemplary embodiment.

FIG. 22 is a detailed front view of a portion of the aerial ladder of FIG. 14 in the retracted configuration, according to an exemplary embodiment.

FIG. 23 is a perspective cross-section view of the aerial ladder of FIG. 14 in the retracted configuration, according to an exemplary embodiment.

FIG. 24 is a detailed front cross-section view of a portion of the aerial ladder of FIG. 14 in the retracted configuration, according to an exemplary embodiment.

FIG. 25 is a detailed perspective view of a portion of a first ladder segment of the aerial ladder of FIG. 14, according to an exemplary embodiment.

FIG. 26 is a detailed partially exploded perspective top view of a portion of a first ladder segment of FIG. 25, according to an exemplary embodiment.

FIG. 27 is a perspective view of a second ladder segment of the aerial ladder of FIG. 14, according to an exemplary embodiment.

FIG. 28 is a detailed perspective view of a portion of a third ladder segment of the aerial ladder of FIG. 14, according to an exemplary embodiment.

FIG. 29 is a detailed perspective view of a portion of the third ladder segment of FIG. 28, according to an exemplary embodiment.

FIG. 30 is a detailed side view of a portion of the third ladder segment of FIG. 28, according to an exemplary embodiment.

FIG. 31 is a detailed perspective view of a portion of a load transfer assembly of the third ladder segment of FIG. 28, according to an exemplary embodiment.

FIG. 32 is a detailed perspective view of a lock shaft of the load transfer assembly of FIG. 31, according to an exemplary embodiment.

FIG. 33 is a detailed perspective view of a lock plate of the load transfer assembly of FIG. 31, according to an exemplary embodiment.

FIG. 34 is a detailed perspective view of a portion of the load transfer assembly of FIG. 31, according to an exemplary embodiment.

FIG. 35 is a detailed exploded perspective view of a portion of the load transfer assembly of FIG. 31, according to an exemplary embodiment.

FIG. 36 is a perspective view of a portion of a fourth ladder segment of the aerial ladder of

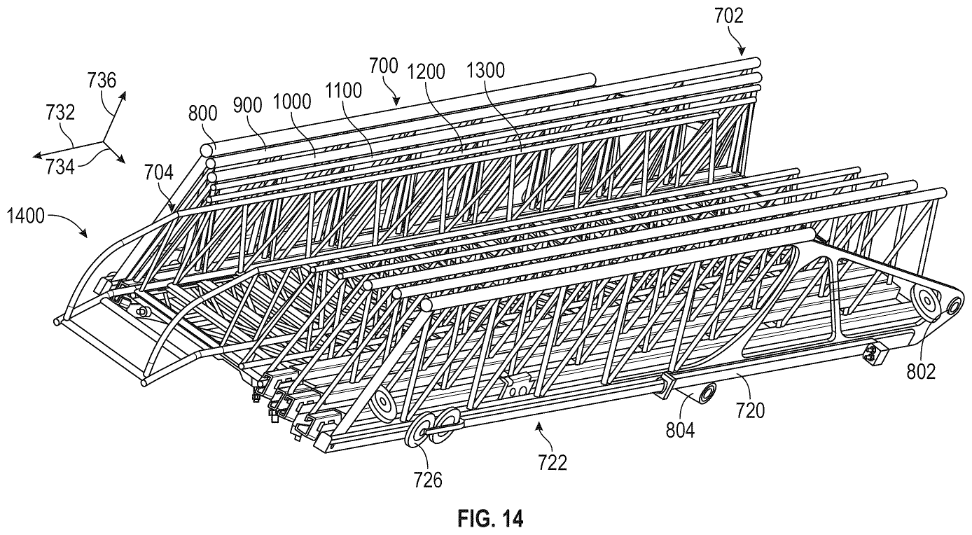

FIG. 14, according to an exemplary embodiment.

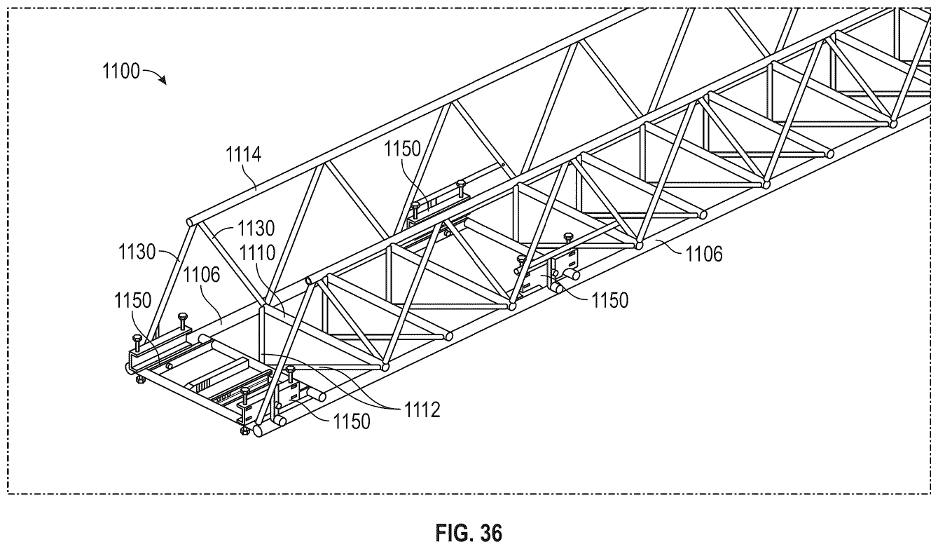

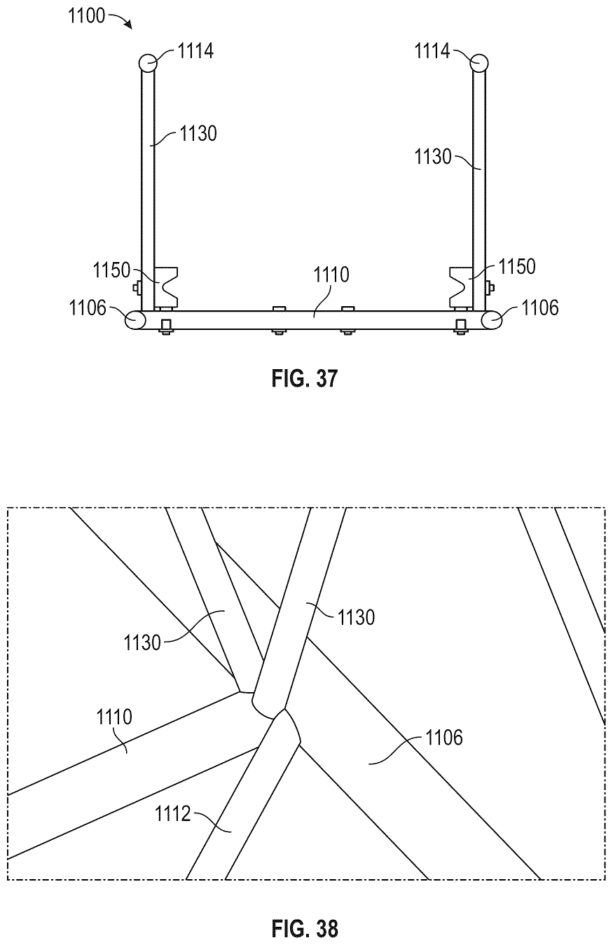

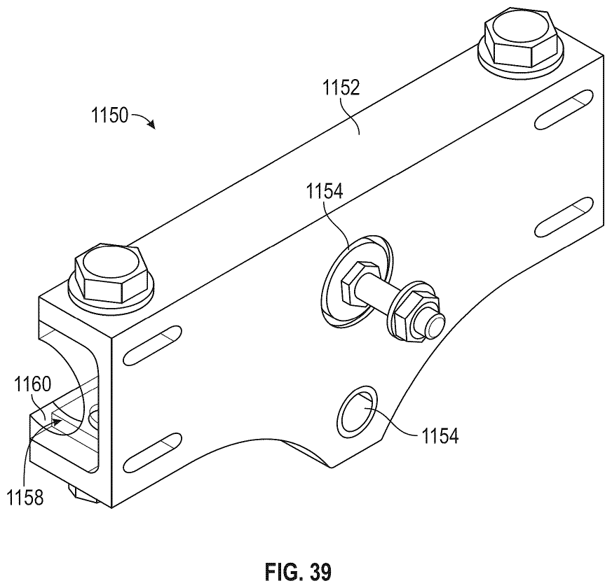

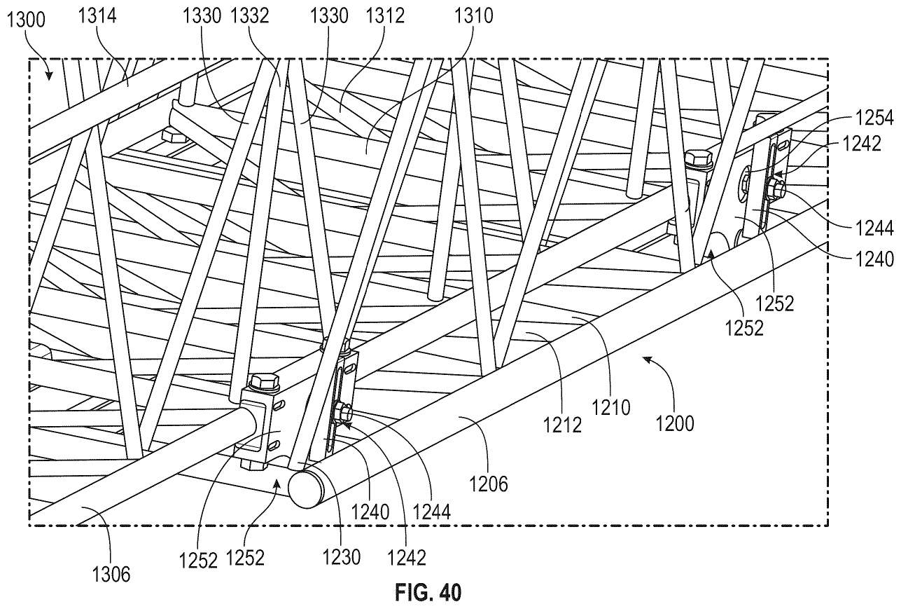

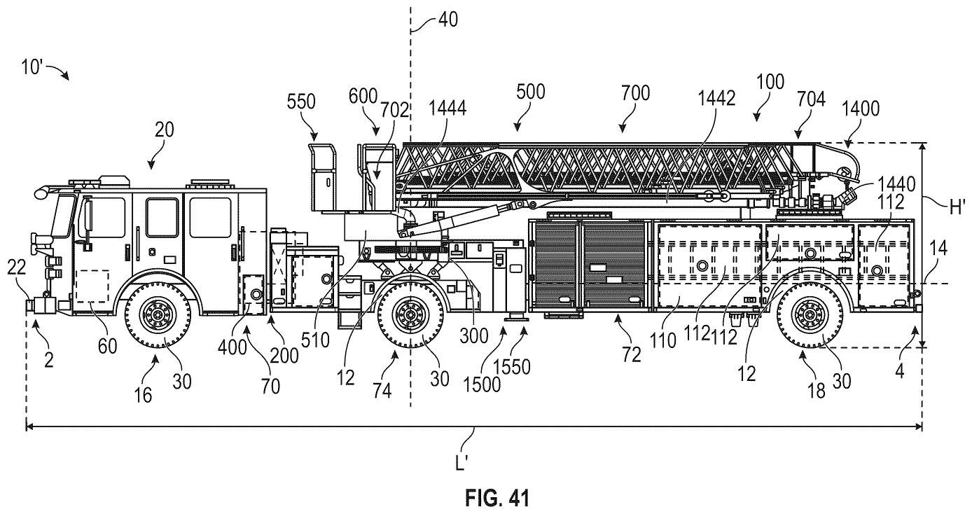

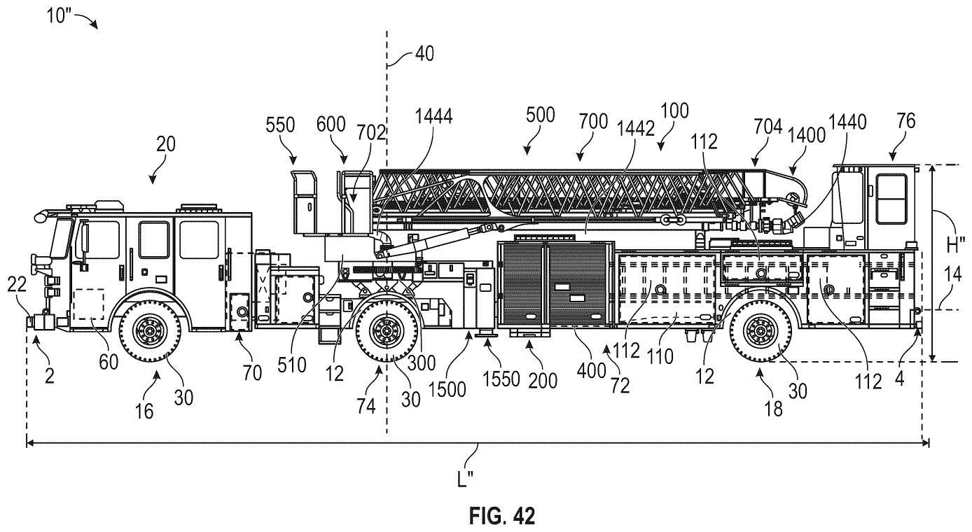

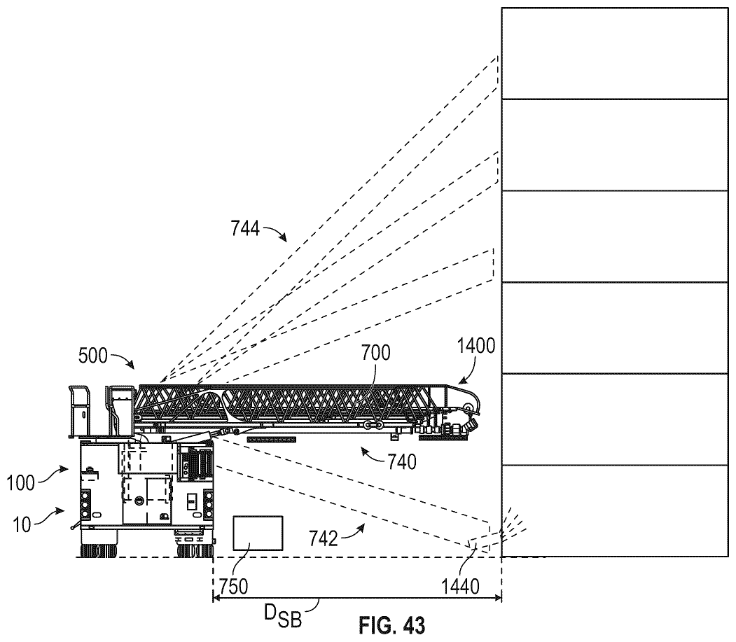

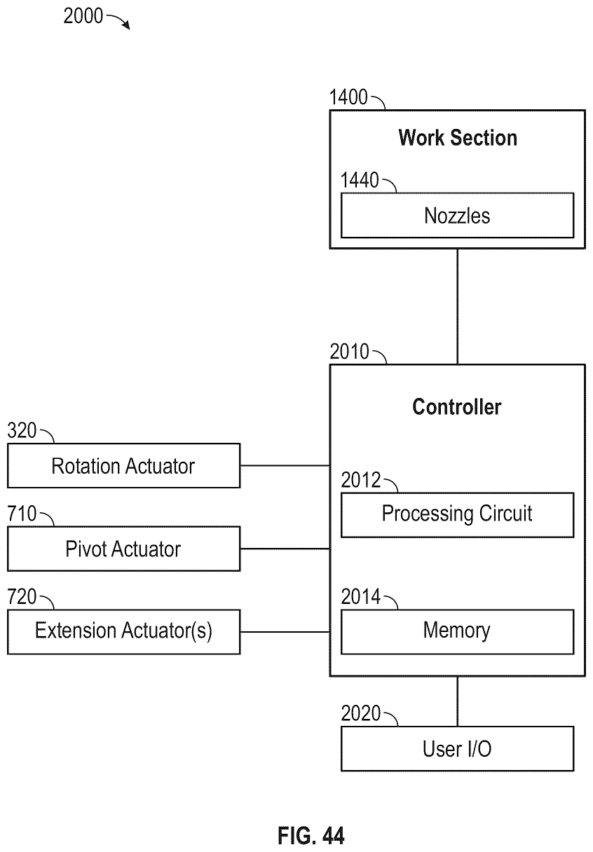

FIG. 37 is a front view of the fourth ladder segment of FIG. 36, according to an exemplary embodiment.

FIG. 38 is a detailed perspective view of a portion of the fourth ladder segment of FIG. 36, according to an exemplary embodiment.

FIG. 39 is a perspective view of a portion of a load transfer assembly of the fourth ladder segment of FIG. 38, according to an exemplary embodiment.

FIG. 40 is a detailed perspective view of portions of a fifth ladder segment and a sixth ladder segment of the aerial ladder of FIG. 14, according to an exemplary embodiment.

FIG. 41 is a left side view of a mid-mount fire apparatus in a trailer configuration, according to an exemplary embodiment.

FIG. 42 is a left side view of a mid-mount fire apparatus in a tiller configuration, according to an exemplary embodiment.

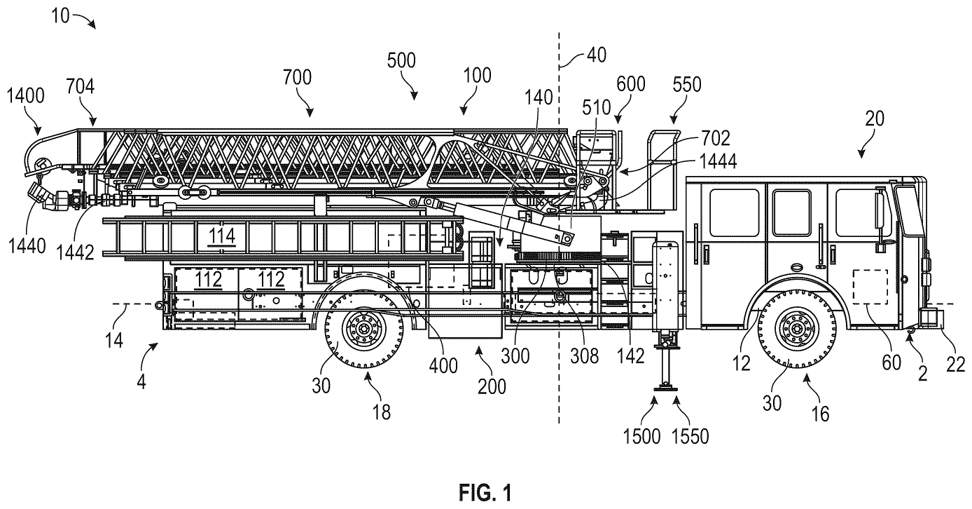

FIG. 43 is a rear view of an aerial assembly of the mid-mount fire apparatus of FIG. 1, 41, or 42 in a plurality of configurations, according to an exemplary embodiment.

FIG. 44 is a block diagram of a control system of the mid-mount fire apparatus of FIG. 1, 41, or 42, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle includes various components that improve performance relative to traditional systems. In one embodiment, the vehicle is a mid-mount quint configuration fire apparatus that includes a water tank, an aerial ladder, hose storage, ground ladder storage, and a water pump. The aerial ladder is coupled to the chassis between a front axle assembly and a rear axle assembly of the fire apparatus and pivotable about a lateral pivot axis and about a vertical pivot axis. The aerial ladder includes a base ladder section, at least one extensible ladder section (e.g., a base ladder section and five extensible ladder sections, etc.), and/or a basket or implement coupled to an end of the aerial ladder. The base ladder section includes a first base rail with a first cross sectional shape. At least one of the at least one extensible ladder sections extensible relative to the base ladder section includes a second base rail with a second cross sectional shape that is different from the first cross sectional shape.

### Overall Vehicle

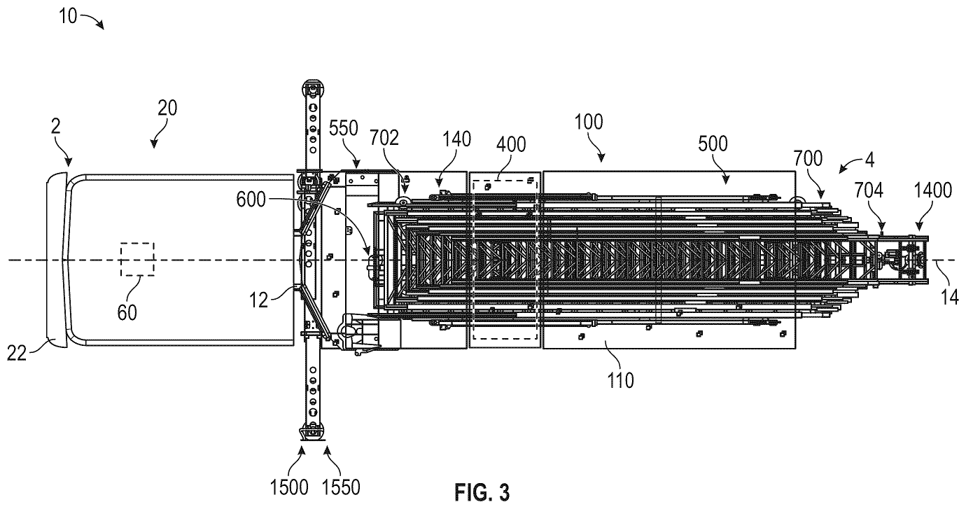

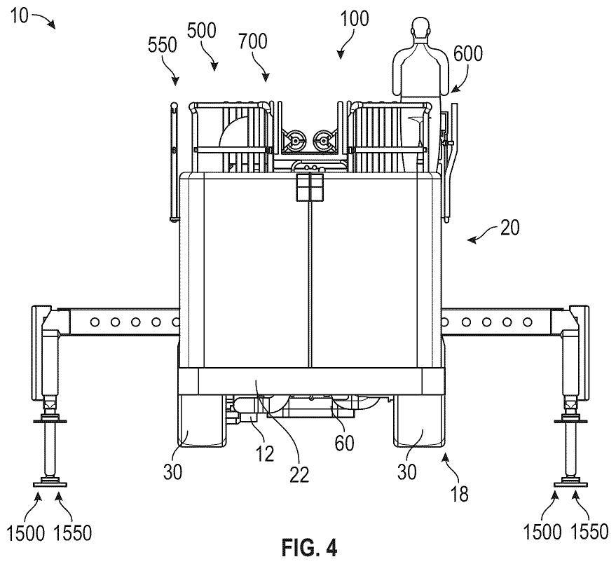

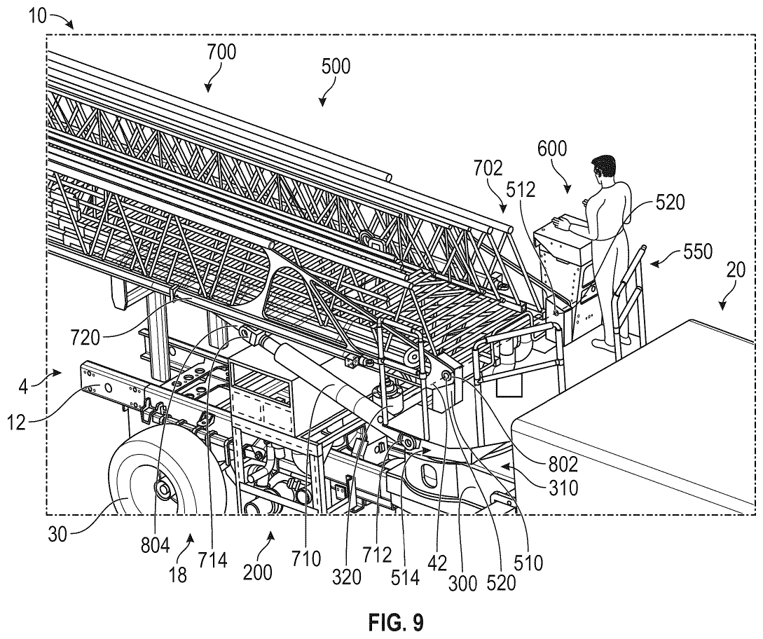

According to the exemplary embodiment shown in FIGS. 1-9, 41, and 42, a vehicle, shown as fire apparatus 10, is configured as a mid-mount quint fire truck having a single rear axle. A “quint” fire truck as used herein may refer to a fire truck that includes a water tank, an aerial ladder, hose storage, ground ladder storage, and a water pump. In other embodiments, the fire apparatus 10 is configured as a mid-mount quint fire truck having a tandem rear axle. A single rear axle chassis may include one solid axle configuration or may include one pair of axles each having a set of constant velocity joints and coupling a differential to a pair of hub assemblies, according to various alternative embodiments. A tandem rear axle may include two solid axle configurations or may include two pairs of axles (e.g., two pairs of half shafts, etc.) each having a set of constant velocity joints and coupling two differentials to two pairs of hub assemblies. In still other embodiments, the fire apparatus 10 is configured as a non-quint mid-mount fire truck having a single rear axle or a tandem rear axle. In yet other embodiments, the fire apparatus 10 is configured as a rear-mount, quint or non-quint, single rear axle or tandem rear axle, fire truck. As shown in FIGS. 1-9, 41, and 42, the fire apparatus 10 includes a chassis, shown as

frame 12, having longitudinal frame rails that define an axis, shown as longitudinal axis 14, that extends between a first end, shown as front end 2, and an opposing second end, shown as rear end 4, of the fire apparatus 10; a single first axle, shown as front axle 16, coupled to the frame 12; a single rear axle, shown as rear axle 18, coupled to the frame 12; a first assembly, shown as front cabin 20, coupled to and supported by the frame 12 and having a bumper, shown as front bumper 22; a prime mover, shown as engine 60, coupled to and supported by the frame 12; and a second assembly, shown as rear assembly 100, coupled to and supported by the frame 12. According to an exemplary embodiment, a weight of the fire apparatus 10 is at most 62,000 pounds (e.g., 57,000 pounds, etc.). In other embodiments, the fire apparatus 10 weighs more than 62,000 pounds. In some embodiments, the rear axle 18 is a tandem rear axle. As shown in FIGS. 1, 2, 4-9, 41, and 42, the front axle 16 and the rear axle 18 include

tractive assemblies, shown as wheel and tire assemblies 30. As shown in FIGS. 1-4, the front cabin 20 is positioned forward of the rear assembly 100 (e.g., with respect to a forward direction of travel for the fire apparatus 10 along the longitudinal axis 14, etc.). According to an alternative embodiment (e.g., FIG. 42), an additional cab assembly may additionally be positioned behind the rear assembly 100 (e.g., with respect to a forward direction of travel for the fire apparatus 10 along the longitudinal axis 14, etc.). The additional cab assembly may be positioned behind the rear assembly 100 on, by way of example, a rear tiller fire apparatus. In some embodiments, the fire apparatus 10 is a ladder truck with a front portion that includes the front cabin 20 pivotably coupled to a rear portion that includes the rear assembly 100. According to an exemplary embodiment, a minimum curb-to-curb turning capability of the fire apparatus 10 is at most 740 inches (e.g., 735 inches, etc.). The minimum curb-to-curb turning capability may be a minimum distance between opposing curbs of a street (e.g., between a first curb on a first side of a street and a second curb on an opposing second side of the street, etc.) where the fire apparatus 10 can turn 180 degrees (e.g., from facing a first direction to facing an opposing second direction, etc.) without contacting either curb. In other embodiments, the minimum curb-to-curb turning capability of the fire apparatus 10 is greater than 740 inches. According to an exemplary embodiment, a minimum wall-to-wall turning capability of the fire apparatus 10 is at most 800 inches (e.g., 792 inches, etc.) in a first direction and at most 810 inches (e.g., 804 inches, etc.) in an opposing second direction. The minimum wall-to-wall turning capability may be a minimum distance between opposing walls (e.g., a minimum distance between a first wall on a first side of the fire apparatus 10 and a second wall on an opposing second side of the fire apparatus 10, etc.) where the fire apparatus 10 can turn (e.g., turn 180 degrees, turn from facing a first direction to facing an opposing second direction, etc.) without contacting either wall. In other embodiments, the minimum wall-to-wall turning capability of the fire apparatus 10 is greater than 810 inches. According to an exemplary embodiment, the engine 60 receives fuel (e.g., gasoline, diesel,

etc.) from a fuel tank and combusts the fuel to generate mechanical energy. A transmission receives the mechanical energy and provides an output to a drive shaft. The rotating drive shaft is received by a differential, which conveys the rotational energy of the drive shaft to a final drive (e.g., the front axle 16, the rear axle 18, the wheel and tire assemblies 30, etc.). The final drive then propels or moves the fire apparatus 10. According to an exemplary embodiment, the engine 60 is a compression-ignition internal combustion engine that utilizes diesel fuel. In alternative embodiments, the engine 60 is another type of prime mover (e.g., a spark-ignition engine, a fuel cell, an electric motor, etc.) that is otherwise powered (e.g., with gasoline, compressed natural gas, propane, hydrogen, electricity, etc.). In some embodiments, the fire apparatus 10 include the engine 60 and a second prime mover (e.g., one or more electric motors) to provide a hybrid or dual-drive drivetrain. As shown in FIGS. 1-3, 5-10, 12, 13, 41, and 42, the rear assembly 100 includes a body

assembly, shown as body 110, coupled to and supported by the frame 12; a fluid driver, shown as pump system 200, coupled to and supported by the frame 12; a chassis support member, shown as torque box 300, coupled to and supported by the frame 12; a fluid reservoir, shown as water tank 400, coupled to the body 110 and supported by the torque box 300 and/or the frame 12; and an aerial assembly, shown as aerial assembly 500, pivotably coupled to the torque box 300 and supported by the torque box 300 and/or the frame 12. In some embodiments, the rear assembly 100 does not include the pump system 200 and/or the water tank 400 (e.g., a “no pump no tank” configuration). In some embodiments, the rear assembly 100 additionally or alternatively includes an agent or foam tank (e.g., that receives and stores a fire suppressing agent, foam, etc.). As shown in FIGS. 1, 2, 5, 41 and 42, the sides of the body 110 define a plurality of

compartments, shown as storage compartments 112. The storage compartments 112 may receive and store miscellaneous items and gear used by emergency response personnel (e.g., helmets, axes, oxygen tanks, hoses, medical kits, etc.). According to an exemplary embodiment, a storage capacity of the storage compartments 112 includes at least 180 cubic feet of storage space (e.g., 186 cubic feet of storage space, etc.). As shown in FIGS. 1, 5, and 6, the rear end 4 of the body 110 defines a longitudinal

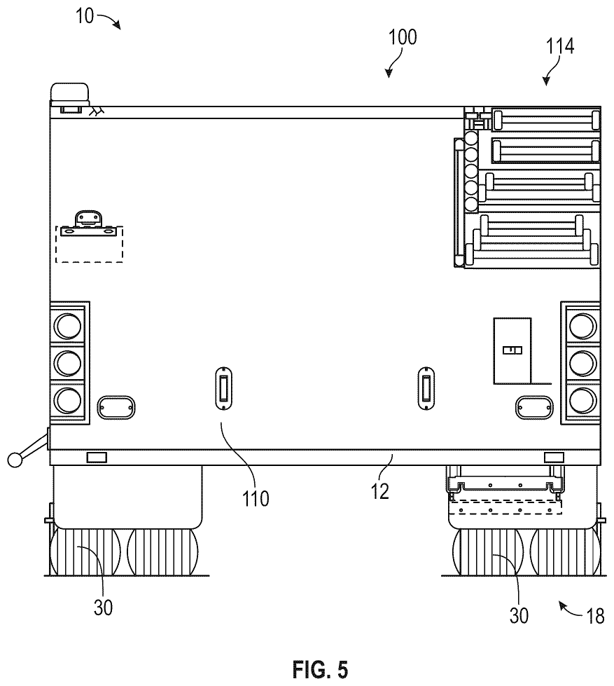

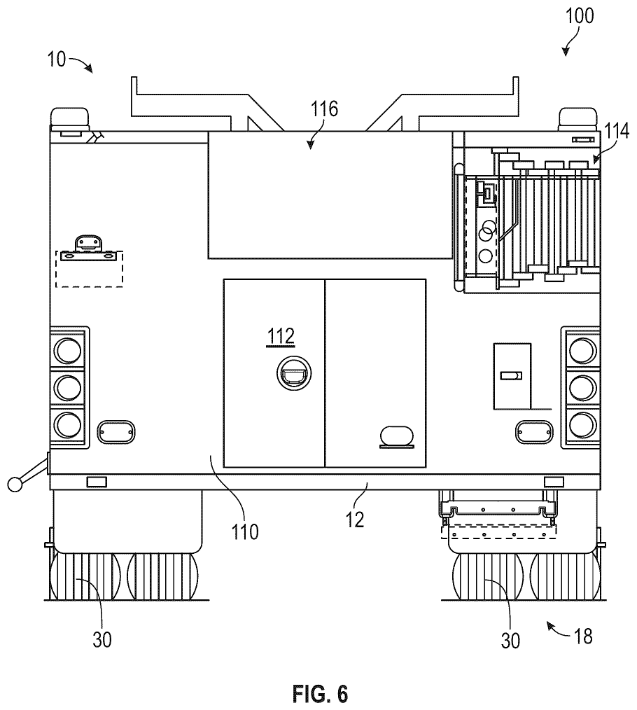

storage compartment that extends along the longitudinal axis 14, shown as ground ladder compartment 114. The ground ladder compartment 114 may receive and store one or more ground ladders. According to the exemplary embodiment shown in FIGS. 1 and 6, the ground ladder compartment 114 is configured to store the one or more ground ladders in an upright configuration. By way of example, the ground ladder compartment 114 may be configured to store the one or more ground ladders in the upright configuration where widths (e.g., maximum widths, etc.) across the one or more ground ladders are oriented vertically (e.g., laterally stacked, oriented substantially parallel to the vertical pivot axis 40, etc.). According to the exemplary embodiment shown in FIG. 5, the ground ladder compartment 114 is configured to store the one or more ground ladders in a horizontal configuration. By way of example, the ground ladder compartment 114 may be configured to store the one or more ground ladders in the horizontal configuration where widths across the one or more ground ladders are oriented horizontally (e.g., vertically stacked, substantially perpendicular to the vertical pivot axis 40, etc.). According to an exemplary embodiment, the ground ladder compartment 114 is configured to store up to 105 feet of ground ladders. By way of example, the ground ladder compartment 114 may be configured to store three 35 foot two-section ladders (e.g., summing to 105 feet of ground ladders, etc.). By way of another example, the ground ladder compartment 114 may be configured to store five 20 foot roof ladders (e.g., summing to 100 feet of ground ladders, etc.). In other embodiments, the ground ladder compartment 114 is configured to store over 105 feet of ground ladders. According to the exemplary embodiment shown in FIG. 6, the body 110 defines a cavity,

shown as hose storage platform 116. The hose storage platform 116 may receive and store one or more hoses (e.g., up to about 800 feet of 5 inch diameter hose, etc.), which may be pulled from the hose storage platform 116. In some embodiments, the rear end 4 of the body 110 has notched, angled, or clipped

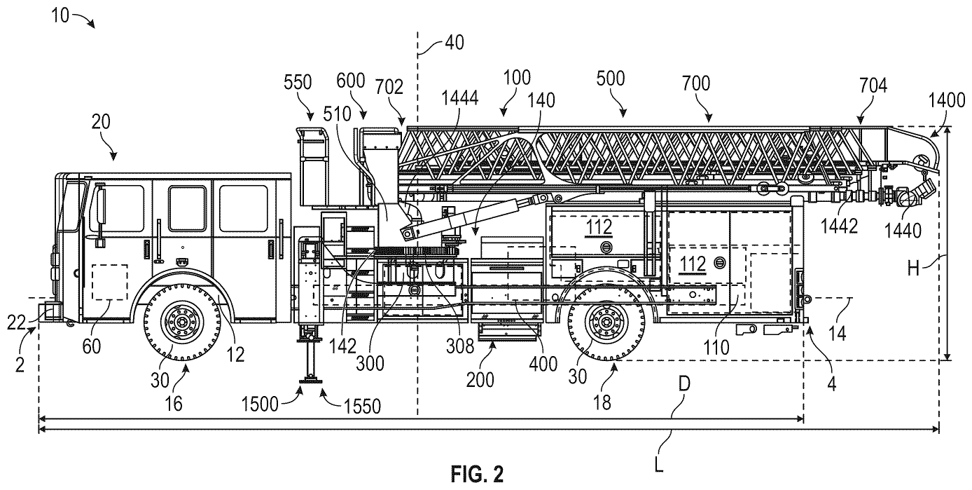

corners (e.g., notched corners, etc.). According to an exemplary embodiment, the notched, angled, or clipped corners provide for increased turning clearance relative to fire apparatuses that have non-notched or non-clipped (e.g., square, etc.) corners. In other embodiments, the rear end 4 of the body 110 does not have notched, angled, or clipped corners (e.g., the rear end 4 of the body 110 may have square corners, etc.). As shown in FIGS. 1 and 2, the body 110 defines a recessed portion, shown as aerial

assembly recess 140, positioned (i) rearward of the front cabin 20 and (ii) forward of the water tank 400 and/or the rear axle 18. The aerial assembly recess 140 defines a first aperture, shown as pedestal opening 142, forward of the pump system 200. According to an exemplary embodiment the water tank 400 is coupled to the frame 12

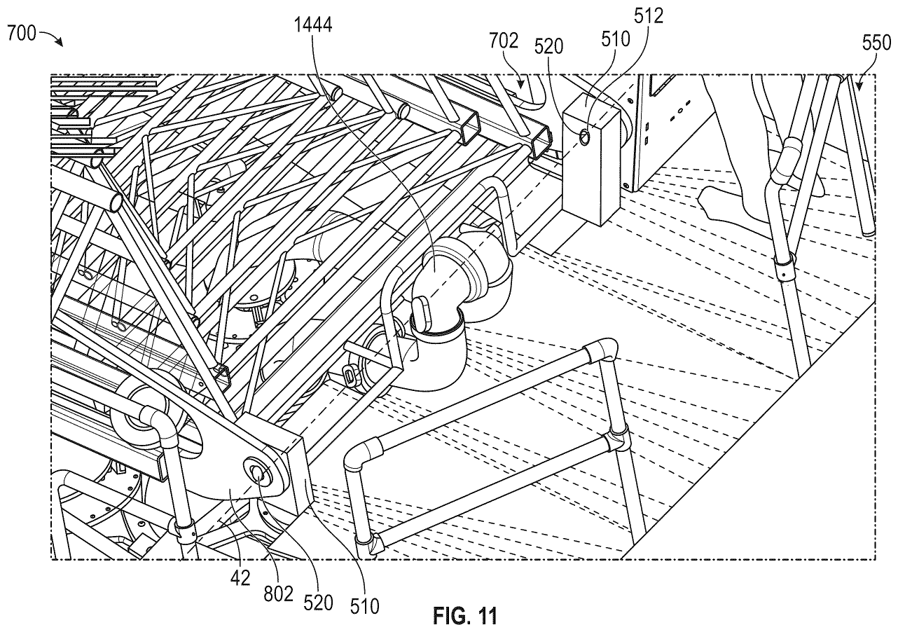

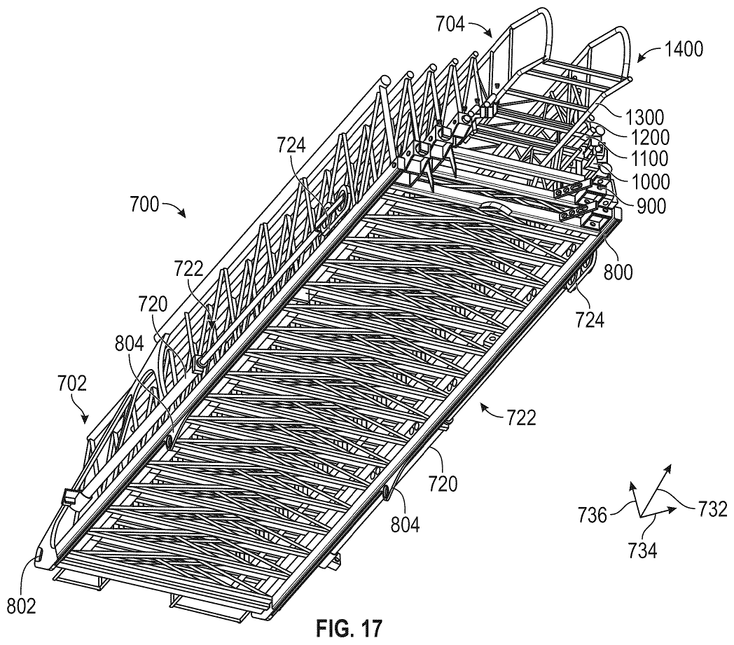

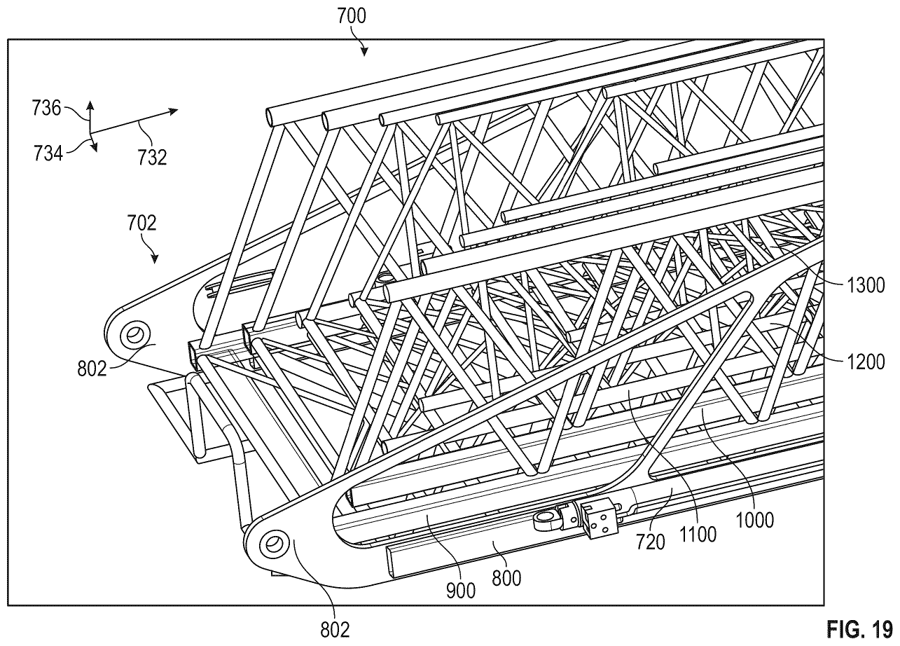

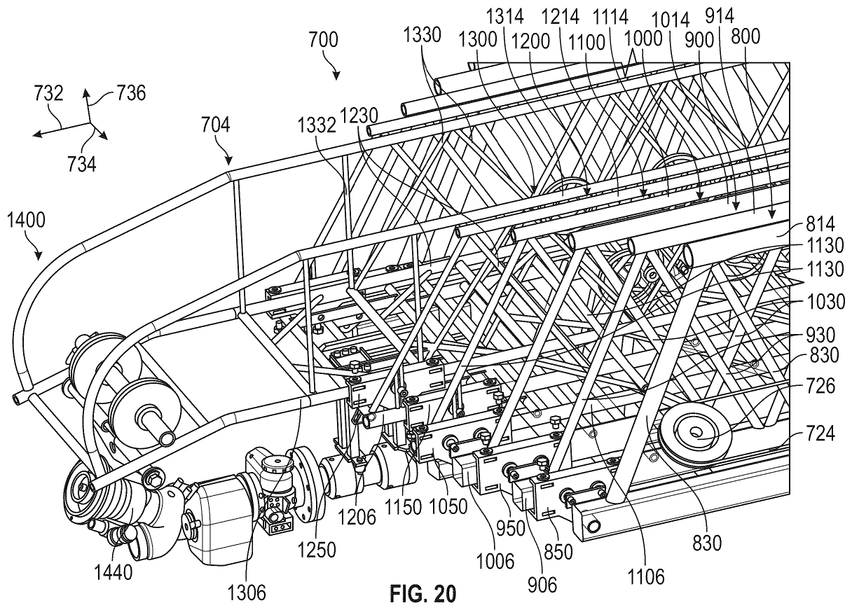

with a superstructure (e.g., disposed along a top surface of the torque box 300, etc.). As shown in FIGS. 1 and 2, the water tank 400 is positioned below the aerial ladder assembly 700, forward of the hose storage platform 116, and/or rearward/above of the pump system 200. In some embodiments, the water tank 400 is positioned such that the water tank 400 defines a rear wall of the aerial assembly recess 140. In one embodiment, the water tank 400 stores up to 300 gallons of water. In another embodiment, the water tank 400 stores more than or less than 300 gallons of water (e.g., 100, 200, 250, 350, 400, 500, etc. gallons). In other embodiments, fire apparatus 10 additionally or alternatively includes a second reservoir that stores another firefighting agent (e.g., foam, etc.). In still other embodiments, the fire apparatus 10 does not include the water tank 400 (e.g., in a non-quint configuration, in a non-tank configuration, etc.). As shown in FIGS. 1-4, 7-20, 23, 41, and 42, the aerial assembly 500 includes a turntable

assembly, shown as turntable 510, pivotably coupled to the torque box 300; a platform, shown work platform 550, coupled to the turntable 510; a console, shown as control console 600, coupled to the turntable 510; a ladder assembly, shown as aerial ladder assembly 700, having a first end (e.g., a base end, a proximal end, a pivot end, etc.), shown as proximal end 702, pivotably coupled to the turntable 510, and an opposing second end (e.g., a free end, a distal end, a platform end, an implement end, etc.), shown as distal end 704. In some embodiments, the aerial assembly 500 includes an implement (e.g., a work basket, water turret, etc.) coupled to the distal end 704. As shown in FIGS. 1, 2, 7, 8, 9, 41, and 42, the torque box 300 is coupled to the frame 12.

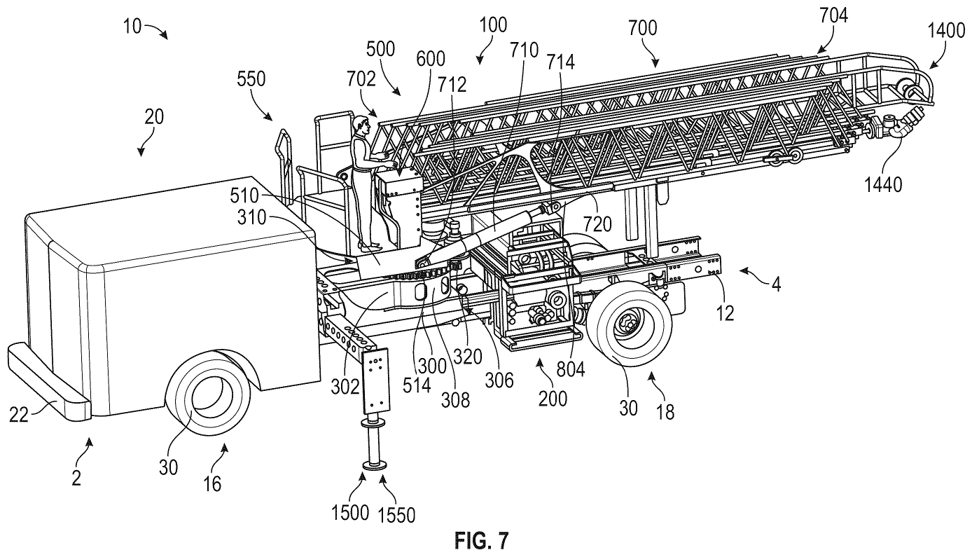

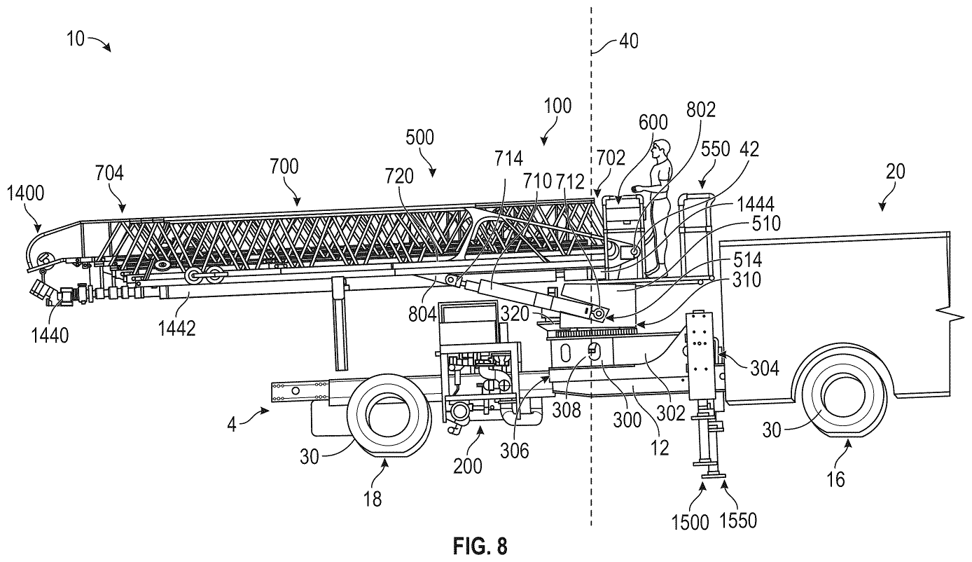

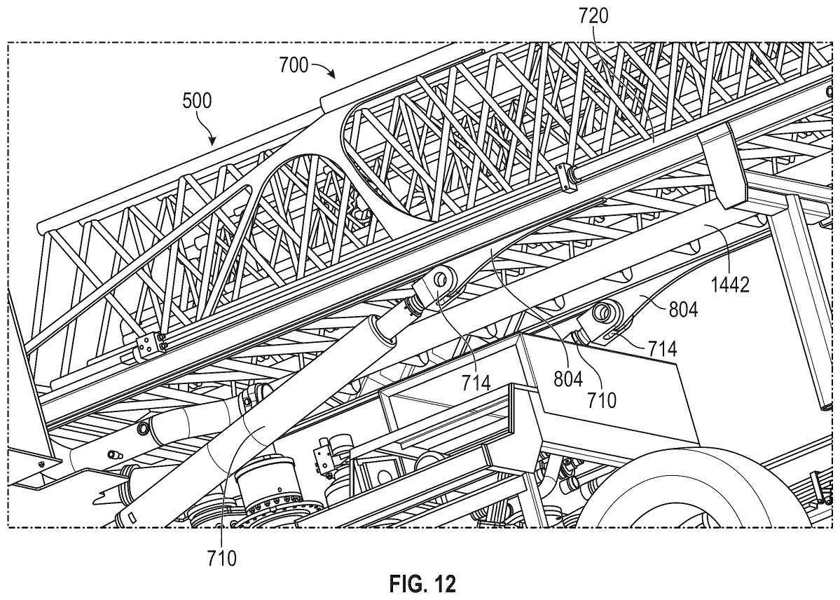

In one embodiment, the torque box 300 extends laterally the full width between the lateral outsides of the frame rails of the frame 12. As shown in FIGS. 7 and 8, the torque box 300 includes a body portion, shown as body 302, having a first end, shown as front end 304, and an opposing second end, shown as rear end 306. As shown in FIGS. 12, 14, and 15, the torque box 300 includes a support, shown as pedestal 308, coupled (e.g., attached, fixed, bolted, welded, etc.) to the rear end 306 of the body 302. As shown in FIGS. 1 and 2, the pedestal 308 extends through the pedestal opening 142 into the aerial assembly recess 140 such that the pedestal 308 is positioned (i) forward of the water tank 400, the pump system 200, and the rear axle 18 and (ii) rearward of the front axle 16 and the front cabin 20.

According to the exemplary embodiment shown in FIGS. 1, 2, and 8, the aerial assembly 500 (e.g., the turntable 510, the work platform 550, the control console 600, the aerial ladder assembly 700, etc.) is rotatably coupled to the pedestal 308 such that the aerial assembly 500 is selectively repositionable into a plurality of operating orientations about a vertical axis, shown as vertical pivot axis 40. As shown in FIGS. 7-10, the torque box 300 includes a pivotal connector, shown as slewing bearing 310, coupled to the pedestal 308. The slewing bearing 310 is a rotational rolling-element bearing with an inner element, shown as bearing element 312, and an outer element, shown as driven gear 314. The bearing element 312 may be coupled to the pedestal 308 with a plurality of fasteners (e.g., bolts, etc.). According to an exemplary embodiment, the bearing element 312 is coupled to the pedestal 308 with a plurality of fasteners that are accessible from a top side of the bearing element 312. By way of example, when the bearing element 312 is coupled to the pedestal 308 by the plurality of fasteners, the bearing element 312 may be coupled and/or decoupled from the pedestal 308 without accessing an underside of the bearing element 312. By way of another example, the fasteners may be inserted through the bearing element 312 from a top side of the bearing element 312 and engage the pedestal 308 to couple the bearing element 312 to the pedestal 308. As a result, the bearing element 312 may be coupled to the pedestal 308 and/or decoupled from the pedestal 308 when another component blocks the bottom side of the bearing element 312 and/or the pedestal 308.

As shown in FIGS. 7-10, a drive actuator, shown as rotation actuator 320, is coupled to the pedestal 308 (e.g., by an intermediate bracket, etc.). The rotation actuator 320 is positioned to drive (e.g., rotate, turn, etc.) the driven gear 314 of the slewing bearing 310. In one embodiment, the rotation actuator 320 is an electric motor (e.g., an alternating current (AC) motor, a direct current motor (DC), etc.) configured to convert electrical energy into mechanical energy. In other embodiments, the rotation actuator 320 is powered by air (e.g., pneumatic, etc.), a fluid (e.g., a hydraulic cylinder, etc.), mechanically (e.g., a flywheel, etc.), or still another power source.

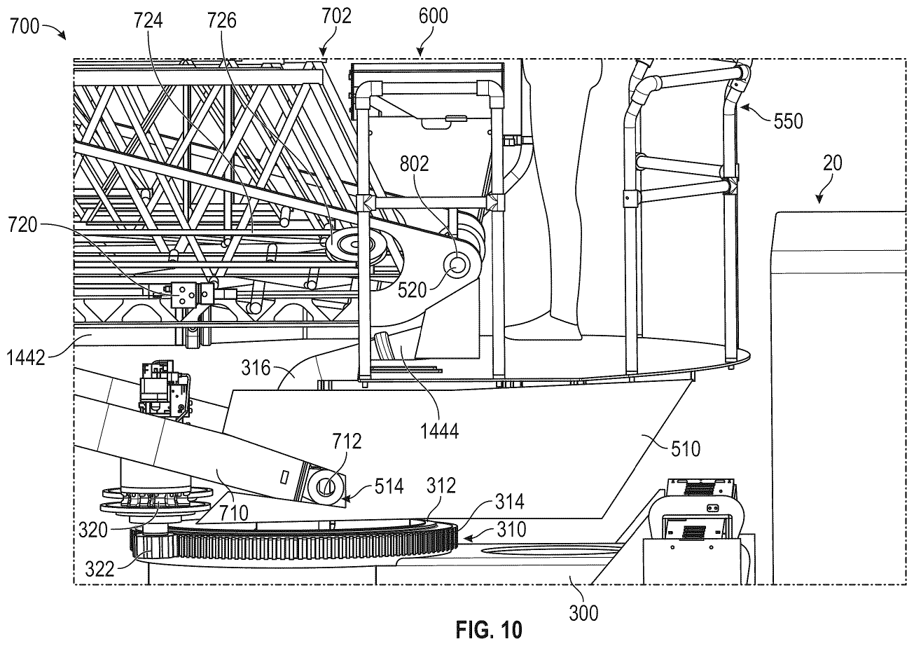

As shown in FIG. 10, the rotation actuator 320 includes a driver, shown as drive pinion 322. The drive pinion 322 is mechanically coupled with the driven gear 314 of the slewing bearing 310. In one embodiment, a plurality of teeth of the drive pinion 322 engage a plurality of teeth on the driven gear 314. By way of example, when the rotation actuator 320 is engaged (e.g., powered, turned on, etc.), the rotation actuator 320 may provide rotational energy (e.g., mechanical energy, etc.) to an output shaft. The drive pinion 322 may be coupled to the output shaft such that the rotational energy of the output shaft drives (e.g., rotates, etc.) the drive pinion 322. The rotational energy of the drive pinion 322 may be transferred to the driven gear 314 in response to the engaging teeth of both the drive pinion 322 and the driven gear 314. The driven gear 314 thereby rotates about the vertical pivot axis 40, while the bearing element 312 remains in a fixed position relative to the driven gear 314.

According to an exemplary embodiment, the turntable 510 includes a first portion (e.g., a rotation base, etc.) and a second portion (e.g., side supports, etc.) that extend vertically upward from opposing lateral sides of the first portion. According to an exemplary embodiment, (i) the work platform 550 is coupled to the second portion of the turntable 510, (ii) the aerial ladder assembly 700 is pivotably coupled to the second portion, (iii) the control console 600 is coupled to the work platform 550, and (iv) the first portion is disposed within the aerial assembly recess 140 and interfaces with and is coupled to the driven gear 314 of slewing bearing 310 such that (i) the aerial assembly 500 is selectively pivotable about the vertical pivot axis 40 using the rotation actuator 320, (ii) at least a portion of the work platform 550 and the aerial ladder assembly 700 is positioned below the roof of the front cabin 20, and (iii) the turntable 510 is coupled rearward of the front cabin 20 and between the front axle 16 and the rear axle 18 (e.g., the turntable 510 is coupled to the frame 12 such that the vertical pivot axis 40 is positioned rearward of a centerline of the front axle 16, forward of a centerline of the rear axle 18, rearward of a rear edge of a tire of the front axle 16, forward of a front edge of a wheel of the rear axle 18, rearward of a front edge of a tire of the front axle 16, forward of a rear edge of a wheel of the rear axle 18, etc.). Accordingly, loading from the aerial ladder assembly 700 and/or the work platform 550 may transfer through the turntable 510 into the torque box 300 and the frame 12.

As shown in FIG. 10, the rear assembly 100 includes a rotation swivel, shown as rotation swivel 316, that includes a conduit. According to an exemplary embodiment, the conduit of the rotation swivel 316 extends upward from the pedestal 308 and into the turntable 510. The rotation swivel 316 may couple (e.g., electrically, hydraulically, fluidly, etc.) the aerial assembly 500 with other components of the fire apparatus 10. By way of example, the conduit may define a passageway for water to flow into the aerial ladder assembly 700. Various lines may provide electricity, hydraulic fluid, and/or water to the aerial ladder assembly 700, actuators, and/or the control console 600.

According to an exemplary embodiment, the work platform 550 provides a surface upon which operators (e.g., fire fighters, rescue workers, etc.) may stand while operating the aerial assembly 500 (e.g., with the control console 600, etc.). The control console 600 may be communicably coupled to various components of the fire apparatus 10 (e.g., actuators of the aerial ladder assembly 700, the rotation actuator 320, a water turret, etc.) such that information or signals (e.g., command signals, fluid controls, etc.) may be exchanged from the control console 600. The information or signals may relate to one or more components of the fire apparatus 10. According to an exemplary embodiment, the control console 600 enables an operator (e.g., a fire fighter, etc.) of the fire apparatus 10 to communicate with one or more components of the fire apparatus 10. By way of example, the control console 600 may include at least one of an interactive display, a touchscreen device, one or more buttons (e.g., a stop button configured to cease water flow through a water nozzle, etc.), joysticks, switches, and voice command receivers. An operator may use a joystick associated with the control console 600 to trigger the actuation of the turntable 510 and/or the aerial ladder assembly 700 to a desired angular position (e.g., to the front, back, or side of fire apparatus 10, etc.). By way of another example, an operator may engage a lever associated with the control console 600 to trigger the extension or retraction of the aerial ladder assembly 700.

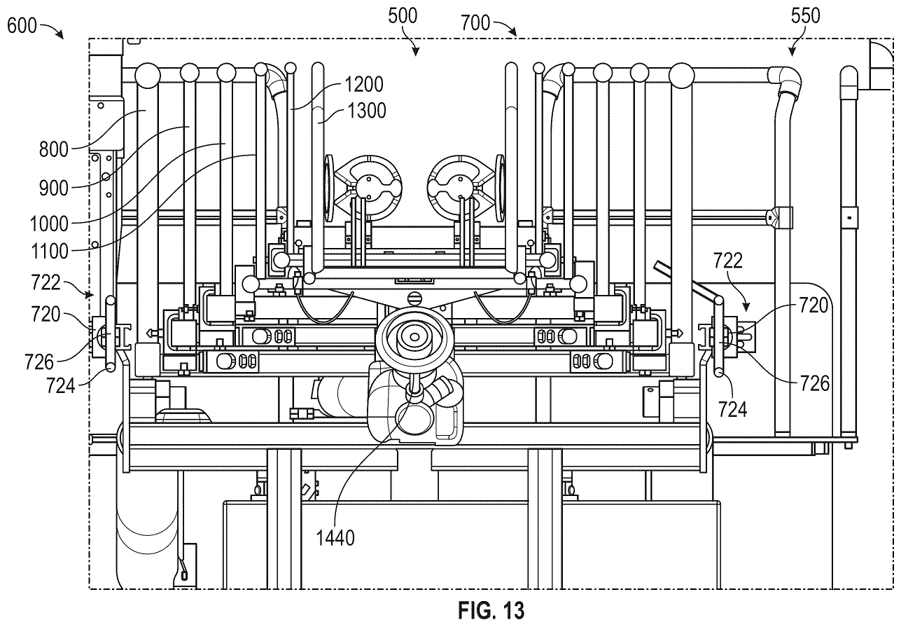

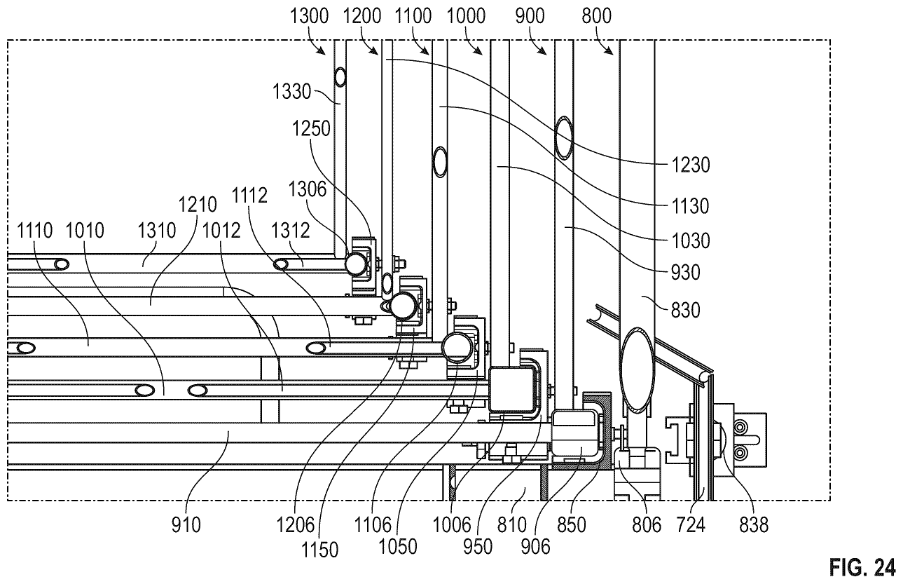

As shown in FIGS. 13-24, the aerial ladder assembly 700 has a plurality of nesting ladder sections (e.g., at least five ladder sections, six ladder sections, etc.) that telescope with respect to one another including a first section, shown as lower base section 800; a second section, shown as middle base section 900; a third ladder section, shown as upper base section 1000; a fourth section, shown as lower middle section 1100; a fifth section, shown as upper middle section 1200; and a sixth section, shown as fly section 1300. For example, the aerial ladder assembly 700 may be a six section ladder (e.g., a multi-section ladder, etc.) including the lower base section 800, the middle base section 900, the upper base section 1000, the lower middle section 1100, the upper middle section 1200, and the fly section 1300. As shown in FIGS. 7-11, the turntable 510 define first interfaces, shown as ladder interfaces 512 (e.g., a pair of ladder interfaces, ladder interface apertures, etc.), and second interfaces, shown as actuator interfaces 514 (e.g., a pair of actuator interfaces, actuator interface aperture, etc.). As shown in FIGS. 7-12 and 14-19, the lower base section 800 of the aerial ladder assembly 700 defines first interfaces, shown as pivot interfaces 802, and second interfaces, shown as actuator interfaces 804. As shown in FIGS. 7-11, the ladder interfaces 512 of the turntable 510 and the pivot interfaces 802 of the lower base section 800 are positioned to align and cooperatively receive a pin, shown as heel pin 520, to pivotably couple the proximal end 702 of the aerial ladder assembly 700 to the turntable 510. As shown in FIGS. 7-10 and 12, the aerial ladder assembly 700 includes first ladder

actuators (e.g., hydraulic cylinders, etc.), shown as pivot actuators 710. Each of the pivot actuators 710 has a first end, shown as end 712, coupled to a respective actuator interface 514 of the turntable 510 and an opposing second end, shown as end 714, coupled to a respective actuator interface 804 of the lower base section 800. According to an exemplary embodiment, the pivot actuators 710 are kept in tension such that retraction thereof lifts and rotates the distal end 704 of the aerial ladder assembly 700 about a lateral axis, shown as lateral pivot axis 42, defined by the heel pin 520. In other embodiments, the pivot actuators 710 are kept in compression such that extension thereof lifts and rotates the distal end 704 of the aerial ladder assembly 700 about the lateral pivot axis 42. In an alternative embodiment, the aerial ladder assembly 700 only includes one pivot actuator 710. As shown in FIGS. 7-10 and 12, the pivot actuators 710 are positioned under the lower base section 800 (e.g., between the lower base section 800 and the turntable 510). By way of example, the actuator interface 804 of the lower base section 800 may be positioned in a lower portion of the lower base section 800 such that the pivot actuators 710 are coupled to the lower base section 800 below the lower base section 800 and positioned below the lower base section 800.

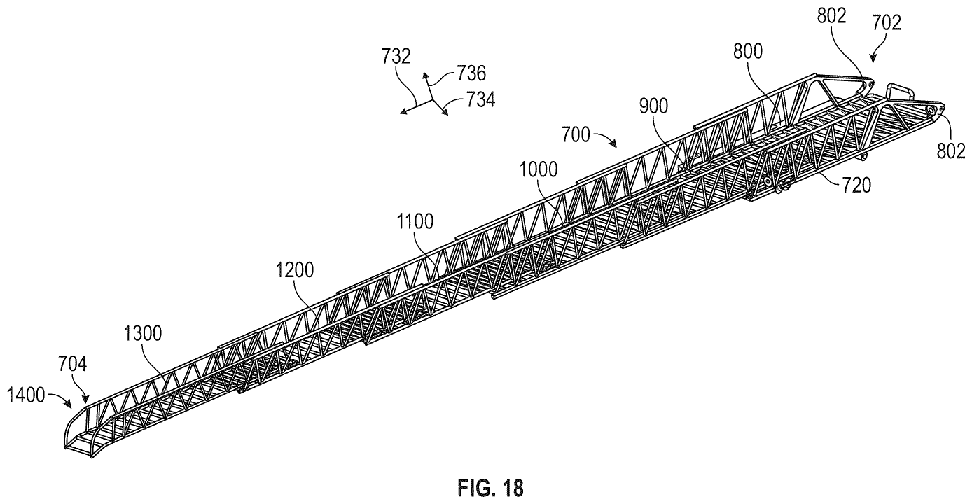

As shown in FIGS. 7-10 and 12-19, the aerial ladder assembly 700 includes one or more second ladders actuators, shown as extension actuators 720. According to an exemplary embodiment, the extension actuators 720 are positioned to facilitate selectively reconfiguring the aerial ladder assembly 700 between an extended configuration (see, e.g., FIG. 18, etc.) and a retracted/stowed configuration (see, e.g., FIGS. 1-3, 7, 8, 14, 15, 17, etc.). In the extended configuration (e.g., deployed position, use position, etc.), the aerial ladder assembly 700 is lengthened, and the distal end 704 is extended away from the proximal end 702. In the retracted configuration (e.g., storage position, transport position, etc.), the aerial ladder assembly 700 is shortened, and the distal end 704 is withdrawn towards the proximal end 702. According to an exemplary embodiment, the aerial ladder assembly 700 weighs less than or equal to about 5,600 pounds (e.g., about 5,100 pounds, etc.).

According to the exemplary embodiment shown in FIG. 1-3 and 15, the aerial ladder assembly 700 has under-retracted ladder sections such that the proximal ends of the middle base section 900, the upper base section 1000, the lower middle section 1100, the upper middle section 1200, and the fly section 1300 are positioned rearward of (i) the heel pin 520 and (ii) the proximal end of the lower base section 800 along the longitudinal axis 14 of the fire apparatus 10 when the aerial ladder assembly 700 is retracted and stowed. For example, the proximal ends of the middle base section 900, the upper base section 1000, the lower middle section 1100, the upper middle section 1200, and the fly section 1300 may be positioned on a same side (e.g., a rearward side, etc.) of the proximal end of the lower base section 800 when the aerial ladder assembly 700 is fully retracted. According to an exemplary embodiment, the distal end 704 of the aerial ladder assembly 700 (e.g., the distal end of the fly section 1300, etc.) is extensible to the horizontal reach of at least 90 feet (e.g., at least 91 feet, at least 92 feet, etc.) and/or a vertical reach of at least 95 feet (e.g., at least 97 feet, at least 100 feet, etc.). According to an exemplary embodiment, the aerial ladder assembly 700 is operable below grade (e.g., at a negative depression angle relative to a horizontal, etc.) within an aerial work envelope or scrub area. In one embodiment, the aerial ladder assembly 700 is operable in the scrub area such that the aerial ladder assembly 700 may pivot about the vertical pivot axis 40 (e.g., up to about 50 degrees, about 20 degrees forward and about 30 degrees rearward from a position perpendicular to the longitudinal axis 14, etc.) on each side of the body 110 while at a negative depression angle (e.g., up to negative 8 degrees, more than negative 8 degrees, up to negative 10 degrees, up to negative 15 degrees, etc. below level, below a horizontal defined by a top surface of the frame 12, etc.). According to an exemplary embodiment, the aerial ladder assembly 700 is operable in a cab area positioned above the front cabin 20 when the aerial ladder assembly 700 is at a positive angle (e.g., greater than 15 degrees, 16 degrees, etc.) such that the aerial ladder assembly 700 does not contact the front cabin 20 when the aerial ladder assembly 700 is positioned above the front cabin 20. According to an exemplary embodiment, when the aerial ladder assembly 700 is positioned above the front cabin 20 and at least four of the tire assemblies 30 are contacting the ground surface, operation of the aerial ladder assembly 700 over the front cabin 20 is not limited (e.g., derated, etc.).

As shown in FIGS. 1-3, 7, 8, 14, 15, 17, 18, 20, 23, and 41-43, the fly section 1300 includes a work portion, shown as work section 1400, configured to hold at least one of fire fighters and persons being aided by the fire fighters. In other embodiments, the aerial assembly 500 does not include the work section 1400. As shown in FIGS. 1, 2, 7, 8, 10-13, 20, and 41-43, the work section 1400 includes a nozzle (e.g., a deluge gun, a water cannon, etc.), shown as water turret 1440, fluidly coupled to a water source (e.g., the water tank 400, an external source, etc.) with a first conduit, shown as extendable conduit 1442, extending along the aerial ladder assembly 700 and a second conduit, shown as connection conduit 1444, extending through the turntable 510. The water turret 1440 is positioned beneath the work section 1400. The extendable conduit 1442 is coupled to the water turret 1440. The extendable conduit 1442 is positioned beneath the aerial ladder assembly 700 and includes a plurality of nesting conduits that are each coupled to one of the plurality of nesting ladder sections. As the aerial ladder assembly 700 expands and retracts, the extendable conduit 1442 may extend and retract with the aerial ladder assembly 700 to continue to provide fluid to the water turret 1440. The connection conduit 1444 is coupled to the extendable conduit 1442. The connection conduit 1444 extends upward through the rotation swivel 316 and includes a portion that is in line with the lateral pivot axis 42 defined by the heel pin 520. Such portion of the connection conduit 1444 that is in line with and extending along the lateral pivot axis 42 may be at least partially surrounded by a frame or step bar of the lower base section 800 extending laterally across the proximal end 702 thereof. As the aerial ladder assembly 700 pivots around the heel pin 520, the portion of the connection conduit 1444 in line with the lateral pivot axis 42 may pivot around the lateral pivot axis 42 to continue to provide fluid to the water turret 1440. By pivoting the aerial ladder assembly 700 into a raised position, the water turret 1440 may be elevated to expel water from a higher elevation to facilitate suppressing a fire. In some embodiments, the work section 1400 is replaced with or additionally includes another tool.

According to an exemplary embodiment, the pump system 200 (e.g., a pump house, etc.) is a mid-ship pump assembly. As shown in FIGS. 1, 2, and 7-9, the pump system 200 is positioned along the rear assembly 100 behind the front cabin 20, rearward of the vertical pivot axis 40 (e.g., rearward of the turntable 510, the torque box 300, the pedestal 308, the slewing bearing 310, the heel pin 520, a front end of the body 110, etc.), and forward of the rear axle 18 such that portions of the lower base section 800, the middle base section 900, the upper base section 1000, the lower middle section 1100, the upper middle section 1200, and the fly section 1300 overhang above the pump system 200 when the aerial ladder assembly 700 is retracted and stowed. According to an exemplary embodiment, the position of the pump system 200 forward of the rear axle 18 facilitates ease of install and serviceability. In other embodiments, the pump system 200 is positioned forward of the vertical pivot axis 40. In still other embodiments, the fire apparatus 10 does not include the pump system 200.

According to an exemplary embodiment, the pump system 200 include a pumping assembly configured to pump fluid. By way of example, the pump assembly may include a pump panel having an inlet for the entrance of water from an external source (e.g., a fire hydrant, etc.), a pump, an outlet configured to engage a hose, various gauges, etc.). The pump of the pump assembly may pump fluid (e.g., water, agent, etc.) through a hose to extinguish a fire (e.g., water received at an inlet of the pump assembly, water stored in the water tank 400, etc.). In some embodiments, the pump assembly includes mechanical valves configured to be manually operated by an operator of the pump system 200 to control the flow of fluid through the pump system 200. For example, the pump assembly may include a mechanical valve that may be rotated to control a flow rate of the fluid output by the pump system 200. According to an exemplary embodiment, the pump system 200 is configured to output a flow rate of fluid up to a flow rate of 1,500 gallons per minute. In other embodiments, the pump system 200 is configured to output a flow rate of fluid greater than 1,500 gallons per minute.

As shown in FIGS. 1-4, 7, 8, 41, and 42, the fire apparatus 10 includes a stability system, shown as stability assembly 1500, including stabilizers, shown as outriggers 1550, coupled to each lateral side of the frame 12 proximate the front cabin 20 and/or the front end 304 of the torque box 300. According to an exemplary embodiment, the outriggers 1550 are selectively deployable (e.g., extendable laterally outward and downward to engage a ground surface). According to an exemplary embodiment, the outriggers 1550 are extendable up to a distance of sixteen feet (e.g., measured between the center of a pad of a first outrigger and the center of a pad of a second outrigger, etc.). In other embodiments, the outriggers 1550 are extendable up to a distance of less than or greater than sixteen feet (e.g., eighteen feet, etc.). In some embodiments, a portion of the outriggers 1550 (e.g., an upper portion, etc.) are integrally formed with the torque box 300. In other embodiments, the outriggers 1550 are positioned under the frame 12. By way of example, the outriggers 1550 may be slung under the frame 12 (e.g., underslung, etc.). In some embodiments, the stability assembly 1500 includes front downriggers coupled to each lateral side of the front bumper 22 and/or the frame 12 at the front end 2 of the frame 12. The front downriggers may be selectively deployable (e.g., extendable, etc.) downward to engage a ground surface. In some embodiments, the stability assembly 1500 includes rear downriggers and/or rear outrigger coupled to each lateral side of the frame 12 at or proximate the rear end 4 of the frame 12. The rear downriggers may be selectively deployable (e.g., extendable, etc.) laterally outward and/or downward to engage a ground surface.

According to an exemplary embodiment, the outriggers 1550 are positioned to transfer the loading from the aerial ladder assembly 700 to the ground. For example, a load applied to the aerial ladder assembly 700 (e.g., a fire fighter at the distal end 704, a wind load, etc.) may be conveyed into to the turntable 510, through the pedestal 308 and the torque box 300, to the frame 12, and into the ground through the outriggers 1550. When the outriggers 1550 engage with a ground surface, portions of the fire apparatus 10 (e.g., the front end 2, the rear end 4, etc.) may be elevated relative to the ground surface. One or more of the wheel and tire assemblies 30 may remain in contact with the ground surface, but may not provide any load bearing support. While the fire apparatus 10 is being driven or not in use, the outriggers 1550 may be retracted into a stored position.

According to an exemplary embodiment, the outriggers 1550 can be extended different distances from the body 110. By way of example, a first of the outriggers 1550 on a first side (e.g., a left side, etc.) of the fire apparatus 10 may be extended a first distance from the body 110 and a second of the outriggers 1550 on a second side (e.g., a right side, etc.) of the fire apparatus 10 may be extended a second distance from the body 110, the second distance different from the first distance (e.g., short-jacking). By way of another example, a first of the outriggers 1550 on a first side of the fire apparatus 10 may be fully extended and a second of the outriggers 1550 on a second side of the fire apparatus 10 may be partially extended. By extending the outriggers 1550 different distances from the body 110, contact between the outriggers 1550 and obstacles (e.g., buildings, other vehicles, fire hydrants, etc.) proximate the fire apparatus 10 may be prevented.

According to an exemplary embodiment, with (i) the outriggers 1550 extended and (ii) the aerial ladder assembly 700 fully extended (e.g., at a horizontal reach of 91 feet, at a vertical reach of 100 feet, etc.), the fire apparatus 10 withstands a rated tip load (e.g., capable of accommodating, rated meaning that the fire apparatus 10 can, from a design-engineering perspective, withstand a greater tip load, with an associated factor of safety of at least two, meets National Fire Protection Association (“NFPA”) requirements, etc.) of at least 500 pounds applied to the work section 1400. In some embodiments, the fire apparatus 10 withstands the rated tip load of at least 500 pounds applied to the work section 1400 when a wind speed is up to 35 miles per hour. In some embodiments, with (i) the outriggers 1550 extended and (ii) the aerial ladder assembly 700 fully extended (e.g., at a horizontal reach of 91 feet, at a vertical reach of 100 feet, etc.), the fire apparatus 10 withstands a rated tip load of at least 500 pounds applied to the work section 1400 plus an additional 100 pound allowance for added equipment (e.g., nozzles, accessories, tools, etc.). In some embodiments, the fire apparatus 10 withstands a rated dry tip load of at least 500 pounds applied to the work section 1400 when the aerial ladder assembly 700 is in a dry state (e.g., when water is not flowing to a nozzle of the work section 1400, etc.) and a rated wet tip load of at least 500 pounds applied to the work section 1400 when the aerial ladder assembly 700 is in a wet state (e.g., when water is flowing to the water turret 1440 of the work section 1400, etc.). In embodiments where the aerial ladder assembly 700 is in the dry state, the fire apparatus 10 may have a rated tip load of more than 500 pounds (e.g., 750 pounds, 1,000 pounds, etc.) when the aerial ladder assembly 700 is fully extended. In such embodiments, the stability assembly 1500 may include additional stabilizers (e.g., front downriggers, rear downriggers, rear outriggers, etc.).

According to an exemplary embodiment, the front axle 16 has at most a 24,000 pound axle rating and the rear axle 18 has at most a 35,000 pound axle rating. Some state regulations prevent vehicles having such a high axle loading, and, therefore, vehicles with axle ratings above high axle loading thresholds are unable to be sold and operated in such states. Advantageously, the fire apparatus 10 of the present disclosure has a gross axle weight loading of at most 24,000 pounds on the front axle 16 and at most 35,000 pounds on the rear axle 18, and, therefore, the fire apparatus 10 may be sold and operated in any state of the United States. In some embodiments, the rear axle 18 has an axle rating below 35,000 pounds (e.g., 33,500 pound axle rating, etc.).

As shown in FIG. 2, the fire apparatus 10 has a height H. According to an exemplary embodiment, the height H of the fire apparatus 10 is at most about 130 inches (i.e., 10 feet, 10 inches). As shown in FIG. 2, the fire apparatus 10 has a longitudinal length L. According to an exemplary embodiment, the longitudinal length L of the fire apparatus 10 is at most about 504 inches (i.e., 42 feet). By way of example, the longitudinal length L of the fire apparatus 10 may be 493.5 inches. In other embodiments, the fire apparatus 10 has a length L greater than 504 inches. As shown in FIG. 2, the fire apparatus 10 has a distance D between(a) the front end 2 of the front cabin 20 and/or the front bumper 22 and (b) the rear end of the body 110. According to an exemplary embodiment, the distance D of the fire apparatus 10 is at most about 430 inches (35 feet, 10 inches). In other embodiments, the fire apparatus 10 has a distance D that is greater than 430 inches. The length D may be shorter than a longitudinal length of a body of a traditional mid-mount fire apparatus with comparable extension capabilities (e.g., a horizontal reach of at least 91 feet and/or or a vertical reach of at least 100 feet, etc.) as the fire apparatus 10. Decreasing the length L and/or the length D of the fire apparatus 10 improves drivability and maneuverability, and substantially reduces the amount of damage that fire departments may inflict on public and/or private property throughout a year of operating their fire trucks. According to an exemplary embodiment, when the aerial ladder assembly 700 is in the retracted configuration, the aerial ladder assembly 700 is positioned within a turning envelope of the body 110 (e.g., a horizontal turning area, a swept horizontal area containing the body 110, etc.) during a turn of the fire apparatus 10.

One solution to reducing the overall length of a fire truck is to configure the fire truck as a rear-mount fire truck with the ladder assembly overhanging the front cabin (e.g., in order to provide a ladder assembly with comparable extension capabilities, etc.). Overhanging the ladder assembly reduces driver visibility, as well as rear-mount fire trucks do not provide as much freedom when arriving at a scene on where and how to position the truck, which typically requires the truck to be reversed into position to provide the desired amount of reach (e.g., which wastes valuable time, etc.). Further, the height of the rear-mount fire truck is required to be higher than the height H of the fire apparatus 10 (e.g., by approximately one foot, etc.) so that the ladder assembly of the rear-mount fire truck can clear the front cabin thereof.

### Aerial Ladder Assembly Structure

As shown in FIGS. 13-17, each extension actuator 720 is part of a cable control assembly 722. As the extension actuator 720 extends and retracts, a cable 724 is pulled into and/or payed out of the cable control assembly 722. The cables 724 extend along each of the lower base section 800, the middle base section 900, the upper base section 1000, the lower middle section 1100, the upper middle section 1200, and the fly section 1300 between a series of pulleys 726. The pulleys 726 are rotatably coupled to the lower base section 800, the middle base section 900, the upper base section 1000, the lower middle section 1100, the upper middle section 1200, and the fly section 1300. As the cable control assembly 722 pulls the cable 724 in and pays/or out the cable 724, the cable 724 exerts forces on the pulleys 726, which forces the aerial ladder assembly 700 to extend or retract. The cable control assemblies 722, the cables 724, and the pulleys 726 actively control both the extension and retraction of the aerial ladder assembly 700 such that the aerial ladder assembly 700 can extend and retract independent of the force of gravity.

Referring to FIGS. 14-20, a longitudinal axis 732, a lateral axis 734, and a vertical axis 736 are defined with respect to the aerial ladder assembly 700. A center plane 738 is defined perpendicular to the lateral axis 734 (i.e., parallel to the longitudinal axis 732 and the vertical axis 736). The center plane 738 is laterally centered with respect to the aerial ladder assembly 700 (e.g., with respect to each ladder section of the aerial ladder assembly 700).

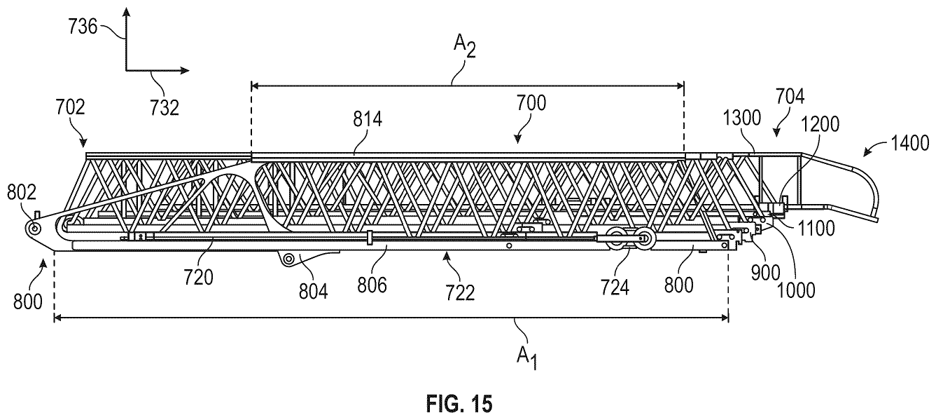

As shown in FIGS. 15, 16, 20, 21, 23, and 24, the lower base section 800 receives the middle base section 900, the middle base section 900 receives the upper base section 1000, the upper base section 1000 receives the lower middle section 1100, the lower middle section 1100 receives the upper middle section 1200, and the upper middle section 1200 receives the fly section 1300. In some embodiments, top surfaces of the lower base section 800, the middle base section 900, the upper base section 1000, the lower middle section 1100, the upper middle section 1200, and the fly section 1300 (e.g., top surfaces of hand rails of each of the lower base section 800, the middle base section 900, the upper base section 1000, the lower middle section 1100, the upper middle section 1200, and the fly section 1300, etc.) are all level with one another (e.g., arranged in the same horizontal plane, substantially level with each other, aligned with each other, etc.). By aligning the top surfaces of the lower base section 800, the middle base section 900, the upper base section 1000, the lower middle section 1100, the upper middle section 1200, and the fly section 1300, a person climbing the aerial ladder assembly 700 and grabbing the top surfaces (e.g., hand rails, etc.) of the lower base section 800, the middle base section 900, the upper base section 1000, the lower middle section 1100, the upper middle section 1200, and the fly section 1300 may not change a height of their hands as they climb the aerial ladder assembly 700. To facilitate this arrangement, each ladder section is taller and wider than the ladder section that it directly supports. As such, the upper middle section 1200 is taller and wider than the fly section 1300, the lower middle section 1100 is taller and wider than the upper middle section 1200, the upper base section 1000 is taller and wider than the lower middle section 1100, the middle base section 900 is taller and wider than the upper base section 1000, and the lower base section 800 is taller and wider than the middle base section 900.

As shown in FIGS. 15, 16, 20, 21, 23, and 24, each ladder section directly supports or indirectly supports all of the ladder sections above it. By way of example, the middle base section 900 supports the upper base section 1000 directly as well as the lower middle section 1100, the upper middle section 1200, and the fly section 1300 indirectly. Accordingly, each sequential ladder section is configured to support a greater load than the ladder section that it directly supports. As such, the upper middle section 1200 is taller and wider than the fly section 1300, the. This is accomplished using structural members of different cross sections, material specifications, and/or thicknesses.

As shown in FIGS. 15, 16, 21, and 23-25, the lower base section 800 includes a first pair of support members, shown as lower base rails 806; a first series of structural members or steps, shown as lower base ladder rungs 810, that extend between the lower base rails 806; a first pair of hand rails, shown as lower base hand rails 814, extending longitudinally along the lower base section 800; a first series of structural members, shown as lower base angled lacing members 830, extending between the lower base rails 806 and the lower base hand rails 814; a first structural assembly, shown as pulley support assembly 838, configured to support the pulleys 726; a first plurality of slide assemblies, shown as lower base load transfer assemblies 850, slidably coupled to the middle base section 900; the actuator interface 804 extending from a proximal end of the lower base rails 806; and the actuator interface 804 extending from the lower base rails 806.

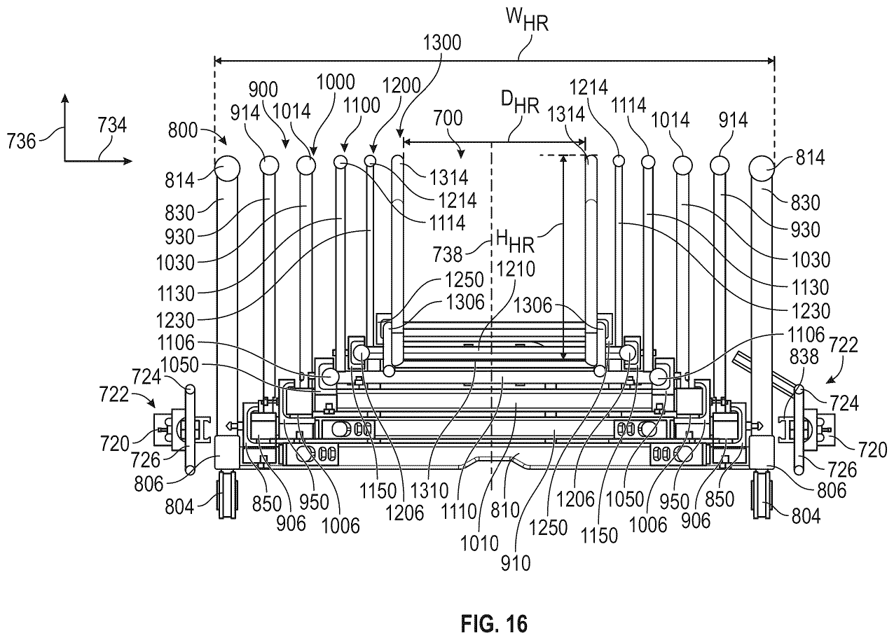

The lower base rails 806 are symmetrically arranged about the center plane 738. As shown in FIGS. 16, 23, and 24, the lower base rails 806 are tubular members each having a rectangular cross section. By way of example, the lower base rails 806 may be formed from rectangular tubular members with a height of 1.5 inches, a width of 2 inches, and a wall thickness of 0.071 inches. In other embodiments, the lower base rails 806 have other cross sectional shapes (e.g., C-channel, circular, square, etc.). Further alternatively, the lower base rails 806 may be made from one or more members (e.g., tubular members, C-channels, rectangular sections, etc.) coupled to one or more plates. In some embodiments, the lower base rails 806 are formed from steel with a yield strength that is less than or equal to 100 kilopounds per square inch (ksi). By way of example, the lower base rails 806 may be formed from steel with a yield strength that is less than or equal to 100 ksi due to the cross section of the lower base rails 806. In other embodiments, the lower base rails 806 are formed from steel with a yield strength that is greater than 100 ksi.

The ends of the lower base rails 806 may be capped (e.g., a plate welded over the open end) to prevent debris from entering the lower base rails 806. In some embodiments, each of the lower base rails 806 defines a pair of apertures that extend from an outer surface of the lower base rails 806 to an interior volume of the lower base rails 806. The apertures are arranged near opposite ends of the lower base section 800. The cables 724 may pass through one aperture, through the interior volume of the lower base rails 806, and out through the other aperture. This arrangement reduces the length of the cable 724 that is exposed (e.g., positioned outside of the lower base rails 806, etc.), reducing the chances of an operator or piece of equipment being caught by the cables 724. In other embodiments, other components extend through the apertures and into the lower base rails 806, such as wires or hoses.

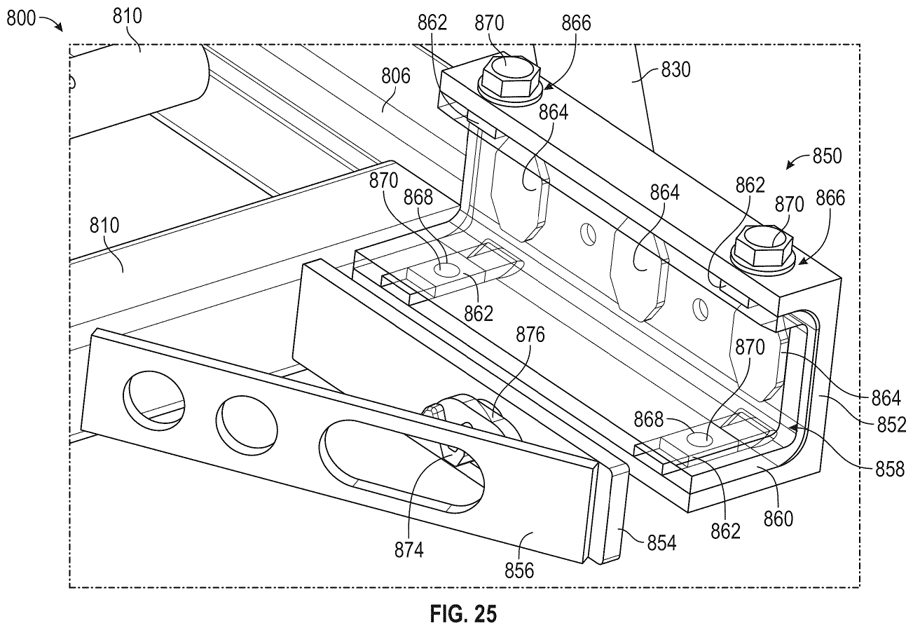

As shown in FIGS. 16, 20, and 23-25, the lower base ladder rungs 810 are coupled to each of the lower base rails 806, thereby indirectly fixedly coupling the lower base rails 806 together. The lower base ladder rungs 810 are tubular members. As shown in FIGS. 16, 24-26, at least one of the lower base ladder rungs 810 have a rectangular cross section and at least one of the lower base ladder rungs 810 have a round cross section. For example, one of the lower base ladder rungs 810 closest to the proximal end of the lower base section 800 and/or one of the lower base ladder rungs 810 closest to a distal end of the lower base section 800 may have a rectangular cross section and a remainder of the lower base ladder rungs 810 may have a round cross section. The lower base ladder rungs 810 are configured to act as steps to support the weight of operators and their equipment as the operators ascend or descend the aerial ladder assembly 700. According to the exemplary embodiment shown in FIGS. 23 and 25, the lower base section 800 includes support members, shown as lower base ladder rung supports 812. The lower base ladder rung supports 812 extend between one of the lower base rails 806 and one of the lower base ladder rungs 810 at an angle relative to the lower base rails 806 (e.g., 30 degrees, 45 degrees, etc.). Each of the lower base ladder rung supports 812 is coupled to one of the lower base rails 806 and one of the lower base ladder rungs 810. Each of the lower base ladder rungs 810 engages a pair of the lower base ladder rung supports 812. The lower base ladder rung supports 812 extend below the corresponding lower base ladder rungs 810 when the aerial ladder assembly 700 is raised. Accordingly, the lower base ladder rung supports 812 help to support the downward weight of the operators and their equipment applied on the lower base ladder rungs 810. In other embodiments, the lower base ladder rungs 810 and/or the lower base ladder rung supports 812 have other cross sectional shapes (e.g., C-channel, square, rectangular, etc.).

As shown in FIGS. 15, 16, 20, and 23, each of the lower base hand rails 814 is positioned above and laterally aligned with one of the lower base rails 806. The lower base hand rails 814 are symmetrically arranged about the center plane 738. In some embodiments, the lower base hand rails 814 are tubular members each having a circular cross section. In other embodiments, the lower base hand rails 814 have other cross sectional shapes (e.g., C-channel, T-bracket, square, rectangular, etc.). In some embodiments one or more surfaces of the lower base hand rails 814 are shaped, textured (e.g., knurled, slotted, etc.), or otherwise configured to facilitate a solid grip by the user on the lower base hand rails 814. As shown in FIG. 16, there is a width W_{HR} of the lower base hand rails 814 from an outside of a first of the lower base hand rails 814 to an outside of a second of the lower base hand rails 814. According to an exemplary embodiment, the width W_{HR} of the lower base hand rails 814 is greater than 62 inches (e.g., 62.5 inches, 64.5 inches, etc.). In other embodiments, the width W_{HR} of the lower base hand rails 814 is less than or equal to 62 inches.

As shown in FIGS. 16, 20, and 23-25, the lower base angled lacing members 830 are coupled between each of the lower base rails 806 and the corresponding of the lower base hand rails 814. In some embodiments, the lower base angled lacing members 830 are each tubular members. In other embodiments, the lower base angled lacing members 830 have solid cross sections. The lower base angled lacing members 830 extend within a plane parallel to the center plane 738. The lower base angled lacing members 830 are oriented at an angle (e.g., an oblique angle, etc.) relative to the longitudinal axis 732 (e.g., 30 degrees, 45 degrees, 60 degrees, etc.). The lower base rails 806, the corresponding lower base hand rail 814, and the corresponding lower base angled lacing members 830 form a truss structure that resists bending about a lateral axis.

The lower base angled lacing members 830 are each coupled to the corresponding lower base rails 806 at lower ends (e.g., first ends, etc.) of the lower base angled lacing members 830. The lower base angled lacing members 830 are each coupled to the corresponding lower base hand rails 814 at upper ends (e.g., opposing second ends, etc.) of the lower base angled lacing members 830. According to the exemplary embodiment shown in FIGS. 16, 20, and 23-25, the lower ends of the lower base angled lacing members 830 are coupled to a top surface of the lower base rails 806 such that a plane parallel to the center plane 738 extends through one of the lower base rails 806, the corresponding lower base angled lacing members 830, and the corresponding lower base hand rail 814. The lower base rails 806 extend a first length A₁ in the longitudinal direction. The lower base hand rails 814 extend a second length A₂ in the longitudinal direction. The length A₂ is less than the length A₁.

As shown in FIG. 16, and 23-25, the pulley support assemblies 838 are configured to support one of the pulleys 726. By way of example, a bracket that supports one of the pulleys 726 may be coupled to each of the pulley support assembly 838 to support the corresponding pulleys 726. According to an exemplary embodiment, the pulley support assembly 838 facilitate adjustment of a position of the corresponding pulley 726 relative to the pulley support assembly 838.

As shown in FIGS. 16, 20, 21 and 23-25, the lower base load transfer assemblies 850 are each coupled to one of the lower base rails 806. The lower base load transfer assemblies 850 are configured to slidably couple to the middle base section 900 to facilitate extension and retraction of the middle base section 900 relative to the lower base section 800. By way of example, the lower base load transfer assemblies 850 may engage the middle base section 900 and facilitate moving the middle base section 900 relative to the lower base section 800 along the longitudinal axis 732.

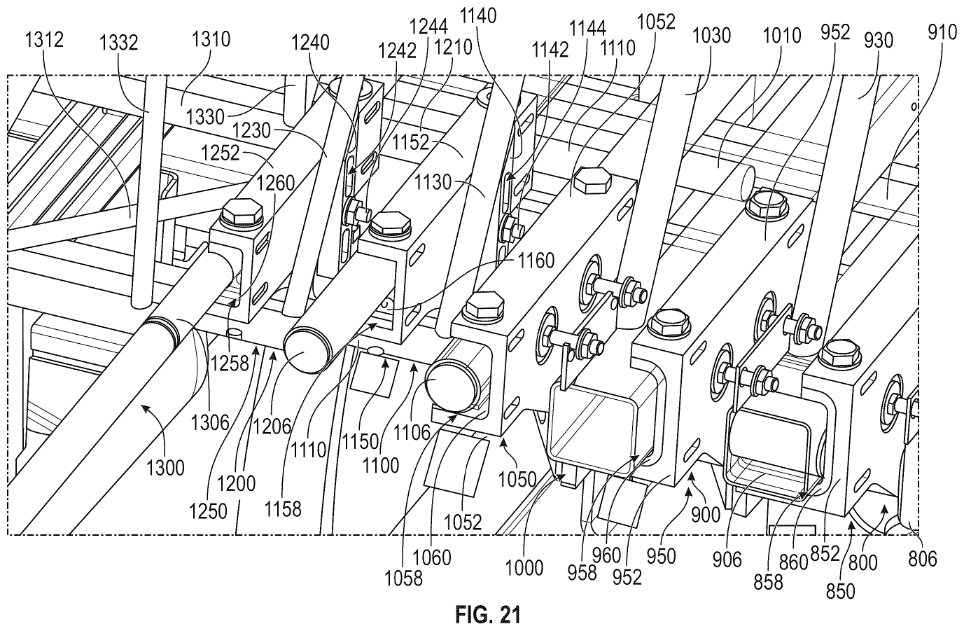

As shown in FIGS. 21 and 23-26, the lower base load transfer assemblies 850 include a first load transfer body, shown as lower base load transfer body 852, coupled to one of the lower base rails 806, a first support plate, shown as first lower base load transfer support plate 854, coupled to the lower base load transfer bodies 852 and at least one of the lower base ladder rungs 810, a second support plate, shown as second lower base load transfer support plate 856, coupled between the first lower base load transfer support plate 854 and one of the lower base ladder rungs 810, and a first load transfer pad, shown as lower base load transfer pad 860. In some embodiments, the lower base load transfer assemblies 850 do not include the second lower base load transfer support plate 856. For example, the rearward of the lower base load transfer assemblies 850 may not include the second lower base load transfer support plate 856 and the first lower base load transfer support plate 854 of the rearward of the lower base load transfer assemblies 850 may be coupled between two of the lower base ladder rungs 810.

As shown in FIGS. 21, 25, and 26, the lower base load transfer bodies 852 define a first channel, shown as lower base load transfer channel 858, configured to receive a portion of the middle base section 900 to slidably couple the middle base section 900 to the lower base load transfer assemblies 850. The lower base load transfer channels 858 may prevent movement of the middle base section 900 relative to the lower base section 800 in a first direction of the lateral axis 734 and/or a second direction of the vertical axis 736. According to the exemplary embodiment shown in FIGS. 21, 25, and 26, the lower base load transfer channels 858 have square cross sections to receive rectangular portions of the middle base section 900 (e.g., a square base rail of the middle base section 900, etc.). In other embodiments, the lower base load transfer channels 858 have other cross sections (e.g., rectangular, etc.) to receive portions of the middle base section 900.

According to an exemplary embodiment, the lower base load transfer bodies 852 are movably coupled to the lower base rails 806 to facilitate adjustment of relative positions of the lower base load transfer bodies 852 in a direction of the vertical axis 736. By way example, a first of the lower base load transfer bodies 852 coupled to one of the lower base rails 806 may be moved relative to the one of lower base rails 806 in the direction of the vertical axis 736 to adjust an alignment of a first of the lower base load transfer channels 858 of the first of the lower base load transfer bodies 852 relative to a second of the lower base load transfer channels 858 of a second of the lower base load transfer bodies 852 coupled to the one of the lower base rails 806 such that the first of the lower base load transfer channels 858 and the second of the lower base load transfer channels 858 may align to receive a square portion of the middle base section 900.

According to an exemplary embodiment, the lower base load transfer bodies 852 are pivotably coupled to the lower base rails 806 to facilitate adjustment between a relative position of the lower base section 800 and a relative position of the middle base section 900. By way of example, as the middle base section 900 moves from a retracted position towards an extended position, the lower base load transfer bodies 852 may pivot relative to the lower base rails 806 to compensate for relative movement between the middle base section 900 and the lower base section 800 and/or deformation of the middle base section 900. In other embodiments, at least a portion of the lower base load transfer bodies 852 are fixedly coupled to the lower base rails 806. By way of example, the forward of the lower base load transfer bodies 852 may be fixedly coupled to the lower base rails 806 and the rearward of the lower base load transfer bodies 852 may be movably and/or pivotably coupled to the lower base rails 806.

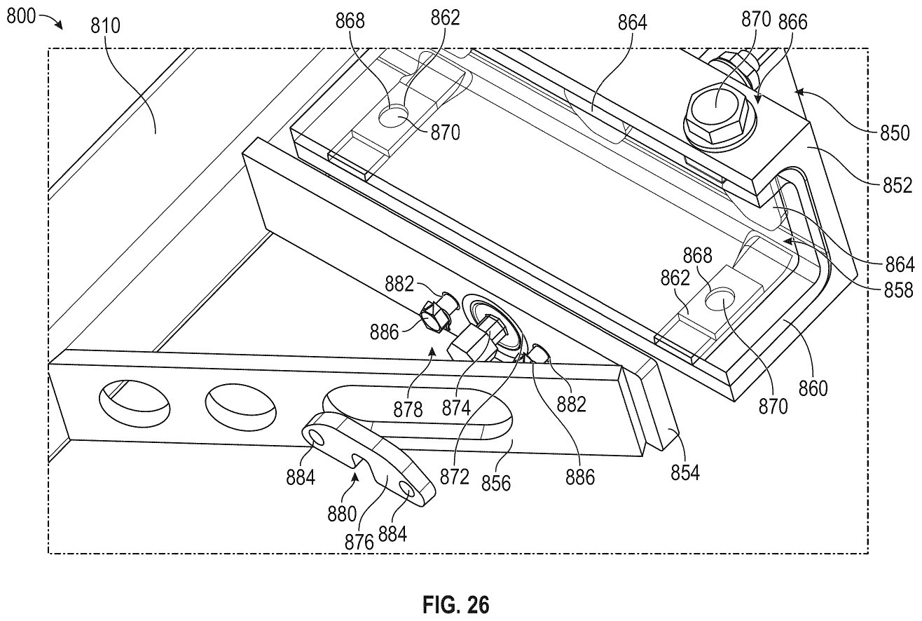

As shown in FIGS. 25 and 26, the lower base load transfer pads 860 are positioned within the lower base load transfer channels 858. The lower base load transfer pads 860 are configured to facilitate the middle base section 900 sliding relative to the lower base load transfer bodies 852. By way of example, the lower base load transfer pads 860 may be formed from a material with low friction properties (e.g., polymer, plastic, ceramic, dry lubricant, materials with a low surface roughness, materials with a high hardness, materials with lower friction properties than steel, etc.) so that the lower base load transfer pads 860 may form a low coefficient of friction with other surfaces (e.g., lower than a coefficient of friction between two steel surfaces, a low coefficient of friction with a portion of the middle base section 900, etc.).

As shown in FIGS. 25 and 26, the lower base load transfer assemblies 850 includes a first plurality of pads, shown as lower base load transfer horizontal pads 862, and a second plurality of pads, shown as lower base load transfer vertical pads 864. The lower base load transfer horizontal pads 862 and the lower base load transfer vertical pads 864 are positioned between the lower base load transfer pad 860 and the lower base load transfer bodies 852. The lower base load transfer horizontal pads 862 and the lower base load transfer vertical pads 864 may be received within openings (e.g., slots, cavities, etc.) defined by the lower base load transfer pad 860. The lower base load transfer horizontal pads 862 and the lower base load transfer vertical pads 864 are configured to absorb a portion of a load transferred from the middle base section 900 to the lower base section 800. By way of example, the lower base load transfer horizontal pads 862 and the lower base load transfer vertical pads 864 may be formed from a material configured to deform to absorb a portion of a load to cushion the lower base load transfer bodies 852 from forces transferred from the middle base section 900 to the lower base section 800 via the lower base load transfer pad 860.

As shown in FIGS. 25 and 26, the lower base load transfer bodies 852 define a first plurality of apertures, shown as pad apertures 866, extending through the lower base load transfer bodies 852 and aligning with the lower base load transfer channels 858. As shown in FIGS. 25 and 26, the lower base load transfer horizontal pads 862 define first apertures, shown as retaining apertures 868, extending through the lower base load transfer horizontal pads 862. The retaining apertures 868 are configured to align with the pad apertures 866 of the lower base load transfer bodies 852 to selectively receive a first plurality of fasteners (e.g., bolts, screws, rivets, nails, anchors, etc.), shown as horizontal pad fasteners 870, to removably couple the lower base load transfer horizontal pads 862 to the lower base load transfer bodies 852. The horizontal pad fasteners 870 and the lower base load transfer horizontal pads 862 may inhibit movement of the lower base load transfer pad 860 relative to the lower base load transfer bodies 852 (e.g., in a direction of the longitudinal axis 732, in a direction of the lateral axis 734, in a direction of the vertical axis 736, etc.).

As shown in FIGS. 25 and 26, the first lower base load transfer support plate 854 defines a second aperture, shown as lower base load transfer alignment aperture 872, configured to receive first alignment pin, shown as lower base load transfer alignment pin 874. The lower base load transfer alignment pin 874 extends through the lower base load transfer bodies 852 (e.g., through an aperture defined by the lower base load transfer bodies 852 and extending through the lower base load transfer bodies 852, etc.) and at least partially into one of the lower base rails 806 (e.g., into an aperture defined by the lower base rails 806, etc.). The lower base load transfer alignment pin 874 is configured to facilitate adjustment of the lower base load transfer bodies 852 in the direction of the vertical axis 736. By way of example, the lower base load transfer alignment pin 874 may be an offset pin defining a first central axis at a first end of the lower base load transfer alignment pin 874 extending through the lower base load transfer alignment aperture 872 (e.g., rotatably coupled to the first lower base load transfer support plate 854 through the lower base load transfer alignment aperture 872, etc.) and a second central axis offset from the first central axis at an opposing second end of the lower base load transfer alignment pin 874 extending into the lower base rails 806 (e.g., rotatably coupled to the lower base rails 806 through an aperture defined by the lower base rails 806, etc.). An operator of the lower base load transfer assemblies 850 may rotate the lower base load transfer alignment pin 874 in a first rotational direction to move the lower base load transfer bodies 852 relative to the one of the lower base rails 806 in a first direction parallel to the vertical axis 736 and in an opposing second rotational direction to move the lower base load transfer bodies 852 relative to the one of the lower base rails 806 in an opposing second direction parallel to the vertical axis 736 due to the offset between the first central axis of the lower base load transfer alignment pin 874 and the second central axis of the lower base load transfer alignment pin 874 (e.g., rotation of the lower base load transfer alignment pin 874 may move the first central axis in a direction parallel to the vertical axis 736 relative to the second central axis, etc.).

As shown in FIGS. 25 and 26, the lower base load transfer assemblies 850 include a first lock plate, shown as lower base load transfer lock plate 876, coupled to the first lower base load transfer support plate 854. The lower base load transfer lock plates 876 are configured to engage the lower base load transfer alignment pins 874 to prevent rotation of the lower base load transfer alignment pin 874 such that movement of the lower base load transfer bodies 852 relative to the lower base rails 806 in the direction parallel to the vertical axis 736 is prevented (e.g., inhibited, etc.). When the lower base load transfer lock plate 876 engages the lower base load transfer alignment pin 874, the lower base load transfer bodies 852 may continue to pivot relative to the lower base rails 806. By way of example, the lower base load transfer bodies 852 may be rotatably coupled to the lower base load transfer alignment pin 874 and may pivot around the lower base load transfer alignment pin 874 when the lower base load transfer lock plate 876 engages the lower base load transfer alignment pin 874 and inhibits rotation of the lower base load transfer alignment pin 874 relative to the first lower base load transfer support plate 854 (e.g., relative to the lower base rails 806, etc.).

As shown in FIG. 26, the lower base load transfer alignment pin 874 defines a first profile, shown as hexagonal profile 878, at the first end of the lower base load transfer alignment pin 874. The hexagonal profile 878 may extend along the first central axis of the lower base load transfer alignment pin 874. As shown in FIG. 26, the lower base load transfer lock plate 876 defines an opening, shown as hexagonal opening 880, configured to engage the hexagonal profile 878 of the lower base load transfer alignment pin 874. When the hexagonal opening 880 of the lower base load transfer lock plate 876 engages the hexagonal profile 878 of the lower base load transfer alignment pin 874, rotation of the lower base load transfer alignment pin 874 may be prevented. In other embodiments, the hexagonal profile 878 and the lower base load transfer lock plate 876 may have different corresponding shapes (e.g., square, octagonal, etc.).

As shown in FIG. 26, the first lower base load transfer support plate 854 defines a second plurality of apertures, shown as mounting apertures 882, extending through the first lower base load transfer support plate 854. As shown in FIG. 26, the lower base load transfer lock plate 876 defines a third plurality of apertures, shown as lock apertures 884, extending through the lower base load transfer lock plate 876. The lock apertures 884 are configured to align with the mounting apertures 882 to selectively receive a second plurality of fasteners, shown as locking fasteners 886, to removably couple the lower base load transfer lock plate 876 to the first lower base load transfer support plate 854. To adjust the position of the lower base load transfer bodies 852 in the direction parallel to the vertical axis 736, an operator of the lower base load transfer assemblies 850 may remove the locking fasteners 886, disengage the hexagonal opening 880 from the hexagonal profile 878, rotate the lower base load transfer alignment pin 874 relative to the lower base rails 806, the lower base load transfer bodies 852, and the first lower base load transfer support plate 854, engage the hexagonal opening 880 with the hexagonal profile 878, and insert the locking fasteners 886 through the mounting apertures 882 and the lock aperture 884.

At least a portion of the lower base section 800 may be assembled as a weldment. By way of example, two or more of the pivot interfaces 802, the actuator interface 804, the lower base rails 806, the lower base ladder rungs 810, the lower base ladder rung supports 812, the lower base angled lacing members 830, the lower base hand rails 814, and the pulley support assembly 838 may be provided as separate components. These separate components may be fixedly coupled to one another as shown and described herein through welding. Additionally or alternatively, one or more of the components of the lower base section 800 may be fastened together. By way of example, the lower base load transfer assemblies 850 may be slidably coupled to the lower base rails 806 via fasteners (e.g., bolds, pins, etc.) to facilitate slidable adjustment of the lower base load transfer assemblies 850 relative to the lower base rails 806.

As shown in FIGS. 15, 16, and 20-24, the middle base section 900 includes a second pair of support members, shown as middle base rails 906, a second series of structural members or steps, shown as middle base ladder rungs 910, that extend between the middle base rails 906, a second pair of hand rails, shown as middle base hand rails 914, extending longitudinally along the middle base section 900, a second series of structural members, shown as middle base angled lacing members 930, extending between the middle base rails 906 and the middle base hand rails 914, and a second plurality of slide assemblies, shown as middle base load transfer assemblies 950, slidably coupled to the upper base section 1000. According to an exemplary embodiment, the middle base section 900 includes a second pulley support assembly configured to support the pulleys 726.

The middle base rails 906 are symmetrically arranged about the center plane 738. The middle base rails 906 are configured to be received by the lower base load transfer channels 858 of the lower base load transfer assemblies 850 to slidably couple the middle base section 900 to the lower base section 800. By way of example, a first of the middle base rails 906 may be received by the lower base load transfer channels 858 of a first and a second of the lower base load transfer assemblies 850 and a second of the middle base rails 906 may be received by the lower base load transfer channels 858 of a third and a fourth of the lower base load transfer assemblies 850 such that the middle base section 900 is held between the lower base load transfer assemblies 850. As shown in FIGS. 16 and 21-23, the middle base rails 906 are tubular members each having a square cross section such that the middle base rails 906 may be received by the lower base load transfer channels 858 with the square cross sections. By way of example, the middle base rails 906 may be formed from square tubular members with a height of 1.5 inches, a width of 1.5 inches, and a wall thickness of 0.071 inches. In other embodiments, the middle base rails 906 have other cross sectional shapes (e.g., C-channel, circular, rectangular, etc.) corresponding to the cross section of the lower base load transfer channels 858. Further alternatively, the middle base rails 906 may be made from one or more members (e.g., tubular members, C-channels, rectangular sections, etc.) coupled to one or more plates. In some embodiments, the middle base rails 906 are formed from steel with a yield strength that is less than or equal to 100 ksi. By way of example, the middle base rails 906 may be formed from steel with a yield strength that is less than or equal to 100 ksi due to the cross section of the middle base rails 906. In other embodiments, the middle base rails 906 are formed from steel with a yield strength that is greater than 100 ksi.

The ends of the middle base rails 906 may be capped (e.g., a plate welded over the open end) to prevent debris from entering the middle base rails 906. In some embodiments, each of the middle base rails 906 defines a pair of apertures that extend from an outer surface of the middle base rails 906 to an interior volume of the middle base rails 906. The apertures are arranged near opposite ends of the middle base section 900. The cables 724 may pass through one aperture, through the interior volume of the middle base rails 906, and out through the other aperture. This arrangement reduces the length of the cable 724 that is exposed (e.g., positioned outside of the middle base rails 906, etc.), reducing the chances of an operator or piece of equipment being caught by the cables 724. In other embodiments, other components extend through the apertures and into the middle base rails 906, such as wires or hoses.

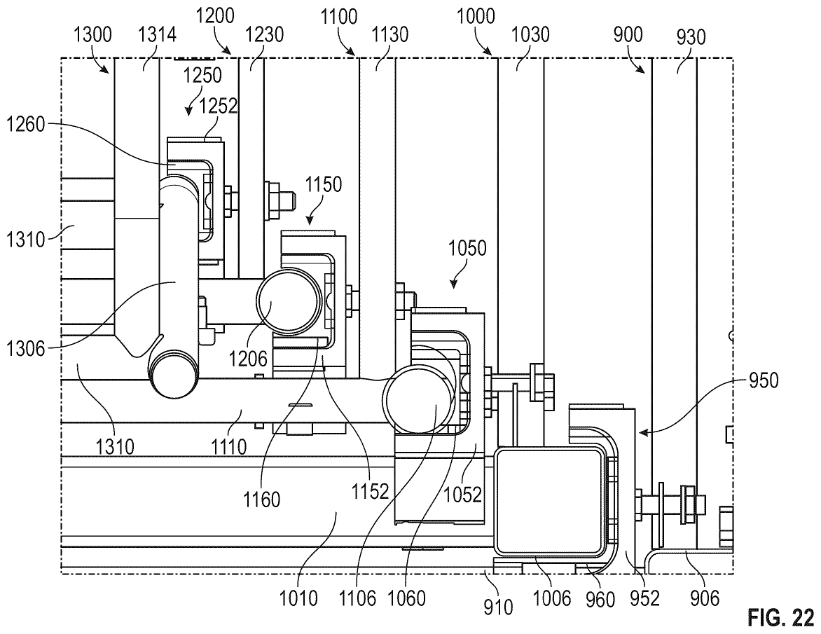

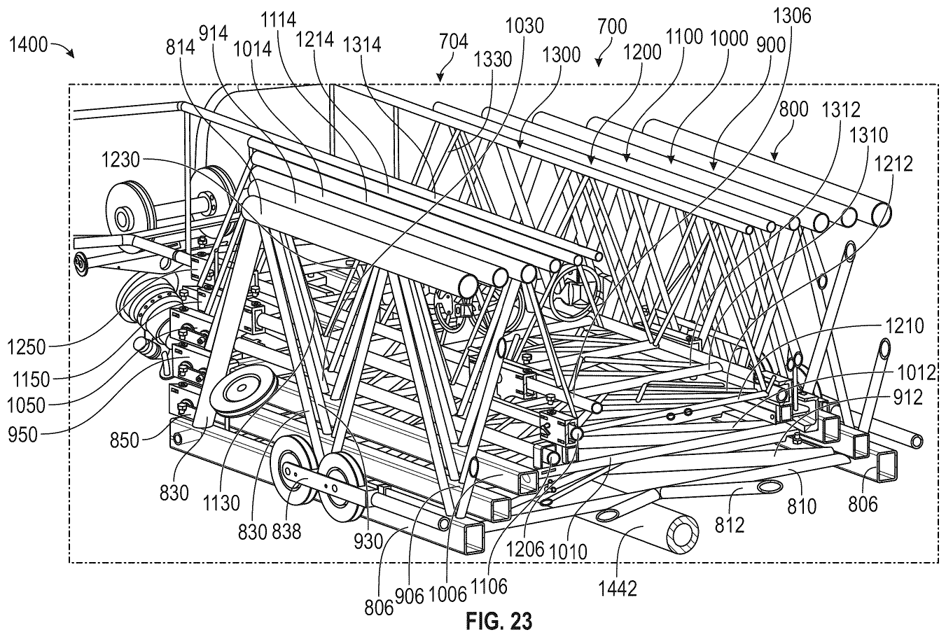

As shown in FIGS. 15, 16, 20, 23, and 24, the middle base ladder rungs 910 are coupled to each of the middle base rails 906, thereby indirectly fixedly coupling the middle base rails 906 together. As shown in FIGS. 16 and 22, at least one of the middle base ladder rungs 910 have a rectangular cross section and at least one of the middle base ladder rungs 910 have a round cross section. For example, one of the middle base ladder rungs 910 closest to the proximal end of the middle base section 900 and/or one of the middle base ladder rungs 910 closest to a distal end of the middle base section 900 may have a rectangular cross section and a remainder of the middle base ladder rungs 910 may have a round cross section. The middle base ladder rungs 910 are tubular members each having a round cross section. The middle base ladder rungs 910 are configured to act as steps to support the weight of operators and their equipment as the operators ascend or descend the aerial ladder assembly 700. According to the exemplary embodiment shown in FIG. 23, the middle base section 900 includes support members, shown as middle base ladder rung supports 912. The middle base ladder rung supports 912 extend between one of the middle base rails 906 and one of the middle base ladder rungs 910 at an angle relative to the middle base rails 906 (e.g., 30 degrees, 45 degrees, etc.). Each of the middle base ladder rung supports 912 is coupled to one of the middle base rails 906 and one of the middle base ladder rungs 910. Each of the middle base ladder rungs 910 engages a pair of the middle base ladder rung supports 912. The middle base ladder rung supports 912 extend below the corresponding middle base ladder rungs 910 when the aerial ladder assembly 700 is raised. Accordingly, the middle base ladder rung supports 912 help to support the downward weight of the operators and their equipment applied on the middle base ladder rungs 910. In other embodiments, the middle base ladder rungs 910 and/or the middle base ladder rung supports 912 have other cross sectional shapes (e.g., C-channel, square, rectangular, etc.).

As shown in FIGS. 15, 16, 20, and 23, each of the middle base hand rails 914 is positioned above and laterally aligned with one of the middle base rails 906. The middle base hand rails 914 are symmetrically arranged about the center plane 738. In some embodiments, the middle base hand rails 914 are tubular members each having a circular cross section. In other embodiments, the middle base hand rails 914 have other cross sectional shapes (e.g., C-channel, T-bracket, square, rectangular, etc.). In some embodiments one or more surfaces of the middle base hand rails 914 are shaped, textured (e.g., knurled, slotted, etc.), or otherwise configured to facilitate a solid grip by the user on the middle base hand rails 914.

As shown in FIGS. 16, 20, and 23-25, the middle base angled lacing members 930 are coupled between each of the middle base rails 906 and the corresponding of the middle base hand rails 914. In some embodiments, the middle base angled lacing members 930 are each tubular members. In other embodiments, the middle base angled lacing members 930 have solid cross sections. The middle base angled lacing members 930 extend within a plane parallel to the center plane 738. The middle base angled lacing members 930 are oriented at an angle relative to the longitudinal axis 732 (e.g., 30 degrees, 45 degrees, 60 degrees, etc.). The middle base rails 906, the corresponding middle base hand rails 914, and the corresponding middle base angled lacing members 930 form a truss structure that resists bending about a lateral axis.

The middle base angled lacing members 930 are each coupled to the corresponding middle base rails 906 at lower ends (e.g., first ends, etc.) of the middle base angled lacing members 930. The middle base angled lacing members 930 are each coupled to the corresponding middle base hand rails 914 at upper ends (e.g., opposing second ends, etc.) of the middle base angled lacing members 930. According to the exemplary embodiment shown in FIGS. 16, 20, 23, and 24, the lower ends of the middle base angled lacing members 930 are coupled to a top surface of the middle base rails 906 such that a plane parallel to the center plane 738 extends through one of the middle base rails 906, the corresponding middle base angled lacing members 930, and the corresponding middle base hand rail 914. The middle base angled lacing members 930 may be coupled to an inward side of the top surface of the middle base rails 906 such that the middle base angled lacing members 930 do not contact the lower base load transfer bodies 852 when the middle base rails 906 are received by the lower base load transfer channels 858. For example, the middle base angled lacing members 930 may be coupled to the middle base rails 906 at locations inward of a plane bisecting the middle base rails 906 and parallel to the center plane 738. The middle base hand rails 914 may extend a shorter length in the longitudinal direction than the middle base rails 906.

As shown in FIGS. 16 and 20-24, the middle base load transfer assemblies 950 are each coupled to one of the middle base rails 906. The middle base load transfer assemblies 950 are configured to slidably couple to the upper base section 1000 to facilitate extension and retraction of the upper base section 1000 relative to the middle base section 900. By way of example, the middle base load transfer assemblies 950 may engage the upper base section 1000 and facilitate moving the upper base section 1000 relative to the middle base section 900 along the longitudinal axis 732.

As shown in FIGS. 21-24, the middle base load transfer assemblies 950 include a second load transfer body, shown as middle base load transfer body 952, coupled to one of the middle base rails 906, and a second load transfer pad, shown as middle base load transfer pad 960. In some embodiments, the middle base load transfer assemblies 950 may include middle load transfer support plates coupled to the middle base load transfer body 952 and at least one of the middle base ladder rungs 910 (e.g., similar to the first lower base load transfer support plate 854 and/or the second lower base load transfer support plate 856).

As shown in FIGS. 21 and 22, the middle base load transfer bodies 952 define a second channel, shown as middle base load transfer channel 958, configured to receive a portion of the upper base section 1000 to slidably couple the upper base section 1000 to the middle base load transfer assemblies 950. According to the exemplary embodiment shown in FIGS. 21 and 22, the middle base load transfer channels 958 have square cross sections to receive square portions of the upper base section 1000 (e.g., a square base rail of the upper base section 1000, etc.). In other embodiments, the middle base load transfer channels 958 may have other cross sections (e.g., rectangular, etc.) to receive portions of the upper base section 1000. The middle base load transfer channels 958 may prevent movement of the upper base section 1000 relative to the middle base section 900 in a first direction of the lateral axis 734 and/or a second direction of the vertical axis 736.

According to an exemplary embodiment, the middle base load transfer bodies 952 are movably coupled to the middle base rails 906 to facilitate adjustment of relative positions of the middle base load transfer bodies 952 in a direction of the vertical axis 736. By way example, a first of the middle base load transfer bodies 952 coupled to one of the middle base rails 906 may be moved relative to the one of the middle base rails 906 in the direction of the vertical axis 736 to adjust an alignment of a first of the middle base load transfer channels 958 of the first of the middle base load transfer bodies 952 relative to a second of the middle base load transfer channels 958 of a second of the middle base load transfer bodies 952 coupled to the one of the middle base rails 906 such that the first of the middle base load transfer channels 958 and the second of the middle base load transfer channels 958 may align to receive a rectangular portion of the upper base section 1000. The middle base load transfer bodies 952 may be movably coupled to the middle base rails 906 substantially similar to how the lower base load transfer bodies 852 are movable coupled to the lower base rails 806 (e.g., via the lower base load transfer alignment pin 874, including the lower base load transfer lock plate 876, etc.).

According to an exemplary embodiment, the middle base load transfer body 952 are pivotably coupled to the middle base rails 906 to facilitate adjustment between a relative position of the middle base section 900 and a relative position of the upper base section 1000. By way of example, as the upper base section 1000 moves from a retracted position towards an extended position, the middle base load transfer body 952 may pivot relative to the middle base rails 906 to compensate for relative movement between the upper base section 1000 and the middle base section 900 and/or deformation of upper base section 1000. The middle base load transfer bodies 952 may be pivotably coupled to the middle base rails 906 substantially similar to how the lower base load transfer bodies 852 are pivotably coupled to the lower base rails 806 (e.g., via the lower base load transfer alignment pin 874, etc.). In other embodiments, at least a portion of the middle base load transfer bodies 952 are fixedly coupled to the middle base rails 906. By way of example, the forward of the middle base load transfer body 952 may be fixedly coupled to the middle base rails 906 and the rearward of the middle base load transfer body 952 may be movably and/or pivotably coupled to the middle base rails 906.

As shown in FIG. 22, the middle base load transfer pads 960 are positioned within the middle base load transfer channels 958. The middle base load transfer pads 960 are configured to facilitate the upper base section 1000 sliding relative to the middle base load transfer body 952. By way of example, the middle base load transfer pads 960 may be formed from a material with low friction properties (e.g., polymer, plastic, ceramic, dry lubricant, materials with a low surface roughness, materials with a high hardness, materials with lower friction properties than steel, etc.) so that the middle base load transfer pads 960 may form a low coefficient of friction with other surfaces (e.g., lower than a coefficient of friction between two steel surfaces, a low coefficient of friction with a portion of the upper base section 1000, etc.). According to an exemplary embodiment, the middle base load transfer assemblies 950 includes pads substantially similar to the lower base load transfer assemblies 850 to absorb a portion of a load transferred from the upper base section 1000 to the middle base section 900.

As shown in FIGS. 15, 16, 20, 22-24, and 27 the upper base section 1000 includes a third pair of support members, shown as upper base rails 1006, a third series of structural members or steps, shown as upper base ladder rungs 1010, that extend between the upper base rails 1006, a third pair of hand rails, shown as upper base hand rails 1014, extending longitudinally along the upper base section 1000, a third series of structural members, shown as upper base angled lacing members 1030, extending between the upper base rails 1006 and the upper base hand rails 1014, and a third plurality of slide assemblies, shown as upper base load transfer assemblies 1050, slidably coupled to the lower middle section 1100. According to an exemplary embodiment, the upper base section 1000 includes a third pulley support assembly configured to support the pulleys 726.

The upper base rails 1006 are symmetrically arranged about the center plane 738. The upper base rails 1006 are configured to be received by the middle base load transfer channels 958 of the middle base load transfer assemblies 950 to slidably couple the upper base section 1000 to the middle base section 900. By way of example, a first of the upper base rails 1006 may be received by the middle base load transfer channels 958 of a first and a second of the middle base load transfer assemblies 950 and a second of the upper base rails 1006 may be received by the middle base load transfer channels 958 of a third and a fourth of the middle base load transfer assemblies 950 such that the upper base section 1000 is held between the middle base load transfer assemblies 950. As shown in FIGS. 16, 21, and 22, the upper base rails 1006 are tubular members each having a square cross section such that the upper base rails 1006 may be received by the middle base load transfer channels 958 with the square cross sections. By way of example, the upper base rails 1006 may be formed from square tubular members with a height of 1.5 inches, a width of 1.5 inches, and a wall thickness of 0.071 inches. In some embodiments, the upper base rails 1006 may be formed from square tubular members with a same size as the square tubular members of the middle base rails 906. In other embodiments, the upper base rails 1006 have other cross sectional shapes (e.g., C-channel, circular, rectangular, etc.). Further alternatively, the upper base rails 1006 may be made from one or more members (e.g., tubular members, C-channels, rectangular sections, etc.) coupled to one or more plates. In some embodiments, the upper base rails 1006 are formed from steel with a yield strength that is less than or equal to 100 ksi. By way of example, the upper base rails 1006 may be formed from steel with a yield strength that is less than or equal to 100 ksi due to the cross section of the upper base rails 1006. In other embodiments, the upper base rails 1006 are formed from steel with a yield strength that is greater than 100 ksi.

The ends of the upper base rails 1006 may be capped (e.g., a plate welded over the open end) to prevent debris from entering the upper base rails 1006. In some embodiments, each of the upper base rails 1006 defines a pair of apertures that extend from an outer surface of the upper base rails 1006 to an interior volume of the upper base rails 1006. The apertures are arranged near opposite ends of the upper base section 1000. The cables 724 may pass through one aperture, through the interior volume of the upper base rails 1006, and out through the other aperture. This arrangement reduces the length of the cable 724 that is exposed (e.g., positioned outside of the upper base rails 1006, etc.), reducing the chances of an operator or piece of equipment being caught by the cables 724. In other embodiments, other components extend through the apertures and into the upper base rails 1006 such as wires or hoses.

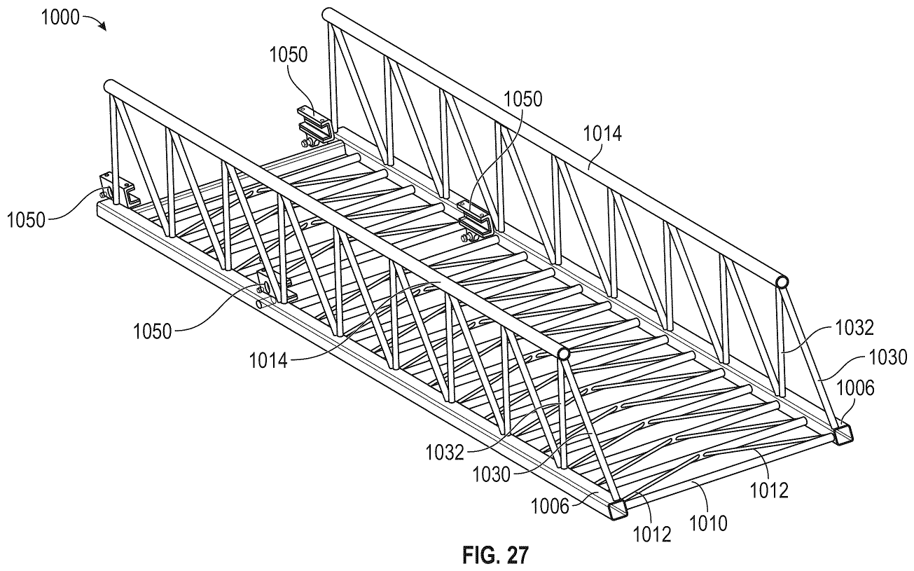

As shown in FIGS. 15, 16, 20, 23, 24, and 27 the upper base ladder rungs 1010 are coupled to each of the upper base rails 1006, thereby indirectly fixedly coupling the upper base rails 1006 together. As shown in FIGS. 16, 22, 27, 28, and 28, at least one of the upper base ladder rungs 1010 have a rectangular cross section and at least one of the upper base ladder rungs 1010 have a round cross section. For example, one of the upper base ladder rungs 1010 closest to the proximal end of the middle base section upper base section 1000 and/or one of the upper base ladder rungs 1010 closest to a distal end of the upper base section 1000 may have a rectangular cross section and a remainder of the upper base ladder rungs 1010 may have a round cross section. The upper base ladder rungs 1010 are configured to act as steps to support the weight of operators and their equipment as the operators ascend or descend the aerial ladder assembly 700. According to the exemplary embodiment shown in FIGS. 23 and 27, the upper base section 1000 includes support members, shown as upper base ladder rung supports 1012. The upper base ladder rung supports 1012 extend between one of the upper base rails 1006 and one of the upper base ladder rungs 1010 at an angle relative to the upper base rails 1006 (e.g., 30 degrees, 45 degrees, etc.). Each of the upper base ladder rung supports 1012 is coupled to one of the upper base rails 1006 and one of the upper base ladder rungs 1010. Each of the upper base ladder rungs 1010 engages a pair of the upper base ladder rung supports 1012. The upper base ladder rung supports 1012 extend below the corresponding upper base ladder rungs 1010 when the aerial ladder assembly 700 is raised. Accordingly, the upper base ladder rung supports 1012 help to support the downward weight of the operators and their equipment applied on the upper base ladder rungs 1010. In other embodiments, the upper base ladder rungs 1010 and/or the upper base ladder rung supports 1012 have other cross sectional shapes (e.g., C-channel, square, rectangular, etc.).

As shown in FIGS. 15, 16, 20, 23, and 27 each of the upper base hand rails 1014 is positioned above and laterally aligned with one of the upper base rails 1006. The upper base hand rails 1014 are symmetrically arranged about the center plane 738. In some embodiments, the upper base hand rails 1014 are tubular members each having a circular cross section. In other embodiments, the upper base hand rails 1014 have other cross sectional shapes (e.g., C-channel, T-bracket, square, rectangular, etc.). In some embodiments one or more surfaces of the upper base hand rails 1014 are shaped, textured (e.g., knurled, slotted, etc.), or otherwise configured to facilitate a solid grip by the user on the upper base hand rails 1014.

As shown in FIGS. 16, 20, 23-25, and 27, the upper base angled lacing members 1030 are coupled between each of the upper base rails 1006 and the corresponding of the upper base hand rails 1014. In some embodiments, the upper base angled lacing members 1030 are each tubular members. In other embodiments, the upper base angled lacing members 1030 have solid cross sections. The upper base angled lacing members 1030 extend within a plane parallel to the center plane 738. The upper base angled lacing members 1030 are oriented at an angle relative to the longitudinal axis 732 (e.g., 30 degrees, 45 degrees, 60 degrees, etc.). The upper base rails 1006, the corresponding upper base hand rails 1014, and the corresponding upper base angled lacing members 1030 form a truss structure that resists bending about a lateral axis.

According to the exemplary embodiment shown in FIG. 27, the upper base section 1000 includes an additional series of structural members, shown as upper base vertical lacing members 1032, extending between the upper base rails 1006 and the upper base hand rails 1014. The upper base vertical lacing members 1032 are coupled between each of the upper base rails 1006 and the corresponding of the upper base hand rails 1014. In some embodiments, the upper base vertical lacing members 1032 are each tubular members. In other embodiments, the upper base vertical lacing members 1032 have solid cross sections. The upper base vertical lacing members 1032 extend within a plane parallel to the center plane 738. The upper base vertical lacing members 1032 are oriented parallel relative to the vertical axis 736. The upper base vertical lacing members 1032 may be included in the truss structure including the upper base rails 1006, corresponding upper base hand rails 1014, and the corresponding upper base angled lacing members 1030 that resists bending about the lateral axis.

The upper base angled lacing members 1030 are each coupled to the upper base rails 1006 at lower ends (e.g., first ends, etc.) of the upper base angled lacing members 1030. The upper base angled lacing members 1030 are each coupled to the corresponding upper base hand rails 1014 at upper ends (e.g., opposing second ends, etc.) of the upper base angled lacing members 1030. According to the exemplary embodiment shown in FIGS. 16, 20, 23, 24, and 27 the lower ends of the upper base angled lacing members 1030 are coupled to a top surface of the upper base rails 1006 such that a plane parallel to the center plane 738 extends through one of the upper base rails 1006, the corresponding upper base angled lacing members 1030, and the corresponding upper base hand rail 1014. The upper base angled lacing members 1030 may be coupled to an inward side of the top surface of the upper base rails 1006 such that the upper base angled lacing members 1030 do not contact the middle base load transfer body 952 when the upper base rails 1006 are received by the middle base load transfer channels 958. For example, the members 1030 may be coupled to the upper base rails 1006 at locations inward of a plane bisecting the upper base rails 1006 and parallel to the center plane 738. The upper base hand rails 1014 may extend a shorter length in the longitudinal direction than the upper base rails 1006.

As shown in FIGS. 16, 20-24, and 27-32, the upper base load transfer assemblies 1050 are each coupled to one of the upper base rails 1006. The upper base load transfer assemblies 1050 are configured to slidably couple to the lower middle section 1100 to facilitate extension and retraction of the lower middle section 1100 relative to the upper base section 1000. By way of example, the upper base load transfer assemblies 1050 may engage the lower middle section 1100 and facilitate moving the lower middle section 1100 relative to the upper base section 1000 along the longitudinal axis 732.

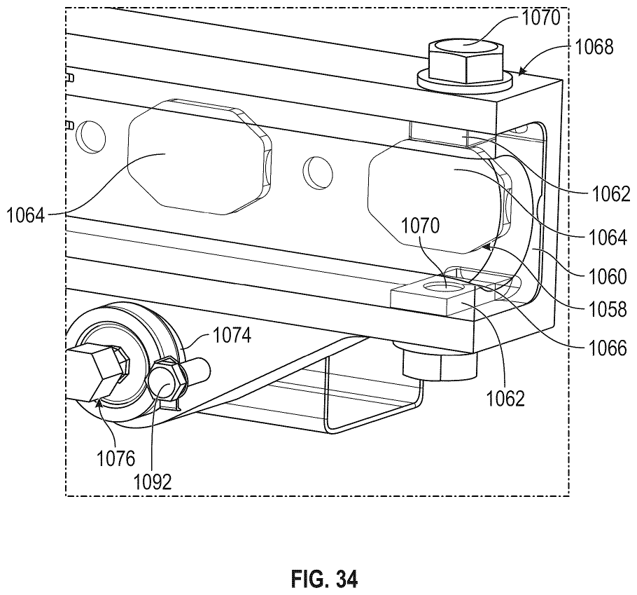

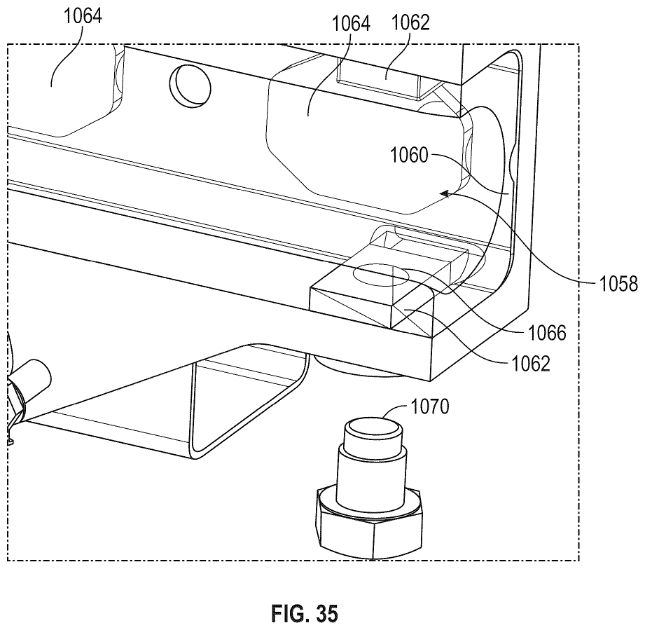

As shown in FIGS. 21, 23-26, and 28-35, the upper base load transfer assemblies 1050 include a first load transfer body, shown as upper base load transfer body 1052, coupled to one of the upper base rails 1006, a third support plate, shown as upper base load transfer support plate 1054, coupled to the upper base load transfer body 1052 and at least one of the upper base ladder rungs 1010, and a third load transfer pad, shown as upper base load transfer pad 1060.

As shown in FIGS. 21, 22, 28, 29, 31, 34, and 35 the upper base load transfer bodies 1052 define third channels, shown as upper base load transfer channels 1058, configured to receive a portion of the lower middle section 1100 to slidably couple the lower middle section 1100 to the upper base load transfer assemblies 1050. According to the exemplary embodiment shown in FIGS. 21, 22, 28, 29, 31, 34, and 35, the upper base load transfer channels 1058 have circular cross sections to engage circular portions of the lower middle section 1100 (e.g., a circular base rail of the lower middle section 1100, etc.). The upper base load transfer channels 1058 may prevent movement of the lower middle section 1100 relative to the upper base section 1000 in a first direction of the lateral axis 734 and/or a second direction of the vertical axis 736.

According to an exemplary embodiment, the upper base load transfer body 1052 are movably coupled to the lower middle rails 1106 to facilitate adjustment of relative positions of the upper base load transfer body 1052 in a direction of the vertical axis 736. By way example, a first of the upper base load transfer body 1052 coupled to one of the lower middle rails 1106 may be moved relative to the one of lower middle rails 1106 in the direction of the vertical axis 736 to adjust an alignment of a first of the upper base load transfer channels 1058 of the first of the upper base load transfer body 1052 relative to a second of the upper base load transfer channels 1058 of a second of the upper base load transfer body 1052 coupled to the one of the upper base rails 1006 such that the first of the upper base load transfer channels 1058 and the second of the upper base load transfer channels 1058 may align to receive a circular portion of the lower middle section 1100.

According to an exemplary embodiment, the upper base load transfer bodies 1052 are pivotably coupled to the upper base rails 1006 to facilitate adjustment between a relative position of the upper base section 1000 and a relative position of the lower middle section 1100. By way of example, as the lower middle section 1100 moves from a retracted position towards an extended position, the upper base load transfer body 1052 may pivot relative to the upper base rails 1006 to compensate for relative movement between the lower middle section 1100 and the upper base section 1000 and/or deformation of the lower middle section 1100. In other embodiments, at least a portion of the upper base load transfer bodies 1052 are fixedly coupled to the upper base rails 1006. By way of example, the forward of the upper base load transfer bodies 1052 may be fixedly coupled to the upper base rails 1006 and the rearward of the upper base load transfer bodies 1052 may be movably and/or pivotably coupled to the upper base rails 1006.

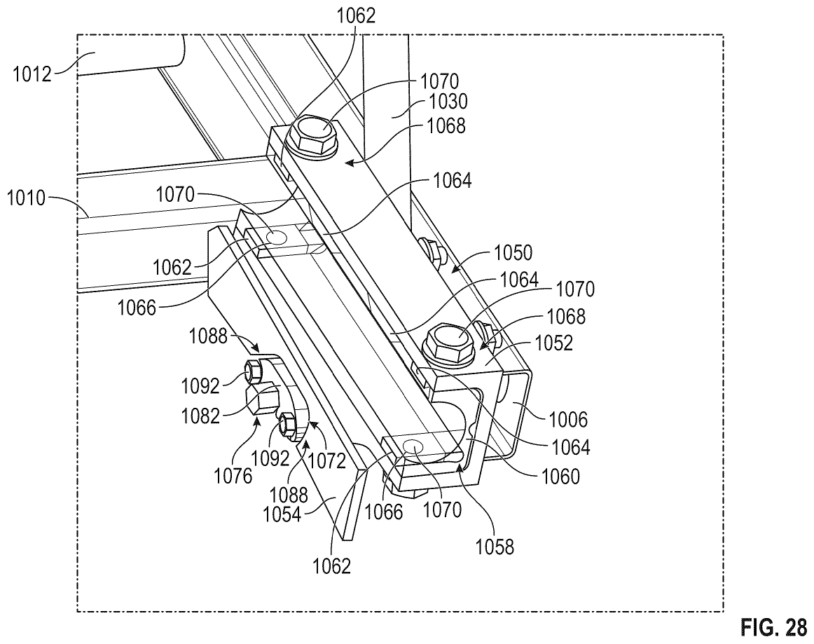

As shown in FIGS. 28, 29, 31, 34, and 35, the upper base load transfer pads 1060 are positioned within the upper base load transfer channels 1058. The upper base load transfer pads 1060 are configured to facilitate the lower middle section 1100 sliding relative to the upper base section 1000. By way of example, the upper base load transfer pads 1060 may be formed from a material with low friction properties (e.g., polymer, plastic, ceramic, dry lubricant, materials with a low surface roughness, materials with a high hardness, materials with lower friction properties than steel, etc.) so that the upper base load transfer pads 1060 may form a low coefficient of friction with other surfaces (e.g., lower than a coefficient of friction between two steel surfaces, a low coefficient of friction with a portion of the lower middle section 1100, etc.).

As shown in FIGS. 28, 29, 31, 34, and 35, the upper base load transfer assemblies 1050 includes a third plurality of pads, shown as upper base load transfer horizontal pads 1062, and a fourth plurality of pads, shown as upper base load transfer vertical pads 1064. The upper base load transfer horizontal pads 1062 and the upper base load transfer vertical pads 1064 are positioned between the upper base load transfer pads 1060 and the upper base load transfer body 1052. The upper base load transfer horizontal pads 1062 and the upper base load transfer vertical pads 1064 may be received within openings (e.g., slots, cavities, etc.) defined by the upper base load transfer pads 1060. The upper base load transfer horizontal pads 1062 and the upper base load transfer vertical pads 1064 are configured to absorb a portion of a load transferred from the lower middle section 1100 to the upper base section 1000. By way of example, the upper base load transfer horizontal pads 1062 and the upper base load transfer vertical pads 1064 may be formed from a material configured to deform to absorb a portion of a load to cushion the upper base load transfer body 1052 from forces transferred from the lower middle section 1100 to the upper base section 1000 via the upper base load transfer pads 1060.

As shown in FIGS. 28, 29, 31, 34, and 35, the upper base load transfer body 1052 defines a fourth plurality of apertures, shown as upper base pad apertures 1066, extending through the upper base load transfer body 1052 and aligning with the upper base load transfer channels 1058. As shown in FIGS. 28, 29, 31, 34, and 35, the upper base load transfer horizontal pads 1062 define a third aperture, shown as upper base retaining apertures 1068, extending through the upper base load transfer horizontal pads 1062. The upper base retaining apertures 1068 are configured to align with the upper base pad apertures 1066 of the upper base load transfer body 1052 to selectively receive a first plurality of fasteners (e.g., bolts, screws, rivets, nails, anchors, etc.), shown as upper base horizontal pad fasteners 1070, to removably couple the upper base load transfer horizontal pads 1062 to the upper base load transfer bodies 1052. The upper base horizontal pad fasteners 1070 and the upper base load transfer horizontal pads 1062 may inhibit movement of the upper base load transfer pads 1060 relative to the upper base load transfer bodies 1052 (e.g., in a direction of the longitudinal axis 732, in a direction of the lateral axis 734, in a direction of the vertical axis 736, etc.).

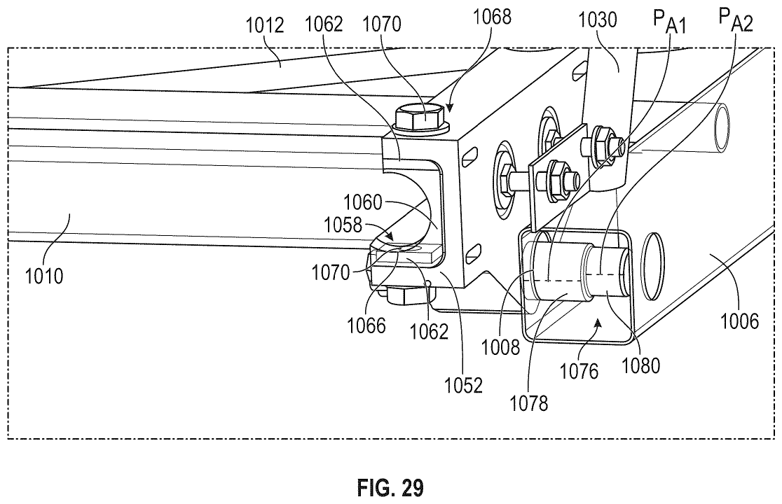

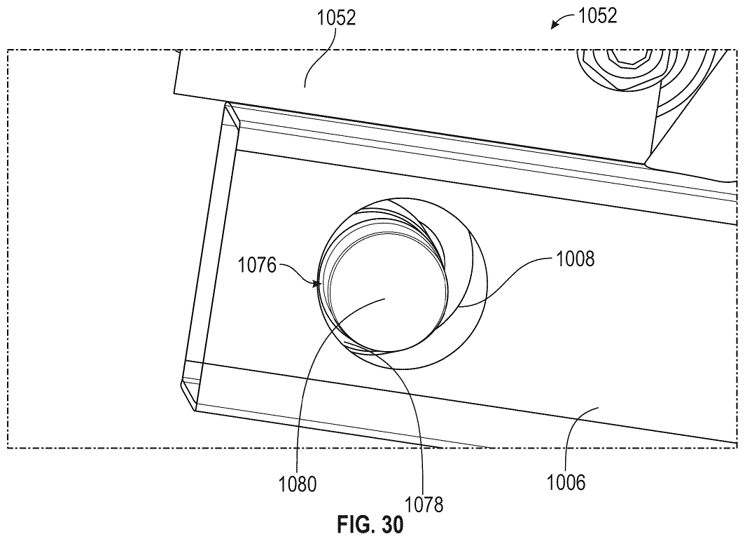

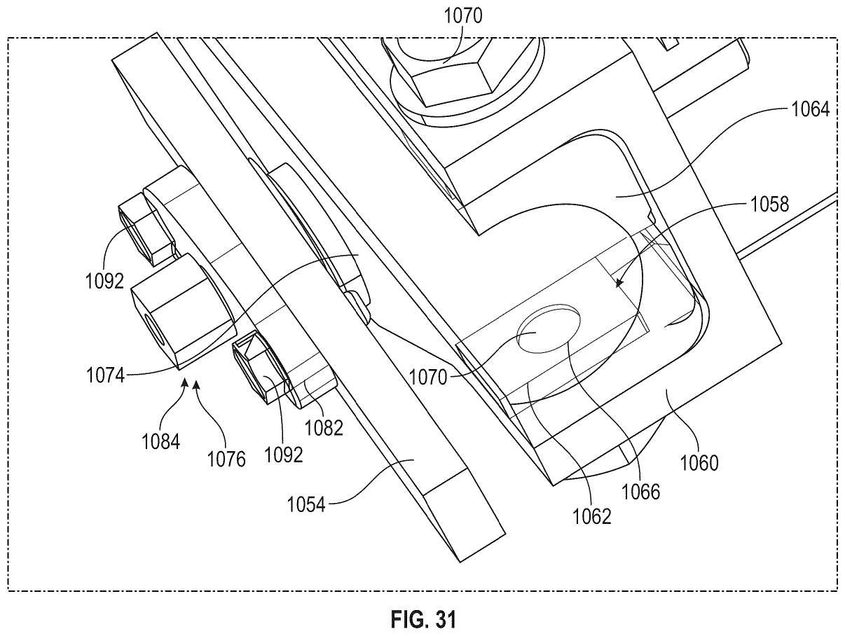

As shown in FIG. 28, the upper base load transfer support plate 1054 defines a fourth aperture, shown as upper base load transfer alignment aperture 1072, extending through the upper base load transfer support plate 1054. As shown in FIGS. 29 and 30, the upper base rails 1006 defines a fifth aperture, shown as upper base rail alignment aperture 1008, extending through at least a portion of the upper base rails 1006. As shown in FIGS. 31, 32, and 33, the upper base load transfer body 1052 defines a sixth aperture, shown as upper base body alignment aperture 1074, extending through the upper base load transfer body 1052. The upper base load transfer alignment aperture 1072, the upper base rail alignment aperture 1008, and the upper base body alignment aperture 1074 selectively align to receive a second alignment pin, shown as upper base load transfer alignment pin 1076. The upper base load transfer alignment pin 1076 is configured to facilitate adjustment of the upper base load transfer body 1052 in the direction of the vertical axis 736.

According to the exemplary embodiment shown in FIGS. 29 and 30, the upper base load transfer alignment pin 1076 is an offset pin including a first portion, shown as first pin portion 1078, defining a first central axis P_{A1} and a second portion, shown as second pin portion 1080, defining a second central axis P_{A2}. The second central axis P_{A2} is offset from the first central axis P_{A1}. The first pin portion 1078 extends through the upper base body alignment aperture 1074 and the second pin portion 1080 extends at least partially through the upper base rail alignment aperture 1008 (e.g., through a bearing coupled to the upper base rails 1006, etc.). The offset between the second central axis P_{A2} and the first central axis P_{A1} causes rotation of the upper base load transfer alignment pin 1076 to move the upper base load transfer body 1052 relative to the upper base rails 1006. By way of example, an operator of the upper base load transfer assemblies 1050 may rotate the upper base load transfer alignment pin 1076 in a first rotational direction to move the upper base load transfer body 1052 relative to the one of the upper base rails 1006 in a first direction parallel to the vertical axis 736 and in an opposing second rotational direction to move the upper base load transfer body 1052 relative to the one of the upper base rails 1006 in an opposing second direction.

As shown in FIGS. 28, 31, and 33, the upper base load transfer assemblies 1050 include a second lock plate, shown as upper base load transfer lock plate 1082, coupled to the upper base load transfer support plate 1054. The upper base load transfer lock plate 1082 are configured to engage the upper base load transfer alignment pin 1076 to prevent rotation of the upper base load transfer alignment pin 1076 such that movement of the upper base load transfer body 1052 relative to the upper base rails 1006 in the direction parallel to the vertical axis 736 is prevented. When the upper base load transfer alignment pin 1076 engages the upper base load transfer alignment pin 1076, the upper base load transfer body 1052 may continue to pivot relative to the upper base rails 1006.

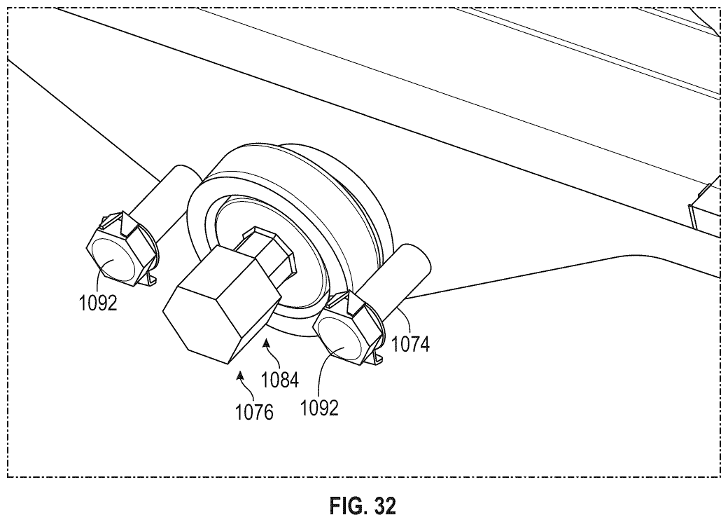

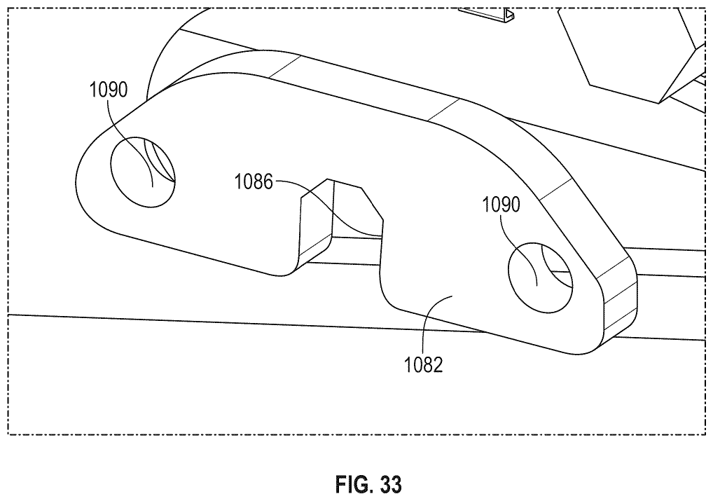

As shown in FIGS. 31 and 32, the upper base load transfer alignment pin 1076 defines a second profile, shown as upper base hexagonal profile 1084, at an end of the upper base load transfer alignment pin 1076 opposing the second pin portion 1080. As shown in FIG. 33, the upper base load transfer lock plate 1082 defines an opening, shown as upper base hexagonal opening 1086, configured to engage the upper base hexagonal profile 1084 of the upper base load transfer alignment pin 1076. When the upper base hexagonal opening 1086 of the upper base load transfer lock plate 1082 engages the upper base hexagonal profile 1084 of the upper base load transfer alignment pin 1076, rotation of the upper base load transfer alignment pin 1076 may be prevented.

As shown in FIG. 28, the upper base load transfer support plate 1054 defines a fifth plurality of apertures, shown as upper base mounting apertures 1088, extending through the upper base load transfer support plate 1054. As shown in FIG. 33, the upper base load transfer lock plate 1082 defines a sixth plurality of apertures, shown as upper base lock apertures 1090. The upper base lock apertures 1090 are configured to align with the upper base mounting apertures 1088 to selectively receive a plurality of fasteners, shown as upper base locking fasteners 1092, to removably couple the upper base load transfer lock plate 1082 to the upper base load transfer support plate 1054. To adjust the position of the upper base load transfer body 1052 in the direction parallel to the vertical axis 736, an operator of the upper base load transfer assemblies 1050 may remove the upper base locking fasteners 1092, disengage the upper base hexagonal opening 1086 from the upper base hexagonal profile 1084, rotate the upper base load transfer alignment pin 1076 relative to the upper base rails 1006, the upper base load transfer body 1052, and the upper base load transfer support plate 1054, engage the upper base hexagonal opening 1086 with the upper base hexagonal profile 1084, and insert the upper base locking fasteners 1092 through the upper base lock apertures 1090 and the upper base mounting apertures 1088.

As shown in FIGS. 15, 16, 20-24, 36, and 37, the lower middle section 1100 includes a fourth pair of support members, shown as lower middle rails 1106, a fourth series of structural members or steps, shown as lower middle ladder rungs 1110, that extend between the lower middle rails 1106, a fourth pair of hand rails, shown as lower middle hand rails 1114, extending longitudinally along the lower middle section 1100, a fourth series of structural members, shown as lower middle angled lacing members 1130, extending between the lower middle ladder rungs 1110 and the lower middle hand rails 1114, a first plurality of bracing members, shown as lower middle load transfer members 1140, coupled between one of the lower middle rails 1106 and one of the lower middle angled lacing members 1130, and a fourth plurality of slide assemblies, shown as lower middle load transfer assemblies 1150, slidably coupled to the upper middle section 1200. According to an exemplary embodiment, the lower middle section 1100 includes a fourth pulley support assembly configured to support the pulleys 726.

The lower middle rails 1106 are symmetrically arranged about the center plane 738. The lower middle rails 1106 are configured to be received by the upper base load transfer channels 1058 of the upper base load transfer assemblies 1050 to slidably couple the lower middle section 1100 to the upper base section 1000. By way of example, a first of the lower middle rails 1106 may be received by the upper base load transfer channels 1058 of a first and a second of the upper base load transfer assemblies 1050 and a second of the lower middle rails 1106 may be received by the upper base load transfer channels 1058 of a third and a fourth of the upper base load transfer assemblies 1050 such that the lower middle section 1100 is held between the upper base load transfer assemblies 1050. As shown in FIGS. 16, 21, 22, and 36-38, the lower middle rails 1106 are tubular members each having a circular cross section such that the lower middle rails 1106 may be received by the upper base load transfer channels 1058 with the circular cross sections. By way of example, the lower middle rails 1106 may be formed from circular tubular members with an outer diameter of 2 inches and a wall thickness of 0.109 inches. In other embodiments, the lower middle rails 1106 have other cross sectional shapes (e.g., C-channel, circular, rectangular, etc.). Further alternatively, the lower middle rails 1106 may be made from one or more members (e.g., tubular members, C-channels, rectangular sections, etc.) coupled to one or more plates. In some embodiments, the lower middle rails 1106 are formed from steel with a yield strength that is greater than 100 ksi (e.g., 110 ksi, 120 ksi, etc.). By way of example, the lower middle rails 1106 may be formed from steel with a yield strength that is greater than 100 ksi due to the cross section of the lower middle rails 1106 (e.g., the circular cross section, the wall thickness, etc.). In other embodiments, the lower middle rails 1106 are formed from steel with a yield strength that is less than or equal to 100 ksi.

The ends of the lower middle rails 1106 may be capped (e.g., a plate welded over the open end) to prevent debris from entering the lower middle rails 1106. In some embodiments, each of the lower middle rails 1106 defines a pair of apertures that extend from an outer surface of the lower middle rails 1106 to an interior volume of the lower middle rails 1106. The apertures are arranged near opposite ends of the lower middle section 1100. The cables 724 may pass through one aperture, through the interior volume of the lower middle rails 1106, and out through the other aperture. This arrangement reduces the length of the cable 724 that is exposed (e.g., positioned outside of the lower middle rails 1106, etc.), reducing the chances of an operator or piece of equipment being caught by the cables 724. In other embodiments, other components extend through the apertures and into the lower middle rails 1106 such as wires or hoses.

As shown in FIGS. 15, 16, 20, 23, 24, and 36-38 the lower middle ladder rungs 1110 are coupled to each of the lower middle rails 1106, thereby indirectly fixedly coupling the lower middle rails 1106 together. The lower middle ladder rungs 1110 are tubular members each having a round cross section. By way of example, the lower middle ladder rungs 1110 may be formed from circular tubular members with an outer diameter of 1.25 inches and a wall thickness of 0.058 inches. The lower middle ladder rungs 1110 are configured to act as steps to support the weight of operators and their equipment as the operators ascend or descend the aerial ladder assembly 700. According to the exemplary embodiment shown in FIGS. 23 and 36-38, the lower middle section 1100 includes support members, shown as lower middle ladder rung supports 1112. The upper base ladder rung supports 1112 extend between one of the lower middle rails 1106 and one of the lower middle ladder rungs 1110 at an angle relative to the lower middle rails 1106 (e.g., 30 degrees, 45 degrees, etc.). Each of the upper base ladder rung supports 1112 is coupled to one of the lower middle rails 1106 and one of the lower middle ladder rungs 1110. Each of the lower middle ladder rungs 1110 engages a pair of the upper base ladder rung supports 1112. The upper base ladder rung supports 1112 extend below the corresponding lower middle ladder rungs 1110 when the aerial ladder assembly 700 is raised. Accordingly, the upper base ladder rung supports 1112 help to support the downward weight of the operators and their equipment applied on the lower middle ladder rungs 1110. In some embodiments, the upper base ladder rung supports 1112 are each tubular members. By way of example, the upper base ladder rung supports 1112 may be formed from circular tubular members with an outer diameter of 1 inch and a wall thickness of 0.058 inches In other embodiments, the lower middle ladder rungs 1110 and/or the upper base ladder rung supports 1112 have other cross sectional shapes (e.g., C-channel, square, rectangular, etc.).

As shown in FIGS. 15, 16, 20, and 23, each of the lower middle hand rails 1114 is positioned above the lower middle ladder rungs 1110. The lower middle hand rails 1114 are symmetrically arranged about the center plane 738. In some embodiments, the lower middle hand rails 1114 are tubular members each having a circular cross section. By way of example, the lower middle hand rails 1114 may be formed from circular tubular members with an outer diameter of 1.5 inches and a wall thickness of 0.065 inches. In other embodiments, the lower middle hand rails 1114 have other cross sectional shapes (e.g., C-channel, T-bracket, square, rectangular, etc.). In some embodiments one or more surfaces of the lower middle hand rails 1114 are shaped, textured (e.g., knurled, slotted, etc.), or otherwise configured to facilitate a solid grip by the user on the lower middle hand rails 1114.

As shown in FIGS. 16, 20, 23-25, and 36-38, the lower middle angled lacing members 1130 are coupled between each of the lower middle ladder rungs 1110 and one of the lower middle hand rails 1114. By coupling the lower middle angled lacing members 1130 to the lower middle ladder rungs 1110 instead of the lower middle rails 1106, the upper base load transfer channels 1058 may be able to receive the lower middle rails 1106 without contacting the lower middle angled lacing members 1130. Additionally or alternatively, when the lower middle angled lacing members 1130 are welded to the lower middle ladder rungs 1110, weld damage to the lower middle rails 1106 that could be caused by welding the lower middle angled lacing members 1130 to the lower middle rails 1106 is prevented. In some embodiments, the lower middle angled lacing members 1130 are each tubular members. By way of example, the lower middle angled lacing members 1130 may be formed from circular tubular members with an outer diameter of 0.75 inches and a wall thickness of 0.058 inches. In other embodiments, the lower middle angled lacing members 1130 have solid cross sections. The lower middle angled lacing members 1130 extend within a plane parallel to the center plane 738. The lower middle angled lacing members 1130 are oriented at an angle relative to the longitudinal axis 732 (e.g., 30 degrees, 45 degrees, 60 degrees, etc.). The lower middle rails 1106, the corresponding lower middle hand rails 1114, the lower middle ladder rungs 1110, and the corresponding lower middle angled lacing members 1130 form a truss structure that resists bending about a lateral axis.

The lower middle angled lacing members 1130 are each coupled to the lower middle ladder rungs 1110 at lower ends (e.g., first ends, etc.) of the lower middle angled lacing members 1130. The lower middle angled lacing members 1130 are each coupled to the lower middle hand rails 1114 at upper ends (e.g., opposing second ends, etc.) of the lower middle angled lacing members 1130. The lower middle angled lacing members 1130 and the lower middle hand rails 1114 are laterally misaligned with the lower middle rails 1106. By way of example, the lower middle hand rails 1114 and the lower middle angled lacing members 1130 may be positioned inward of the lower middle rails 1106 such that the lower middle angled lacing members 1130 do not contact the upper base load transfer body 1052 when the lower middle rails 1106 are received by the upper base load transfer channels 1058. The lower middle hand rails 1114 may extend a shorter length in the longitudinal direction than the lower middle rails 1106.

As shown in FIG. 21, the lower middle load transfer members 1140 are coupled between one of the lower middle rails 1106 and one of the lower middle angled lacing members 1130. The lower middle load transfer members 1140 each define a seventh plurality of apertures, shown as lower middle load transfer apertures 1142, extending through the lower middle load transfer members 1140. In some embodiments, the lower middle load transfer members 1140 are positioned inward of the lower middle rails 1106. By way of example, the lower middle load transfer members 1140 may be laterally aligned with the lower middle angled lacing members 1130.

As shown in FIG. 16, the lower middle load transfer assemblies 1150 are each coupled to one of the lower middle load transfer members 1140. The lower middle load transfer assemblies 1150 are configured to slidably couple to the upper middle section 1200 to facilitate extension and retraction of the upper middle section 1200 relative to the lower middle section 1100. By way of example, the lower middle load transfer assemblies 1150 may engage the upper middle section 1200 and facilitate moving the upper middle section 1200 relative to the lower middle section 1100 along the longitudinal axis 732.

As shown in FIGS. 21-24 and 39, the lower middle load transfer assemblies 1150 include a fourth load transfer body, shown as lower middle load transfer body 1152, coupled to one of the lower middle load transfer members 1140, and a fourth load transfer pad, shown as lower middle load transfer pad 1160. As shown in FIGS. 21, 22, and 39, the lower middle load transfer bodies 1152 define fourth channels, shown as lower middle load transfer channels 1158, configured to receive a portion of the upper middle section 1200 to slidably couple the upper middle section 1200 to the lower middle load transfer assemblies 1150. According to the exemplary embodiment shown in FIGS. 21, 22, and 39, the lower middle load transfer channels 1158 have circular cross sections to engage circular portions of the upper middle section 1200 (e.g., a circular base rail of the upper middle section 1200, etc.). The lower middle load transfer channels 1158 may prevent movement of the upper middle section 1200 relative to the lower middle section 1100 in a first direction of the lateral axis 734 and/or a second direction of the vertical axis 736.

As shown in FIG. 39, the lower middle load transfer body 1152 defines an eighth plurality of apertures, shown as lower middle load transfer body apertures 1154, extending through the lower middle load transfer body 1152. The lower middle load transfer body apertures 1154 of the lower middle load transfer body 1152 align each align with one of the lower middle load transfer apertures 1142 of the corresponding lower middle load transfer members 1140 to selectively receive a third plurality of fasteners, shown as lower middle load transfer fasteners 1144, to couple to the lower middle load transfer body 1152 to the lower middle load transfer members 1140. According to an exemplary embodiment, an upper of the lower middle load transfer fasteners 1144 may be removed from the lower middle load transfer apertures 1142 of each of the lower middle load transfer members 1140 to allow for the lower middle load transfer body 1152 to pivot relative to the lower middle rails 1106.

As shown in FIGS. 22 and 39, the lower middle load transfer pads 1160 are positioned within the lower middle load transfer channels 1158. The lower middle load transfer pads 1160 are configured to facilitate the upper middle section 1200 sliding relative to the lower middle load transfer body 1152. According to an exemplary embodiment, the lower middle load transfer assemblies 1150 includes pads substantially similar to the lower base load transfer assemblies 850 to absorb a portion of a load transferred from the upper middle section 1200 to the lower middle section 1100.

As shown in FIGS. 15, 16, 20-24 and 40, the upper middle section 1200 includes a fifth pair of support members, shown as upper middle rails 1206, a fifth series of structural members or steps, shown as upper middle ladder rungs 1210, that extend between the upper middle rails 1206, a fifth pair of hand rails, shown as upper middle hand rails 1214, extending longitudinally along the upper middle section 1200, a fifth series of structural members, shown as upper middle angled lacing members 1230, extending between the upper middle ladder rungs 1210 and the upper middle hand rails 1214, a second plurality of bracing members, shown as upper middle load transfer members 1240, coupled between one of the upper middle rails 1206 and one of the upper middle angled lacing members 1230, and a fifth plurality of slide assemblies, shown as upper middle load transfer assemblies 1250, slidably coupled to the fly section 1300. According to an exemplary embodiment, the upper middle section 1200 includes a fifth pulley support assembly configured to support the pulleys 726.

The upper middle rails 1206 are symmetrically arranged about the center plane 738. The upper middle rails 1206 are configured to be received by the lower middle load transfer channels 1158 of the lower middle load transfer assemblies 1150 to slidably couple the upper middle section 1200 to the lower middle section 1100. By way of example, a first of the upper middle rails 1206 may be received by the lower middle load transfer channels 1158 of a first and a second of the lower middle load transfer assemblies 1150 and a second of the upper middle rails 1206 may be received by the lower middle load transfer channels 1158 of a third and a fourth of the lower middle load transfer assemblies 1150 such that the upper middle section 1200 is held between the lower middle load transfer assemblies 1150. As shown in FIGS. 16, 21, 22, and 40, the upper middle rails 1206 are tubular members each having a circular cross section such that the upper middle rails 1206 may be received by the lower middle load transfer channels 1158 with the circular cross sections. By way of example, the upper middle rails 1206 may be formed from circular tubular members with an outer diameter of 1.75 inches and a wall thickness of 0.083 inches. In other embodiments, the upper middle rails 1206 have other cross sectional shapes (e.g., C-channel, circular, rectangular, etc.). Further alternatively, the upper middle rails 1206 may be made from one or more members (e.g., tubular members, C-channels, rectangular sections, etc.) coupled to one or more plates. In some embodiments, the upper middle rails 1206 are formed from steel with a yield strength that is greater than 100 ksi (e.g., 110 ksi, 120 ksi, etc.). By way of example, the upper middle rails 1206 may be formed from steel with a yield strength that is greater than 100 ksi due to the cross section of the upper middle rails 1206 (e.g., the circular cross section, the wall thickness, etc.). In other embodiments, the upper middle rails 1206 are formed from steel with a yield strength that is less than or equal to 100 ksi.

The ends of the upper middle rails 1206 may be capped (e.g., a plate welded over the open end) to prevent debris from entering the upper middle rails 1206. In some embodiments, each of the upper middle rails 1206 defines a pair of apertures that extend from an outer surface of the upper middle rails 1206 to an interior volume of the upper middle rails 1206. The apertures are arranged near opposite ends of the upper middle section 1200. The cables 724 may pass through one aperture, through the interior volume of the upper middle rails 1206, and out through the other aperture. This arrangement reduces the length of the cable 724 that is exposed (e.g., positioned outside of the upper middle rails 1206, etc.), reducing the chances of an operator or piece of equipment being caught by the cables 724. In other embodiments, other components extend through the apertures and into the upper middle rails 1206 such as wires or hoses.

As shown in FIGS. 15, 16, 20, 23, 24, and 40, the upper middle ladder rungs 1210 are coupled to each of the upper middle rails 1206, thereby indirectly fixedly coupling the upper middle rails 1206 together. The upper middle ladder rungs 1210 are tubular members each having a round cross section. By way of example, the upper middle ladder rungs 1210 may be formed from circular tubular members with an outer diameter of 1.25 inches and a wall thickness of 0.058 inches. The upper middle ladder rungs 1210 are configured to act as steps to support the weight of operators and their equipment as the operators ascend or descend the aerial ladder assembly 700. According to the exemplary embodiment shown in FIGS. 23 and 40, the upper middle section 1200 includes support members, shown as upper middle ladder rung supports 1212. The upper middle ladder rung supports 1212 extend between one of the upper middle rails 1206 and one of the upper middle ladder rungs 1210 at an angle relative to the upper middle rails 1206 (e.g., 30 degrees, 45 degrees, etc.). Each of the upper middle ladder rung supports 1212 is coupled to one of the upper middle rails 1206 and one of the upper middle ladder rungs 1210. Each of the upper middle ladder rungs 1210 engages a pair of the upper middle ladder rung supports 1212. The upper middle ladder rung supports 1212 extend below the corresponding upper middle ladder rungs 1210 when the aerial ladder assembly 700 is raised. Accordingly, the upper middle ladder rung supports 1212 help to support the downward weight of the operators and their equipment applied on the upper middle ladder rungs 1210. In some embodiments, the upper middle ladder rung supports 1212 are each tubular members. By way of example, the upper middle ladder rung supports 1212 may be formed from circular tubular members with an outer diameter of 0.75 inches and a wall thickness of 0.058 inches In other embodiments, the upper middle ladder rungs 1210 and/or the upper middle ladder rung supports 1212 have other cross sectional shapes (e.g., C-channel, square, rectangular, etc.).

As shown in FIGS. 15, 16, 20, and 23, each of the upper middle hand rails 1214 is positioned above the upper middle ladder rungs 1210. The upper middle hand rails 1214 are symmetrically arranged about the center plane 738. In some embodiments, the upper middle hand rails 1214 are tubular members each having a circular cross section. By way of example, the upper middle hand rails 1214 may be formed from circular tubular members with an outer diameter of 1.25 inches and a wall thickness of 0.058 inches. In other embodiments, the upper middle hand rails 1214 have other cross sectional shapes (e.g., C-channel, T-bracket, square, rectangular, etc.). In some embodiments one or more surfaces of the upper middle hand rails 1214 are shaped, textured (e.g., knurled, slotted, etc.), or otherwise configured to facilitate a solid grip by the user on the upper middle hand rails 1214.

As shown in FIGS. 16, 20, and 23-25, the upper middle angled lacing members 1230 are coupled between each of the upper middle ladder rungs 1210 and one of the upper middle hand rails 1214. By coupling the upper middle angled lacing members 1230 to the upper middle ladder rungs 1210 instead of the upper middle rails 1206, the lower middle load transfer channels 1158 may be able to receive the upper middle rails 1206 without contacting the upper middle angled lacing members 1230. In some embodiments, the upper middle angled lacing members 1230 are each tubular members. By way of example, the upper middle angled lacing members 1230 may be formed from circular tubular members with an outer diameter of 0.75 inches and a wall thickness of 0.058 inches. In other embodiments, the upper middle angled lacing members 1230 have solid cross sections. The upper middle angled lacing members 1230 extend within a plane parallel to the center plane 738. The upper middle angled lacing members 1230 are oriented at an angle relative to the longitudinal axis 732 (e.g., 30 degrees, 45 degrees, 60 degrees, etc.). The upper middle rails 1206, the upper middle hand rails 1214, the upper middle ladder rungs 1210, and the corresponding upper middle angled lacing members 1230 form a truss structure that resists bending about a lateral axis.

The upper middle angled lacing members 1230 are each coupled to the upper middle ladder rungs 1210 at lower ends (e.g., first ends, etc.) of the upper middle angled lacing members 1230. The upper middle angled lacing members 1230 are each coupled to the upper middle hand rails 1214 at upper ends (e.g., opposing second ends, etc.) of the upper middle angled lacing members 1230. The upper middle hand rails 1214 and the upper middle angled lacing members 1230 are laterally misaligned with the upper middle rails 1206. By way of example, the upper middle hand rails 1214 and the upper middle angled lacing members 1230 may be positioned inward of the upper middle rails 1206 such that the upper middle angled lacing members 1230 do not contact the lower middle load transfer body 1152 when the upper middle rails 1206 are received by the lower middle load transfer channels 1158. The upper middle hand rails 1214 may extend a shorter length in the longitudinal direction than the upper middle rails 1206.

As shown in FIGS. 16, 21, and 40, the upper middle load transfer members 1240 are coupled between one of the upper middle rails 1206 and one of the upper middle angled lacing members 1230. The lower middle load transfer members 1140 each define a ninth plurality of apertures, shown as upper middle load transfer apertures 1242, extending through the upper middle load transfer members 1240. In some embodiments, the upper middle load transfer members 1240 are positioned inward of the upper middle rails 1206. By way of example, the upper middle load transfer members 1240 may be laterally aligned with the upper middle angled lacing members 1230.

As shown in FIGS. 16, 21, and 40 the upper middle load transfer assemblies 1250 are each coupled to one of the upper middle load transfer members 1240. The upper middle load transfer assemblies 1250 are configured to slidably couple to the fly section 1300 to facilitate extension and retraction of the fly section 1300 relative to the upper middle section 1200. By way of example, the upper middle load transfer assemblies 1250 may engage the fly section 1300 and facilitate moving the fly section 1300 relative to the upper middle section 1200 along the longitudinal axis 732.

As shown in FIGS. 21-24 and 40, the upper middle load transfer assemblies 1250 include a fifth load transfer body, shown as upper middle load transfer body 1252, coupled to one of the lower middle load transfer assemblies 1150, and a fifth load transfer pad, shown as upper middle load transfer pad 1260. As shown in FIGS. 21 and 22, the upper middle load transfer bodies 1252 define fifth channels, shown as upper middle load transfer channels 1258, configured to receive a portion of the fly section 1300 to slidably couple the fly section 1300 to the upper middle load transfer assemblies 1250. According to the exemplary embodiment shown in FIGS. 21 and 22, the upper middle load transfer channels 1258 have circular cross sections to engage circular portions of the fly section 1300 (e.g., a circular base rail of the fly section 1300, etc.). The upper middle load transfer channels 1258 may prevent movement of the fly section 1300 relative to the upper middle section 1200 in a first direction of the lateral axis 734 and/or a second direction of the vertical axis 736.

As shown in FIG. 40, the upper middle load transfer body 1252 defines a tenth plurality of apertures, shown as upper middle load transfer body apertures 1254, extending through the upper middle load transfer body 1252. The upper middle load transfer body apertures 1254 of the upper middle load transfer body 1252 align each align with one of the upper middle load transfer apertures 1242 of the corresponding upper middle load transfer members 1240 to selectively receive a fourth plurality of fasteners, shown as upper middle load transfer fasteners 1244, to couple to the upper middle load transfer body 1252 to the upper middle load transfer members 1240. According to an exemplary embodiment, an upper of the upper middle load transfer fasteners 1244 may be removed from the upper middle load transfer apertures 1242 of each of the upper middle load transfer members 1240 to allow for the upper middle load transfer bodies 1252 to pivot relative to the upper middle rails 1206.

As shown in FIG. 22, the upper middle load transfer pads 1260 are positioned within the upper middle load transfer channels 1258. The upper middle load transfer pads 1260 are configured to facilitate the fly section 1300 sliding relative to the upper middle load transfer body 1252. According to an exemplary embodiment, the upper middle load transfer assemblies 1250 includes pads substantially similar to the lower base load transfer assemblies 850 to absorb a portion of a load transferred from the fly section 1300 to the upper middle section 1200.

As shown in FIGS. 15, 16, and 20-24, the fly section 1300 includes a sixth pair of support members, shown as fly rails 1306, a sixth series of structural members or steps, shown as fly ladder rungs 1310, that extend between the fly rails 1306, a sixth pair of hand rails, shown as fly hand rails 1314, extending longitudinally along the fly section 1300, and a fifth series of structural members, shown as fly angled lacing members 1330 and fly vertical lacing members 1332, extending between the fly ladder rungs 1310 and the fly hand rails 1314. According to an exemplary embodiment, the fly section 1300 includes a sixth pulley support assembly configured to support the pulleys 726.

The fly rails 1306 are symmetrically arranged about the center plane 738. The fly rails 1306 are configured to be received by the upper middle load transfer channels 1258 of the upper middle load transfer assemblies 1250 to slidably couple the fly section 1300 to the upper middle section 1200. By way of example, a first of the fly rails 1306 may be received by the upper middle load transfer channels 1258 of a first and a second of the upper middle load transfer assemblies 1250 and a second of the fly rails 1306 may be received by the upper middle load transfer channels 1258 of a third and a fourth of the upper middle load transfer assemblies 1250 such that the fly section 1300 is held between the upper middle load transfer assemblies 1250. As shown in FIGS. 16, 21, and 22, the fly rails 1306 are tubular members each having a circular cross section such that the fly rails 1306 may be received by the upper middle load transfer channels 1258 with the circular cross sections. By way of example, the fly rails 1306 may be formed from circular tubular members with an outer diameter of 1.375 inches and a wall thickness of 0.083 inches. In other embodiments, the fly rails 1306 have other cross sectional shapes (e.g., C-channel, circular, rectangular, etc.). Further alternatively, the fly rails 1306 may be made from one or more members (e.g., tubular members, C-channels, rectangular sections, etc.) coupled to one or more plates. In some embodiments, the fly rails 1306 are formed from steel with a yield strength that is greater than 100 ksi (e.g., 110 ksi, 120 ksi, etc.). By way of example, the fly rails 1306 may be formed from steel with a yield strength that is greater than 100 ksi due to the cross section of the fly rails 1306 (e.g., the circular cross section, the wall thickness, etc.). In other embodiments, the fly rails 1306 are formed from steel with a yield strength that is less than or equal to 100 ksi.

The ends of the fly rails 1306 may be capped (e.g., a plate welded over the open end) to prevent debris from entering the fly rails 1306. In some embodiments, each of the fly rails 1306 defines a pair of apertures that extend from an outer surface of the fly rails 1306 to an interior volume of the fly rails 1306. The apertures are arranged near opposite ends of the fly section 1300. The cables 724 may pass through one aperture, through the interior volume of the fly rails 1306, and out through the other aperture. This arrangement reduces the length of the cable 724 that is exposed (e.g., positioned outside of the fly rails 1306, etc.), reducing the chances of an operator or piece of equipment being caught by the cables 724. In other embodiments, other components extend through the apertures and into the fly rails 1306 such as wires or hoses.

As shown in FIGS. 15, 16, 20, 23, and 24, the fly ladder rungs 1310 are coupled to each of the fly rails 1306, thereby indirectly fixedly coupling the fly rails 1306 together. The fly ladder rungs 1310 are tubular members each having a round cross section. By way of example, the fly ladder rungs 1310 may be formed from circular tubular members with an outer diameter of 1.25 inches and a wall thickness of 0.058 inches. The fly ladder rungs 1310 are configured to act as steps to support the weight of operators and their equipment as the operators ascend or descend the aerial ladder assembly 700. According to the exemplary embodiment shown in FIG. 23, the fly section 1300 includes support members, shown as fly ladder rung supports 1312. The fly ladder rung supports 1312 extend between one of the fly rails 1306 and one of the fly ladder rungs 1310 at an angle relative to the fly rails 1306 (e.g., 30 degrees, 45 degrees, etc.). Each of the fly ladder rung supports 1312 is coupled to one of the fly rails 1306 and one of the fly ladder rungs 1310. Each of the fly ladder rungs 1310 engages a pair of the fly ladder rung supports 1312. The fly ladder rung supports 1312 extend below the corresponding fly ladder rungs 1310 when the aerial ladder assembly 700 is raised. Accordingly, the fly ladder rung supports 1312 help to support the downward weight of the operators and their equipment applied on the fly ladder rungs 1310. In some embodiments, the fly ladder rung supports 1312 are each tubular members. By way of example, the fly ladder rung supports 1312 may be formed from circular tubular members with an outer diameter of 0.75 inches and a wall thickness of 0.058 inches In other embodiments, the fly ladder rungs 1310 and/or the fly ladder rung supports 1312 have other cross sectional shapes (e.g., C-channel, square, rectangular, etc.).

As shown in FIGS. 15, 16, 20, and 23, each of the fly hand rails 1314 is positioned above the fly ladder rungs 1310. The fly hand rails 1314 are symmetrically arranged about the center plane 738. In some embodiments, the fly hand rails 1314 are tubular members each having a circular cross section. By way of example, the fly hand rails 1314 may be formed from circular tubular members with an outer diameter of 1.25 inches and a wall thickness of 0.058 inches. In other embodiments, the fly hand rails 1314 have other cross sectional shapes (e.g., C-channel, T-bracket, square, rectangular, etc.). In some embodiments one or more surfaces of the fly hand rails 1314 are shaped, textured (e.g., knurled, slotted, etc.), or otherwise configured to facilitate a solid grip by the user on the fly hand rails 1314. As shown in FIG. 16, there is a distance D_{HR} between a first of the fly hand rails 1314 and a second of the fly hand rails 1314. According to an exemplary embodiment, the distance D_{HR} between the fly hand rails 1314 is at least 21 inches. As shown in FIG. 16, there is a height H_{HR} of the fly hand rails 1314 from the fly ladder rungs 1310 to a top of the fly hand rails 1314. According to an exemplary embodiment, the height H_{HR} of the fly hand rails 1314 is at least 15.75 inches. In some embodiments, the height H_{HR} of the fly hand rails 1314 is at least 19.5 inches (e.g., 19.875 inches, etc.).

As shown in FIGS. 16, 20, and 23-25, the fly angled lacing members 1330 and the fly vertical lacing members 1332 are coupled between each of the fly ladder rungs 1310 and one of the fly hand rails 1314. By coupling the fly angled lacing members 1330 and the fly vertical lacing members 1332 to the fly ladder rungs 1310 instead of the fly rails 1306, the upper middle load transfer channels 1258 may be able to receive the fly rails 1306 without contacting the fly angled lacing members 1330 or the fly vertical lacing members 1332. In some embodiments, the fly angled lacing members 1330 and the fly vertical lacing members 1332 are each tubular members. By way of example, the fly angled lacing members 1330 and the fly vertical lacing members 1332 may be formed from circular tubular members with an outer diameter of 0.75 inches and a wall thickness of 0.058 inches. In other embodiments, the fly angled lacing members 1330 and the fly vertical lacing members 1332 have solid cross sections. The fly angled lacing members 1330 and the fly vertical lacing members 1332 extend within a plane parallel to the center plane 738. The fly angled lacing members 1330 are oriented at an angle relative to the longitudinal axis 732 (e.g., 30 degrees, 45 degrees, 60 degrees, etc.). The fly vertical lacing members 1332 are oriented parallel to the vertical axis 736. The fly rails 1306, the fly hand rails 1314, the fly ladder rungs 1310, the corresponding fly angled lacing members 1330, and the corresponding fly vertical lacing members 1332 form a truss structure that resists bending about a lateral axis.

The fly angled lacing members 1330 and the fly vertical lacing members 1332 are each coupled to the fly ladder rungs 1310 at lower ends (e.g., first ends, etc.) of the fly angled lacing members 1330 and the fly vertical lacing members 1332. The fly angled lacing members 1330 and the fly vertical lacing members 1332 are each coupled to the fly hand rails 1314 at upper ends (e.g., opposing second ends, etc.) of the fly angled lacing members 1330 and the fly vertical lacing members 1332. The fly hand rails 1314, the fly angled lacing members 1330, and the fly vertical lacing members 1332 are laterally misaligned with the lower middle rails 1106. By way of example, the fly hand rails 1314 and the fly angled lacing members 1330 may be positioned inward of the fly rails 1306 such that the fly hand rails 1314 do not contact the upper middle load transfer bodies 1252 when the fly rails 1306 are received by the upper middle load transfer channels 1258.

### Mid-Mount Trailer Configuration

According to the exemplary embodiment shown in FIG. 41, the fire apparatus 10 is configured as a mid-mount trailer mount quint fire truck having a single rear axle, shown as trailer fire apparatus 10′. The frame 12 of the trailer fire apparatus 10′ includes a first portion (e.g., of the tractor), shown as forward frame portion 70, and a second portion (e.g., of the trailer), shown as rearward frame portion 72, pivotably coupled to the forward frame portion 70 and positioned rearward of the forward frame portion 70. As shown in FIG. 41, the aerial assembly 500 of the fire apparatus 10 is mounted on or coupled to the rearward frame portion 72.

According to the exemplary embodiment shown in FIG. 41, the rearward frame portion 72 is configured to pivot relative to the forward frame portion 70 about the vertical pivot axis 40 of the aerial assembly 500. In other embodiments, the rearward frame portion 72 is configured to pivot relative to the forward frame portion 70 about a frame pivot axis parallel to and offset from the vertical pivot axis 40.

According to the exemplary embodiment shown in FIG. 41, (a) the front cabin 20, the pump system 200, and the water tank 400 are mounted on (e.g., positioned on, supported by, etc.) the forward frame portion 70 and (b) the torque box 300, the aerial assembly 500, and the stability assembly 1500 are mounted on the rearward frame portion 72. In other embodiments, the pump system 200 and/or the water tank 400 are mounted on the rearward frame portion 72. In some embodiments, the torque box 300 may be coupled to a portion of the rearward frame portion 72 extending over the forward frame portion 70. By way of example, the torque box 300 may be coupled to the portion of the rearward frame portion 72 pivotably coupled to the forward frame portion 70. The aerial ladder assembly 700 is positioned above the rearward frame portion 72 when the aerial ladder assembly 700 is in the stowed position. For example, a distal end of the aerial ladder assembly 700 may be positioned above the rearward frame portion 72 (e.g., forward of a rearward end of the rearward frame portion 72, etc.) when the aerial ladder assembly 700 is in the stowed position.

As shown in FIG. 41, the front axle 16 is coupled to the forward frame portion 70 and the rear axle 18 is coupled to the rearward frame portion 72. In some embodiments, the rear axle 18 is hydraulically steerable by an operator positioned in the front cabin 20. By way of example, the rear axle 18 may be steered hydraulically based on an input to a steering wheel in the front cabin 20. As shown in FIG. 41, the fire apparatus 10′ includes a third axle, shown as intermediate axle 74, coupled to the forward frame portion 70. The intermediate axle 74 includes the tire assemblies 30. According to an exemplary embodiment, the intermediate axle 74 is positioned beneath the torque box 300. For example, the vertical pivot axis 40 may extend through the intermediate axle 74.

According to the exemplary embodiment shown in FIG. 41, a storage capacity of the storage compartments 112 of the trailer fire apparatus 10′ includes at least 300 cubic feet of storage space (e.g., about 314 cubic feet of storage space, etc.). Traditionally, mid-mount quint fire trucks with a trailer have less than 190 cubic feet of storage space. Alternatively, by converting a portion of the storage compartments 112 to the ground ladder compartment 114 (e.g., in order to store more ground ladders, etc.), a storage capacity of the storage compartments 112 of the trailer fire apparatus 10′ includes at least 210 cubic feet of storage space (e.g., at least about 219 cubic feet of storage space, etc.).

According to the exemplary embodiment shown in FIG. 41, the ground ladder compartment 114 of the trailer fire apparatus 10′ is configured to store at least about 220 feet of ground ladders. By converting the portion of the storage compartments 112 to the ground ladder compartment 114, the ground ladder compartment 114 is configured to store up to about 272 feet of ground ladders.

According to the exemplary embodiment shown in FIG. 41, the hose storage platform 116 of the trailer fire apparatus 10′ may receive and store one or more hoses (e.g., up to 800 feet of 5 inch diameter hose, etc.), which may be pulled from the hose storage platform 116.

According to an exemplary embodiment, a minimum curb-to-curb turning capability of the trailer fire apparatus 10′ is at most 550 inches (e.g., about 540 inches, etc.). In other embodiments, the minimum curb-to-curb turning capability of the trailer fire apparatus 10′ is greater than 550 inches. According to an exemplary embodiment, a minimum wall-to-wall turning capability of the trailer fire apparatus 10′ is at most 590 inches (e.g., about 583 inches, etc.). In other embodiments, the minimum wall to wall turning capability of the trailer fire apparatus 10′ is greater than 590 inches.

As shown in FIG. 41, the trailer fire apparatus 10′ has a height H′. According to an exemplary embodiment, the height H′ of the trailer fire apparatus 10′ is at most 134 inches (i.e., 11 feet, 2 inches). In other embodiments, the trailer fire apparatus 10′ has a height greater than 134 inches. As shown in FIG. 41, the trailer fire apparatus 10′ has a longitudinal length L′. According to an exemplary embodiment, the longitudinal length L′ of the trailer fire apparatus 10′ is at most 588 inches (i.e., 49 feet). By way of example, the longitudinal length L′ of the trailer fire apparatus 10′ may be 580.25 inches. In other embodiments, the trailer fire apparatus 10′ has a length L′ greater than 588 inches.

### Mid-Mount Trailer No-Pump No-Tank Configuration

In various embodiments, the fire apparatus 10′ is configured as a mid-mount trailer no-pump no-tank fire truck having a single rear axle. In these embodiments, the frame 12 of the fire apparatus 10′ includes the forward frame portion 70 and the rearward frame portion 72 pivotably coupled to the forward frame portion 70, but the fire apparatus 10′ does not include the pump system 200 or the water tank 400.

When the fire apparatus 10′ is configured as the mid-mount trailer no-pump no-tank fire truck, a storage capacity of the storage compartments 112 of the fire apparatus 10′ includes at least 470 cubic feet of storage space (e.g., about 480 cubic feet of storage space, etc.). Alternatively, by converting a portion of the storage compartments 112 to the ground ladder compartment 114 (e.g., in order to store more ground ladders, etc.), a storage capacity of the storage compartments 112 of the mid-mount trailer no-pump no-tank fire truck includes at least 350 cubic feet of storage space (e.g., about 355 cubic feet of storage space, etc.).

When the fire apparatus 10′ is configured as the mid-mount trailer no-pump no-tank fire truck, the ground ladder compartment 114 of the mid-mount trailer no-pump no-tank fire truck is configured to store at least 220 feet of ground ladders. By converting the portion of the storage compartments 112 to the ground ladder compartment 114, the ground ladder compartment 114 is configured to store up to 272 feet of ground ladders.

According to an exemplary embodiment, a minimum curb-to-curb turning capability of the mid-mount trailer no-pump no-tank fire truck is at most 510 inches (e.g., about 502 inches, etc.). In other embodiments, the minimum curb-to-curb turning capability of the mid-mount trailer no-pump no-tank fire truck is greater than 510 inches. According to an exemplary embodiment, a minimum wall-to-wall turning capability of the mid-mount trailer no-pump no-tank fire truck is at most 555 inches (e.g., about 553 inches, etc.). In other embodiments, the minimum wall to wall turning capability of the mid-mount trailer no-pump no-tank fire truck is greater than 555 inches.

The fire apparatus 10′ configured as the mid-mount trailer no-pump no-tank fire truck has a height that is at most 139 inches (i.e., 11 feet, 7 inches). By way of example, the height of the fire apparatus 10′ configured as the mid-mount trailer no-pump no-tank fire truck may be 134 inches. In other embodiments, the fire apparatus 10′ configured as the mid-mount trailer no-pump no-tank fire truck has a height greater than 139 inches. The fire apparatus 10′ configured as the mid-mount trailer no-pump no-tank fire truck has a longitudinal length that is at most 564 inches (i.e., 47 feet). By way of example, the longitudinal length of the fire apparatus 10′ configured as the mid-mount trailer no-pump no-tank fire truck may be about 557.25 inches. In other embodiments, the fire apparatus 10′ configured as the mid-mount trailer no-pump no-tank fire truck has a length greater than 564 inches.

### Mid-Mount Tiller Configuration

According to the exemplary embodiment shown in FIG. 42, the fire apparatus 10 is configured as a mid-mount tiller quint fire truck having a single rear axle, shown as tiller fire apparatus 10″. The frame 12 of the tiller fire apparatus 10″ includes the forward frame portion 70 and the rearward frame portion 72 pivotably coupled to the forward frame portion 70 and positioned rearward of the forward frame portion 70. As shown in FIG. 42, the aerial assembly 500 of the fire apparatus 10 is mounted on the rearward frame portion 72.

According to the exemplary embodiment shown in FIG. 42, the rearward frame portion 72 is configured to pivot relative to the forward frame portion 70 about the vertical pivot axis 40 of the aerial assembly 500. In other embodiments, the rearward frame portion 72 is configured to pivot relative to the forward frame portion 70 about a frame pivot axis parallel to and offset from the vertical pivot axis 40.

According to the exemplary embodiment shown in FIG. 42, (a) the front cabin 20 and the pump system 200 are mounted on (e.g., positioned on, supported by, etc.) the forward frame portion 70 and (b) the torque box 300, the water tank 400, the aerial assembly 500, and the stability assembly 1500 are mounted on the rearward frame portion 72. In other embodiments, the pump system 200 is mounted on the rearward frame portion 72 and/or the water tank 400 is mounted on the forward frame portion 70. In some embodiments, the torque box 300 may be coupled to a portion of the rearward frame portion 72 extending over the forward frame portion 70. By way of example, the torque box 300 may be coupled to the portion of the rearward frame portion 72 pivotably coupled to the forward frame portion 70.

As shown in FIG. 42, the front axle 16 is coupled to the forward frame portion 70 and the rear axle 18 is coupled to the rearward frame portion 72. The fire apparatus 10″ includes the intermediate axle 74 coupled to the forward frame portion 70. As shown in FIG. 42, the intermediate axle 74 includes the tire assemblies 30. According to an exemplary embodiment, the intermediate axle 74 is positioned beneath the torque box 300. For example, the vertical pivot axis 40 may extend through the intermediate axle 74.

As shown in FIG. 42, the tiller fire apparatus 10″ includes a second cabin, shown as rear cabin 76, mounted on the rearward frame portion 72. The rear cabin 76 may be positioned behind the rear assembly 100 (e.g., with respect to a forward direction of travel for the tiller fire apparatus 10″ along the longitudinal axis 14, etc.). In some embodiments, the rear cabin 76 is positioned behind the aerial ladder assembly 700. According to an exemplary embodiment, a first operator in the front cabin 20 may steer the front axle 16 and a second operator in the rear cabin 76 may steer the rear axle 18. Separately steering the front axle 16 and the rear axle 18 improves drivability and maneuverability, and substantially reduces the amount of damage that fire departments may inflict on public and/or private property throughout a year of operating their fire trucks.

According to the exemplary embodiment shown in FIG. 42, a storage capacity of the storage compartments 112 of the tiller fire apparatus 10″ includes at least 350 cubic feet of storage space (e.g., about 362 cubic feet of storage space, etc.). Alternatively, by converting a portion of the storage compartments 112 to the ground ladder compartment 114 (e.g., in order to store more ground ladders, etc.), a storage capacity of the storage compartments 112 of the tiller fire apparatus 10″ includes at least 280 cubic feet of storage space (e.g., about 290 cubic feet of storage space, etc.). According to the exemplary embodiment shown in FIG. 42, the ground ladder

compartment 114 of the tiller fire apparatus 10″ is configured to store at least 220 feet of ground ladders. By converting the portion of the storage compartments 112 to the ground ladder compartment 114, the ground ladder compartment 114 is configured to store up to 272 feet of ground ladders. According to the exemplary embodiment shown in FIG. 42, the hose storage platform

116 of the tiller fire apparatus 10″ may receive and store one or more hoses (e.g., up to 800 feet of 5 inch diameter hose, etc.), which may be pulled from the hose storage platform 116.

As shown in FIG. 42, the tiller fire apparatus 10″ has a height H″. According to an exemplary embodiment, the height H″ of the tiller fire apparatus 10″ is at most 139 inches (i.e., 11 feet, 7 inches). By way of example, the height H″ of the tiller fire apparatus 10″ may be about 134 inches. In other embodiments, the tiller fire apparatus 10″ has a height greater than 139 inches. As shown in FIG. 42, the tiller fire apparatus 10″ has a longitudinal length L″. According to an exemplary embodiment, the longitudinal length L″ of the tiller fire apparatus 10″ is at most 624 inches (i.e., 52 feet). By way of example, the longitudinal length L″ of the tiller fire apparatus 10″ may be about 617.75 inches. In other embodiments, the tiller fire apparatus 10″ has a length L″ greater than 624 inches.

### Mid-Mount Tiller No-Pump No-Tank Configuration

In various embodiments, the fire apparatus 10″ is configured as a mid-mount tiller no-pump no-tank fire truck having a single rear axle. In these embodiments, the frame 12 of the fire apparatus 10″ includes the forward frame portion 70, the rearward frame portion 72 pivotably coupled to the forward frame portion 70, and the rear cabin 76 mounted on the rearward frame portion 72, but the fire apparatus 10″ does not include the pump system 200 or the water tank 400.

When the fire apparatus 10″ is configured as the mid-mount tiller no-pump no-tank fire truck, a storage capacity of the storage compartments 112 of the fire apparatus 10″ includes at least 430 cubic feet of storage space (e.g., about 438 cubic feet of storage space, etc.). Alternatively, by converting a portion of the storage compartments 112 to the ground ladder compartment 114 (e.g., in order to store more ground ladders, etc.), a storage capacity of the storage compartments 112 of the mid-mount tiller no-pump no-tank fire truck includes at least 360 cubic feet of storage space (e.g., about 366 cubic feet of storage space, etc.).

When the fire apparatus 10″ is configured as the mid-mount tiller no-pump no-tank fire truck, the ground ladder compartment 114 of the fire apparatus 10″ is configured to store at least 220 feet of ground ladders. By converting the portion of the storage compartments 112 to the ground ladder compartment 114, the ground ladder compartment 114 is configured to store up to 272 feet of ground ladders.

The fire apparatus 10″ configured as the mid-mount tiller no-pump no-tank fire truck has a height that is at most 139 inches (i.e., 11 feet, 7 inches). By way of example, the height of the fire apparatus 10″ configured as the mid-mount tiller no-pump no-tank fire truck may be 134 inches. In other embodiments, the fire apparatus 10″ configured as the mid-mount tiller no-pump no-tank fire truck has a height greater than 139 inches. The fire apparatus 10″ configured as the mid-mount tiller no-pump no-tank fire truck has a longitudinal length that is at most 600 inches (i.e., 50 feet). By way of example, the longitudinal length of the fire apparatus 10″ configured as the mid-mount tiller no-pump no-tank fire truck may be about 594.75 inches. In other embodiments, the fire apparatus 10″ configured as the mid-mount tiller no-pump no-tank fire truck has a length greater than 600 inches.

### Aerial Configuration

As shown in FIG. 8, the lateral pivot axis 42 defined by the heel pin 520 is positioned forward of the vertical pivot axis 40 defined by the aerial assembly 500 along the longitudinal axis 14 of the fire apparatus 10. According to the exemplary embodiment shown in FIG. 8, the proximal ends of the lower base section 800, the middle base section 900, and the upper base section 1000 extend forward of (i.e., past) the vertical pivot axis 40 along the longitudinal axis 14 of the fire apparatus 10 when the aerial ladder assembly 700 is retracted and stowed (e.g., such that the proximal ends of the lower base section 800, the middle base section 900, and the upper base section 1000 are positioned between the vertical pivot axis 40 and the lateral pivot axis 42 when the aerial ladder assembly 700 is retracted and stowed, etc.). In some embodiments the proximal ends of the lower middle section 1100, the upper middle section 1200, and/or the fly section 1300 extend forward of the vertical pivot axis 40 along the longitudinal axis 14 of the fire apparatus 10 when the aerial ladder assembly 700 is retracted and stowed. As shown in FIGS. 1 and 2, at least a portion of the plurality of nesting ladders sections (e.g., at least a base rail of the lower base section 800, the middle base section 900, the upper base section 1000, the lower middle section 1100, the upper middle section 1200, the fly section 1300, etc.) of the aerial ladder assembly 700 is positioned below the top (i.e., roof) of the front cabin 20 (e.g., when the aerial ladder assembly 700 is not pivoted/raised about the lateral pivot axis 42, etc.).

According to an exemplary embodiment, the body 110 of the rear assembly 100 within the aerial assembly recess 140 is shaped to facilitate a substantial aerial work envelope of the aerial ladder assembly 700. By way of example, the body 110 of the rear assembly 100 may define openings proximate the torque box 300 to facilitate the substantial aerial work envelope of the aerial ladder assembly 700. The openings proximate the torque box 300 may extend downward below a top surface of the pedestal 308 of the torque box 300. Such component configurations facilitate operation of the aerial ladder assembly 700 at a negative depression angle below grade (e.g., below horizontal, etc.) of up to a maximum negative depression angle. According to an exemplary embodiment, the maximum negative depression angle is approximately negative ten degrees. In other embodiments, the maximum negative depression angle is greater than ten degrees (e.g., twelve, fifteen, eighteen, twenty, etc. degrees) or less than ten degrees (e.g., nine, etc. degrees). In some embodiments, the maximum depression angle is at least greater than eight degrees. According to an exemplary embodiment, at least one bolt coupling the aerial assembly 500 to the torque box 300 is assessable through the openings in the rear assembly 100 proximate the torque box 300. In some embodiments, the outriggers 1550 are positioned forward of the pedestal 308 of the torque box 300 to facilitate the substantial aerial work envelope of the aerial ladder assembly 700. In some embodiments, the pump system 200 and/or the water tank 400 are positioned rearward of the pedestal 308 of the torque box 300 to facilitate the substantial aerial work envelope of the aerial ladder assembly 700.

When the aerial ladder assembly 700 is oriented to extend perpendicularly from the body 110 of the rear assembly 100 (e.g., the aerial ladder assembly 700 is perpendicular relative to the longitudinal axis 14, etc.) and is positioned below grade at the maximum depression angle (e.g., negative ten degrees, etc.), the aerial ladder assembly 700 extends from the side of the body 110 and the work section 1400 is positioned at a height above a ground surface while none of the plurality of nesting ladder sections (e.g., the middle base section 900, the upper base section 1000, the lower middle section 1100, the upper middle section 1200, the fly section 1300, etc.) are extended. According to an exemplary embodiment, being able to operate the aerial ladder assembly 700 at the maximum depression angle facilitates accessing the work section 1400 from the ground surface without requiring the extension of the aerial ladder assembly 700. The height of the work section 1400 from the ground surface when the aerial ladder assembly 700 is oriented to extend perpendicularly from the body 110 of the rear assembly 100 and is positioned at the maximum depression angle is at most 20.3 inches, according to an exemplary embodiment (e.g., meeting the maximum step height limit as set by NFPA regulations, without requiring extension of the aerial ladder assembly 700, etc.). In some embodiments, the height of the work section 1400 from the ground is less than 20.3 inches (e.g., in embodiments where the stability assembly 1500 of the fire apparatus 10, 10′, 10″ has a leaning capability, etc.).

As shown in FIG. 43, the aerial ladder assembly 700 is pivotable about the lateral pivot axis 42 to reposition the aerial ladder assembly 700 at a plurality of different positions including a horizontal position, shown as horizontal set-back configuration 740, a below grade position, shown as blitz configuration 742, and a plurality of above grade positions, shown as raised configurations 744. As shown in FIG. 43, when the aerial ladder assembly 700 is arranged in the horizontal set-back configuration 740 and the longitudinal axis 14 of the fire apparatus 10, 10′, 10″ is positioned parallel or substantially parallel with a fire scene (e.g., a house, a building, an apartment, etc.), the aerial ladder assembly 700 extends from the side of the body 110 a set-back distance D_{SB}. According to an exemplary embodiment, the set-back distance D_{SB} is less than twenty feet. In some embodiments, the set-back distance D_{SB} is less than nineteen feet. In other embodiments, the set-back distance D_{SB} is greater than or equal to twenty feet. As shown in FIG. 43, when the aerial ladder assembly 700 is arranged in the blitz

configuration 742, the aerial ladder assembly 700 is oriented at a negative depression angle (e.g., up to the maximum depression angle, etc.) such that the work section 1400 is positioned substantially close to the ground surface and adjacent the fire scene (e.g., the first level of a building, a store front, etc.). In the blitz configuration 742, the work section 1400 may be extended from the rear assembly 100 by pivoting the aerial ladder assembly 700 about the vertical pivot axis 40 toward the fire scene and then pivoting the aerial ladder assembly 700 about the lateral pivot axis 42 such that the work section 1400 clears any obstacles 750 (e.g., cars, etc.) positioned in front of the fire scene. A turret, shown as the water turret 1440, that is coupled to the work section 1400 may be manipulated (e.g., using a user input device of the fire apparatus 10, the control console 600, etc.) to expel water or another fire surprising agent from the water tank 400 or other source (e.g., a fire hydrant, an agent tank, etc.) into the first level of the fire scene upward at the ceiling thereof to expel a fire therein (e.g., to prevent a fire from spreading to the upper levels of the building, etc.). In other embodiments, the water turret 1440 is otherwise positioned (e.g., coupled to the distal end of the fly section 1300, in embodiments where the aerial ladder assembly 700 does not include the work section 1400, etc.). As shown in FIG. 43, when the aerial ladder assembly 700 is arranged in the raised

configurations 744, the aerial ladder assembly 700 is oriented at a positive angle such that the work section 1400 is positioned above the fire apparatus 10. To extend further in the vertical direction, the plurality of nesting sections of the aerial ladder assembly 700 may begin to be extended.

### Control System

According to the exemplary embodiment shown in FIG. 44, a control system, shown as fire apparatus control system 2000, for the fire apparatus 10, 10′, 10″ includes a controller 2010. In one embodiment, the controller 2010 is configured to selectively engage, selectively disengage, control, and/or otherwise communicate with components of the fire apparatus 10, 10′, 10″. As shown in FIG. 44, the controller 2010 is coupled to the rotation actuator 320, the pivot actuator(s) 710, the extension actuator(s) 720, the water turret 1440, and a user input/output (“I/O”) device 2020. In other embodiments, the controller 2010 is coupled to more or fewer components (e.g., the stability assembly 1500, etc.). By way of example, the controller 2010 may send and/or receive signals with the rotation actuator 320, the pivot actuator(s) 710, the extension actuator(s) 720, the water turret 1440, and/or the user I/O device 2020.

The controller 2010 may be implemented as a general-purpose processor, an application specific integrated circuit (ASIC), one or more field programmable gate arrays (FPGAs), a digital-signal-processor (DSP), circuits containing one or more processing components, circuitry for supporting a microprocessor, a group of processing components, or other suitable electronic processing components. According to the exemplary embodiment shown in FIG. 44, the controller 2010 includes a processing circuit 2012 and a memory 2014. The processing circuit 2012 may include an ASIC, one or more FPGAs, a DSP, circuits containing one or more processing components, circuitry for supporting a microprocessor, a group of processing components, or other suitable electronic processing components. In some embodiments, the processing circuit 2012 is configured to execute computer code stored in the memory 2014 to facilitate the activities described herein. The memory 2014 may be any volatile or non-volatile computer-readable storage medium capable of storing data or computer code relating to the activities described herein. According to an exemplary embodiment, the memory 2014 includes computer code modules (e.g., executable code, object code, source code, script code, machine code, etc.) configured for execution by the processing circuit 2012. In some embodiments, controller 2010 represents a collection of processing devices (e.g., servers, data centers, etc.). In such cases, the processing circuit 2012 represents the collective processors of the devices, and the memory 2014 represents the collective storage devices of the devices.

In one embodiment, the user I/O device 2020 includes a display and an operator input. The display may be configured to display a graphical user interface, an image, an icon, and/or still other information. In one embodiment, the display includes a graphical user interface configured to provide general information about the fire apparatus 10, 10′, 10″ (e.g., vehicle speed, fuel level, warning lights, battery level, etc.). The graphical user interface may also be configured to display a current position of the aerial ladder assembly 700, a current position of the work section 1400, a current position of the turntable 510, an orientation of the fire apparatus 10, 10′, 10″ (e.g., an angle relative to a ground surface, etc.), and/or still other information relating to the fire apparatus 10, 10′, 10″ and/or the aerial assembly 500. The user I/O device 2020 may be or include the control console 600, a user interface within the front cabin 20, a user interface in the work section 1400, a user interface on the side of the body 110, and/or a portable device wirelessly connected to the controller 2010 (e.g., a mobile device, a smartphone, a tablet, etc.).

The operator input may be used by an operator to provide commands to at least one of the rotation actuator 320, the pivot actuator(s) 710, the extension actuator(s) 720, or the water turret 1440. The operator input may include one or more buttons, knobs, touchscreens, switches, levers, joysticks, pedals, a steering wheel, or handles. The operator input may facilitate manual control of some or all aspects of the operation of the fire apparatus 10. It should be understood that any type of display or input controls may be implemented with the systems and methods described herein.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X; Y; Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire apparatus 10, 10′, 10″ and the systems and components thereof as shown in the various exemplary embodiments is illustrative only. Additionally, any element disclosed in one embodiment may be incorporated or utilized with any other embodiment disclosed herein.

1. A tiller fire apparatus comprising:
a tractor including:
a chassis defining a longitudinal axis;
a first cab coupled to the chassis;
a front axle coupled to the chassis; and
a single intermediate axle coupled to the chassis rearward of the front axle; and
a trailer including:
a frame pivotably coupled to the chassis about a vertical axis perpendicular to the longitudinal axis;
a single rear axle coupled to the frame;
a stabilization assembly coupled to the frame rearward of the vertical axis;
a second cab coupled to the frame rearward of the single rear axle; and
an aerial assembly supported by the frame, the aerial assembly having a vertical reach of at least 95 feet and a horizontal reach of at least 90 feet;
wherein the tractor and the trailer have a longitudinal length along the longitudinal axis that is at most 52 feet.

2. The tiller fire apparatus of claim 1, wherein the aerial assembly is capable of accommodating at least a 500 pound load applied to a distal end of the aerial assembly while the aerial assembly is fully extended.

3. The tiller fire apparatus of claim 1, wherein:
the aerial assembly includes:
a six section ladder that is extensible;
a nozzle coupled to a distal section of the six section ladder; and
an extendable conduit fluidly coupled to the nozzle, the extendable conduit extensible with the six section ladder to fluidly couple the nozzle to a fluid source; and
the aerial assembly is capable of accommodating at least a 500 pound load applied to a distal end of the six section ladder while the six section ladder is fully extended and a fluid is flowing through the extendable conduit to the nozzle.

4. The tiller fire apparatus of claim 3, wherein:
the aerial assembly includes a turntable pivotably coupled to the frame, the six section ladder pivotably coupled to the turntable about a pivot axis; and
at least a portion of the extendable conduit extends along the pivot axis.

5. The tiller fire apparatus of claim 1, further comprising a water tank coupled to the frame, the water tank having at least a 300 gallon capacity.

6. The tiller fire apparatus of claim 1, wherein:
the front axle has a first gross axle weight rating of no more than 24,000 pounds; and
the single rear axle has a second gross axle weight rating of no more than 35,000 pounds.

7. The tiller fire apparatus of claim 1, wherein the tiller fire apparatus has an overall height of at most 139 inches when the aerial assembly is in a stowed position.

8. The tiller fire apparatus of claim 1, wherein a distal end of the aerial assembly is positioned forward of the second cab when the aerial assembly is in a stowed position.

9. The tiller fire apparatus of claim 1, wherein the aerial assembly includes a base ladder section and a plurality of extensible ladder sections that extend relative to the base ladder section, wherein proximal ends of the plurality of extensible ladder sections are positioned on a same side of a proximal end of the base ladder section when the aerial assembly is fully retracted.

10. The tiller fire apparatus of claim 1, further comprising a torque box coupled between the frame and the aerial assembly, the torque box including:
a pedestal coupled to the frame; and
a pivotal connector pivotably coupling the aerial assembly to the pedestal, wherein the pivotal connector is coupled to the pedestal with a plurality of fasteners that are accessible from a top side of the pivotal connector.

11. The tiller fire apparatus of claim 1, wherein the trailer includes one or more ground ladder compartments configured to store at least 220 feet of ground ladders.

12. The tiller fire apparatus of claim 11, wherein the trailer includes storage compartments having at least 350 cubic feet of storage space.

13. A fire apparatus comprising:
a tractor including:
a chassis defining a longitudinal axis;
a first cab coupled to the chassis;
a front axle coupled to the chassis; and
a single intermediate axle coupled to the chassis rearward of the front axle; and
a trailer including:
a frame pivotably coupled to the chassis about a vertical axis perpendicular to the longitudinal axis;
a single rear axle coupled to the frame;
a stabilization assembly coupled to the frame rearward of the vertical axis;
a second cab coupled to the frame rearward of the single rear axle; and
an aerial assembly supported by the frame, the aerial assembly including a multi-section ladder that is extensible to provide a vertical reach of at least 95 feet and a horizontal reach of at least 90 feet;
wherein the fire apparatus has an overall height of at most 139 inches when the aerial assembly is in a stowed position.

14. The fire apparatus of claim 13, further comprising a water tank coupled to the frame, the water tank having at least a 300 gallon capacity.

15. The fire apparatus of claim 13, wherein:
the front axle has a first gross axle weight rating of no more than 24,000 pounds; and
the single rear axle has a second gross axle weight rating of no more than 35,000 pounds.

16. The fire apparatus of claim 13, wherein the trailer includes one or more ground ladder compartments configured to store at least 220 feet of ground ladders.

17. The fire apparatus of claim 13, wherein the trailer includes storage compartments having at least 350 cubic feet of storage space.

18. The fire apparatus of claim 13, wherein the multi-section ladder includes a base ladder section and at least five extensible ladder sections that extend relative to the base ladder section.

19. A fire apparatus comprising:
a tractor including:
a chassis defining a longitudinal axis;
a first cab coupled to the chassis;
a front axle coupled to the chassis; and
a single intermediate axle coupled to the chassis rearward of the front axle; and
a trailer including:
a frame pivotably coupled to the chassis about a vertical axis perpendicular to the longitudinal axis;
a single rear axle coupled to the frame;
a stabilization assembly coupled to the frame rearward of the vertical axis;
a second cab coupled to the frame rearward of the single rear axle; and
an aerial assembly supported by the frame, the aerial assembly including a multi-section ladder that is extensible to provide a vertical reach of at least 95 feet and a horizontal reach of at least 90 feet;
wherein the aerial assembly is capable of accommodating at least a 500 pound load applied to a distal end of the multi-section ladder while the multi-section ladder is fully extended; and
wherein a distal end of the aerial assembly is positioned forward of the second cab when the aerial assembly is in a stowed position.

20. The fire apparatus of claim 19, wherein the multi-section ladder includes a base ladder section and at least five extensible ladder sections that extend relative to the base ladder section.
